(19) United States
(12) Patent Application Publication
(10) Pub. No.: US 2009/0126022 A1
(43) Pub. Date: May 14, 2009

(54) Method and System for Generating Data for Security Assessment

(75) Inventor: Hiroshi SAKAKI, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/791,673

(22) PCT Filed: Nov. 25, 2005
(86) PCT No.: PCT/JP05/21674

§ 371 Date: May 25, 2007

(30) Foreign Application Priority Data
Nov. 25, 2004 (JP) 2004-340898

(51) Int. Cl. G06F 11/00

(52) U.S. Cl. 726/25

(57) ABSTRACT

A system for creating data to be inputted to a security assessment system is provided with: a system configuration information collection unit for collecting system configuration information from an assessment object system; an attribute information input unit for receiving attribute information added to the system configuration information; an access policy generation unit for generating an access policy using the attribute information; and an assessment policy generation unit for generating an assessment policy representing an improper data migration path based on the access policy, the system configuration information and the attribute information.

### TECHNICAL FIELD

The present invention relates to a method and system for assessing the security settings of software, and particularly, to a security assessment data generation method and system which generate input data to a security assessment system capable of detecting whether composite faults that become security holes exist in the security settings of software and indicating such faults.

### BACKGROUND ART

With the popularization of the Internet in recent years, the Internet is becoming a vital social infrastructure that is comparable to the telephone network and the like. A user may receive a wide variety of services on the Internet. Generally, services provided on the Internet are realized by accepting a series of requests from the user, executing processing corresponding to the accepted requests, and transmitting processing results thereof to the user. More specifically, services via the WWW (the World Wide Web) are widely prevalent and presently form a foundation for various services such as electronic commerce.

The various services provided on the Internet are realized by systems referred to as servers, which are connected to the Internet. In particular, since public servers on the Internet accept requests from an unspecified large number of highly anonymous users, such servers are vulnerable to so-called cyber attacks, that is, attacks directed to cyber space, and have become a major security concern.

Such cyber attacks towards public servers include those which cause malicious operations that exploit security holes such as vulnerabilities existing within a server or inappropriate settings of a server to send a malicious request to the server in order to cause incorrect operations and to steal confidential files. Hereinafter, inappropriate settings of a server shall be referred to as improper settings. Examples of vulnerabilities of a server include program errors that trigger server software failure. Examples of improper settings include setting errors at the time of security settings which trigger server software failure.

Ideally, such cyber attacks may be prevented by eliminating security holes of a server. However, eliminating all security holes in software is extremely difficult, and in practice, impossible. In addition, since a creator of software and a server administrator are generally different entities, the possibility that a server administrator will misinterpret the specifications of the software and will configure the same in an inappropriate manner cannot be ruled out.

Conventionally, as a device for assessing security, for instance, JP-A-2002-229946 or “Internet Scanner”, an online document available at http://www.isskk.co.jp/product/Internet_Scanner.html, propose a security assessment device that detects a presence or an absence of vulnerability in a server or the like to determine security strength of a computer system. More specifically, as shown in FIG. 1, such a security assessment device comprises pseudo attack unit 520, response examination unit 530, and vulnerability database 510.

In the security assessment device shown in FIG. 1, according to the configuration of a computer system that is an examination object, pseudo attack unit 520 extracts an attacking procedure that has been prepared in advance for pseudo-attacking the examination object from vulnerability database 510. Pseudo attack unit 520 pseudo-attacks the examination object using the extracted attacking procedure. Response examination unit 530 studies the attacked examination object, compares the response of the examination object with responses predefined according to the attacking procedures, and identifies a presence or absence of vulnerabilities in the examination object. The security assessment device shown in FIG. 1 is a system that executes pseudo attacks on all examination objects in the manner described above, and assesses security from the presence or absence of vulnerabilities.

In addition, “System Scanner”, an online document available at http://www.isskk.co.jp/product/System_Scanner.html, discloses a system that assesses security of an object computer system through comparison with recommended settings prepared in advance. In this system, recommended settings are registered in a database, and security is assessed by comparing the actual settings of a computer that is an examination object with the recommended settings.

Furthermore, in 2000 IEEE Symposium on Security and Privacy, pp. 156-165, March 2000, Ronald W. Ritchey and Paul Ammann proposed a security assessment method capable of assessing a case where a combination of vulnerabilities give rise to a greater threat by representing the correlation between a plurality of vulnerabilities as a graph. In this method, a plurality of vulnerabilities are detected in advance, whereby a correlation between the vulnerabilities is represented in a graph.

For instance, it is assumed that an assessment object system has two vulnerabilities. The first is a vulnerability that allows user authorities to be usurped via the Internet, and the second is a vulnerability that allows any user to usurp administrator authorities. In this case, since the second vulnerability that allows “any user to usurp administrator authorities” cannot be used directly by an outsider, the vulnerability is not serious. Therefore, in a system that examines a single vulnerability, even if a second vulnerability exists, it is often determined that the second vulnerability is not an issue with respect to the entire system. However, the second vulnerability becomes usable after the first vulnerability has been used. In other words, it will be determined to be a serious vulnerability only after combining the two vulnerabilities. In order to assess such combinations of vulnerabilities, vulnerabilities that become usable after using a given vulnerability are exhaustively connected by directed graphs. As seen, the system of Ritchey et al. is a system that assesses a combination of a plurality of vulnerabilities.

[Patent Document 1] Japanese Patent Laid-Open 2002-229946

[Non-patent Document 1] “Internet Scanner”, [online], Internet, URL: http://www.isskk.co.jp/product/Internet_Scanner.html, (retrieved Oct. 27, 2003)

[Non-patent Document 2] “System Scanner”, [online], Internet, URL: http://www.isskk.co.jp/product/System_Scanner.html, (retrieved Oct. 27, 2003)

[Non-patent Document 3] Ritchey, Ronald W. and Paul Ammann, “2000 IEEE Symposium on Security and Privacy”, IEEE, March 2000, 156-165, (U.S.A.).

### DISCLOSURE OF THE INVENTION

### Problem to be Solved by the Invention

With the respective conventional techniques described above, since the contents of security settings may not be made assessment objects, there is a problem in that an assessment on whether a security setting is an improper setting or not could not be performed. In other words, with the respective conventional techniques described above, pseudo attacks for assessing security settings may not be performed. More specifically, for instance, in the security assessment system shown in FIG. 1 or the security assessment system that represents a correlation between a plurality of vulnerabilities as a graph, an examination method referred to as the pseudo attack method is used. With this examination method, examination is performed by preparing in advance an attacking procedure according to vulnerabilities, and actually launching an attack. Therefore, only vulnerabilities for which attacking procedures may be created in advance could be made examination objects and security settings for which pseudo attacks may not be created could not be assessed.

With the method in which a comparison with a recommended setting is performed, while the method is arranged to assess a presence or absence of setting errors in security settings, only obvious setting errors in security settings may be assessed. In other words, with this method, only obvious setting errors such as a case of a null password which may be individually assessed on a per-setting basis could be made assessment objects. The method is incapable of assessing presence or absence of improper settings based on composite setting errors, such as a setting error that is difficult to determine whether the setting error is a setting error depending on the respective settings. On the other hand, since many illegal accesses are caused by setting errors, it is desirable that evaluations on whether a setting error that may lead to failure exists are performed in a rigorous manner.

With the respective conventional techniques described above, there is also a problem in that a determination may not be performed on whether an improper setting is a result of a combination of a plurality of security settings. In other words, the respective conventional techniques described above are incapable of assessing the presence or absence of an improper setting based on a composite setting error. More specifically, with the assessment system shown in FIG. 1 or the assessment system based on a comparison with a recommended setting, examination objects are limited to the presence or absence of security holes that render a computer system vulnerable by just one vulnerability or just one setting, and a combination of a plurality of security settings may not be made an assessment object. There are cases where a plurality of security settings which may not be deemed setting errors and may not be determined to be security holes, when seen from the perspective of individual configurations, combine with each other to become a security hole of a computer system. The above conventional techniques are not capable of detecting such security holes.

While the system of Ritchey et al. is arranged to assess the presence or absence of a combination of a plurality of vulnerabilities which may become a security hole, setting errors of security settings are not considered assessment objects.

Furthermore, with the respective conventional systems described above, there is also a problem in that examination object systems are presented with heavy loads. More specifically, since the examination method referred to as the pseudo attack method which is used in the assessment system shown in FIG. 1 actually launches an attack targeting a vulnerability, the system that is the examination object will be subject to the same load as in an real attack, and in some cases, the examination object system may be down. Therefore, depending on the condition of the assessment object system, there are cases where the assessment system shown in FIG. 1 may not be applied. However, as a security assessment system, it is desirable that the security of an assessment object system or computer is assessable regardless of what condition the assessment object system or computer is in.

Moreover, while input data to a security assessment system is required when performing security assessment, it is preferable that such input data is generated in a simple manner.

In consideration of the above, an object of the present invention is to provide a data generation method and system capable of easily generating data to be inputted to a security assessment system.

Another object of the present invention is to solve the above-described problems, and provide an assessment method and system capable of performing rigorous assessment of security settings.

Yet another object of the present invention is to provide a method and system capable of assessing the presence or absence of failures that occur as a result of a composite action of a plurality of security settings.

Still another object of the present invention is to provide a method and system capable of reducing the load on the examination object system during assessment.

### Means for Solving the Problem

The objects of the present invention may be achieved by a security assessment data generation method of generating an assessment policy that is data to be inputted to a security assessment system that assesses a presence or absence of an improper setting indicating a composite error of security settings in an assessment object system, the method including the steps of: collecting system configuration information including information regarding at least one of or a combination of a network, an application, a file, a service and a user of the assessment object system; receiving attribute information that is added to the system configuration information and which indicates contents of attributes of at least one of or a combination of the network, the application, the file, the service and the user; generating, using the attribute information, an access policy that includes information regarding at least one of or a combination of a migration source, a migration destination and a migration path of data with respect to an improper data migration path; and generating an assessment policy representing the improper data migration path based on the access policy, the system configuration information and the attribute information.

In such a security assessment data generation method according to the present invention: the step of collecting system configuration information is executed by, for instance, system configuration information collection means; the step of receiving attribute information is executed by, for instance, attribute information input means; the step of generating an access policy is executed by, for instance, access policy generation means; and the step of generating an assessment policy is executed by, for instance, assessment policy generation means. In addition, the security assessment data generation method may be provided with a step for assessing, using a data migration path that indicates data migration in an assessment object system and an assessment policy, whether the data migration path in the assessment object system is appropriate. Such an assessing step is executed by, for instance, assessment means. By providing an assessment step, it is now possible to execute the processes from generating assessment data to the process of assessing the security settings of the examination object system as a series of processes.

The objects of the present invention may also be achieved by a security assessment data generation system for generating an assessment policy that is data to be inputted to a security assessment system that assesses a presence or absence of an improper setting that indicates a composite error of security settings in an assessment object system, the system including: system configuration information collection means for collecting system configuration information including information regarding at least one of or a combination of a network, an application, a file, a service and a user of the assessment object system; attribute information inputting means for receiving input of attribute information which is added to the system configuration information and which indicates contents of attributes of at least one of or a combination of the network, the application, the file, the service and the user; access policy generation means for generating, using the attribute information, an access policy including information regarding at least one of or a combination of a migration source, a migration destination and a migration path of data with respect to an improper data migration path; and assessment policy generation means for generating an assessment policy representing the improper data migration path based on the access policy generated by access policy generation means, the system configuration information and the attribute information.

In the system according to the present invention, the attribute information inputting means may be arranged so as to display system configuration information collected by the system configuration information collection means and prompt an operator to input attribute information. According to such an arrangement, by presenting system configuration information to the operator, an assessment policy in conformity with the system configuration of the assessment object system may easily be created.

In the system according to the present invention, the access policy generation means may be arranged so as to display attribute information as options and prompt the operator to select attribute information, and to specify a migration source, a migration destination or a migration path according to the selected attribute information. According to such an arrangement, the operator is no longer required to directly specify individual elements of the assessment object system, and may create an assessment policy by selecting attribute information. Therefore, the operator will be able to create an assessment policy without having to know details of the system configuration of the assessment object system.

In the system according to the present invention, the assessment policy generation means may be arranged to generate an assessment policy by replacing the information regarding the migration source, the migration destination or the migration path in the access policy specified using attribute information with information included in the system configuration information or attribute information.

In addition, the system according to the present invention may further comprise assessment means that assesses, using a data migration path that indicates data migration in the assessment object system and the assessment policy, whether the data migration path in the assessment object system is appropriate. By adopting such an arrangement, it is now possible to consistently execute the processes from generating assessment data to assessing security settings of the examination object system.

The objects of the present invention may also be achieved by a security assessment data generation program to be installed in a computer that generates an assessment policy that is data to be inputted to a security assessment system that assesses a presence or absence of an improper setting indicating a composite error of security settings in an assessment object system, the program causing the computer to execute processing for: collecting system configuration information including information regarding at least one of or a combination of a network, an application, a file, a service and a user of the assessment object system; receiving attribute information that is added to the system configuration information and which indicates contents of attributes of at least one of or a combination of the network, the application, the file, the service and the user; generating, using the attribute information, an access policy including information regarding at least one of or a combination of a migration source, a migration destination and a migration path with respect to an improper data migration path; and generating an assessment policy representing the improper data migration path based on the access policy, the system configuration information and the attribute information.

The program according to the present invention may be arranged so as to cause the computer to further execute processing for assessing, using the data migration path that indicates data migration in the assessment object system and the assessment policy, whether the data migration path in the assessment object system is appropriate.

According to the present invention, an assessment policy may easily be created by entering attribute information. In addition, since a plurality of system components may be simultaneously specified with a single piece of attribute information, a necessary and sufficient number of assessment policies may be created with a small number of access policies.

### BRIEF DESCRIPTION OF THE DRAWINGS

FIG. 1 is a block diagram showing a configuration of a conventional security assessment system;

FIG. 2 is a block diagram showing a first configuration of a security assessment system that uses data created by a data generation method according to the present invention;

FIG. 3 is a diagram showing an exemplary structure of data stored in a setting information storage unit;

FIG. 4 is a diagram showing an exemplary structure of data stored in a program operation information storage unit;

FIG. 5 is a diagram showing an exemplary structure of data stored in a data transfer path information storage unit;

FIG. 6 is a flowchart showing security assessment processing executed by the security assessment system shown in FIG. 2;

FIG. 7 is a block diagram showing a second configuration of the security assessment system;

FIG. 8 is a flowchart showing security assessment processing executed by the security assessment system shown in FIG. 7;

FIG. 9 is a block diagram showing a third configuration of the security assessment system;

FIG. 10 is a block diagram showing a fourth configuration of the security assessment system;

FIG. 11 is a block diagram showing a fifth configuration of the security assessment system;

FIG. 12 is a diagram showing an exemplary structure of a policy stored in a policy storage unit;

FIG. 13 is a flowchart showing security assessment processing executed by the security assessment system shown in FIG. 12;

FIG. 14 is a flowchart showing processing executed by an assessment unit of the security assessment system shown in FIG. 11;

FIG. 15 is a diagram showing an example of a policy conversion rule;

FIG. 16 is a block diagram showing a configuration of a security assessment data generation system according to a first embodiment of the present invention;

FIG. 17 is a diagram showing an example of network configuration information;

FIG. 18 is a diagram showing an example of application information;

FIG. 19 is a diagram showing an example of file information;

FIG. 20 is a diagram showing an example of service information;

FIG. 21 is a diagram showing an example of user information;

FIG. 22 is a flowchart showing operations of the security assessment data generation system shown in FIG. 16;

FIG. 23 is a block diagram showing a configuration of a security assessment data generation system according to a second embodiment of the present invention;

FIG. 24 is a flowchart showing operations of the security assessment data generation system shown in FIG. 23;

FIG. 25 is a flowchart showing operations of the security assessment data generation system shown in FIG. 23;

FIG. 26 is a block diagram showing a configuration of a security assessment system;

FIG. 27A is a diagram showing an exemplary setting of a user account of an OS in an examination object computer;

FIG. 27B is a diagram showing an exemplary setting of a group of the OS in the examination object computer;

FIG. 28 is a diagram showing an exemplary setting of an access right to a file in the examination object computer;

FIG. 29A is a diagram showing an exemplary setting of a Web server in the examination object computer;

FIG. 29B is a diagram showing an exemplary setting of a Web server in the examination object computer;

FIG. 30 is a diagram showing a graph indicating data transfer paths generated based on security setting information of the OS in the examination object computer;

FIG. 31 is a diagram showing a graph indicating a data transfer path to which has been added arcs and objects created from a directory structure managed by the OS in the examination object computer;

FIG. 32 is a diagram showing a graph indicating data transfer paths generated based on security setting information of the Web server in the examination object computer;

FIG. 33 is a diagram showing a graph indicating data transfer paths generated by a data transfer path generation unit;

FIG. 34 is a flowchart showing an example of access right integration processing;

FIG. 35 is a diagram showing a graph indicating data transfer paths generated by the data transfer path generation unit;

FIG. 36 is a diagram showing a graph indicating data transfer paths in a state where an access right has been integrated by an access right integration unit;

FIG. 37 is a diagram showing a graph indicating data transfer paths in a state where all access rights have been integrated by the access right integration unit;

FIG. 38 is a diagram showing a graph indicating examples of data transfer paths to be entered to a data transfer path conversion unit;

FIG. 39 is a diagram showing a tree structure indicating examples of data transfer paths after conversion delivered from a data transfer path conversion unit;

FIG. 40 is a flowchart showing data transfer path conversion processing;

FIG. 41 is a diagram showing examples of a security assessment policies entered from a policy input unit;

FIG. 42 is a diagram showing a graph indicating improper paths retrieved by pattern matching processing;

FIG. 43 is a flowchart showing improper path retrieval processing;

FIG. 44 is a diagram extracting and showing a retrieved improper path;

FIG. 45 is a flowchart showing configuration information retrieval processing;

FIG. 46 is a diagram showing an example of a state where nodes included in an improper path have been retrieved from a data transfer path after access right integration;

FIG. 47 is a diagram showing an example of a state where improper paths in a data transfer path before access right integration have been retrieved;

FIG. 48 is a diagram showing an example of a state where an authority delegation arc, an alias definition arc, and nodes connected to these arcs have been retrieved;

FIG. 49 is a diagram showing an example of a state where all nodes and arcs responsible for the creation of an improper path have been retrieved;

FIG. 50 is a diagram showing an example of a state representing improper setting areas in data transfer path information;

FIG. 51 is a diagram showing an example of security setting information extracted from a setting information storage unit;

FIG. 52 is a diagram showing an example of a display screen of an improper path retrieved by the pattern matching processing;

FIG. 53 is a diagram showing an example of a primary screen depicting an overall picture of a user interface of in a security assessment system;

FIG. 54 is a diagram showing an example of a topology screen;

FIG. 55 is a diagram showing an example of a topology screen;

FIG. 56 is a diagram showing an example of a policy screen;

FIG. 57 is a diagram showing an example of an alert screen;

FIG. 58 is a diagram showing an example of a result screen;

FIG. 59 is a diagram showing an example of a detail screen;

FIG. 60 is a block diagram showing another configuration of a security assessment system;

FIG. 61A is a diagram showing a tree structure indicating an example of data transfer paths after conversion delivered from the data transfer path conversion unit;

FIG. 61B is a diagram showing a tree structure indicating an example of data transfer paths after conversion outputted from the data transfer path conversion unit;

FIG. 62 is a flowchart showing another example of the data transfer path conversion processing;

FIG. 63 is a diagram showing a host configuration of an assessment object;

FIG. 64 is a diagram showing a host configuration stored in a setting model storage unit;

FIG. 65 is a diagram showing a relationship between an IP address configuration and a host of an assessment object system;

FIG. 66 is a diagram showing an IP address setting of a host comprising the assessment object system;

FIG. 67 is a diagram showing an IP address stored in the setting model storage unit;

FIG. 68 is a diagram showing a network connection of the assessment object system;

FIG. 69 is a diagram showing elements of a setting model stored in the setting model storage unit;

FIG. 70 is a diagram showing a system configuration of the assessment object system;

FIG. 71 is a diagram showing a user setting of the assessment object system;

FIG. 72 is a diagram showing a group setting of the assessment object system;

FIG. 73 is a diagram showing users stored in the setting model storage unit;

FIG. 74 is a diagram showing a setting of file access rights of the assessment object system;

FIG. 75 is a diagram showing files stored in the setting model storage unit;

FIG. 76 is a diagram showing a display state of assessment results of the assessment object system;

FIG. 77 is a diagram showing a configuration of a computer system that is an assessment object;

FIG. 78 is a diagram showing an example of network configuration information to which network configuration information attributes have been added;

FIG. 79 is a diagram showing an example of service information to which service information attributes have been added;

FIG. 80 is a diagram showing an example of user information to which user information attributes have been added;

FIG. 81 is a diagram showing an example of file information to which file information attributes have been added;

FIG. 82 is a diagram showing an example of a created access policy;

FIG. 83 is a diagram showing an example of an initial screen presented when creating an access policy;

FIG. 84 is a diagram showing an example of a screen for newly creating an access policy;

FIG. 85 is a diagram showing an example of a migration source input screen;

FIG. 86 is a diagram showing an example of a migration destination input screen;

FIG. 87 is a diagram showing an example of a migration path input screen;

FIG. 88 is a flowchart showing operations for retrieving a user account converted from a user when the user is specified as a migration source or migration destination using attribute information;

FIG. 89 is a flowchart showing operations for retrieving a file name converted from a file when the file is specified as a migration source or migration destination using the attribute information; and

FIG. 90 is a flowchart showing operations for retrieving an IP address or a port number converted from a service when the service is specified as a migration path using the attribute.

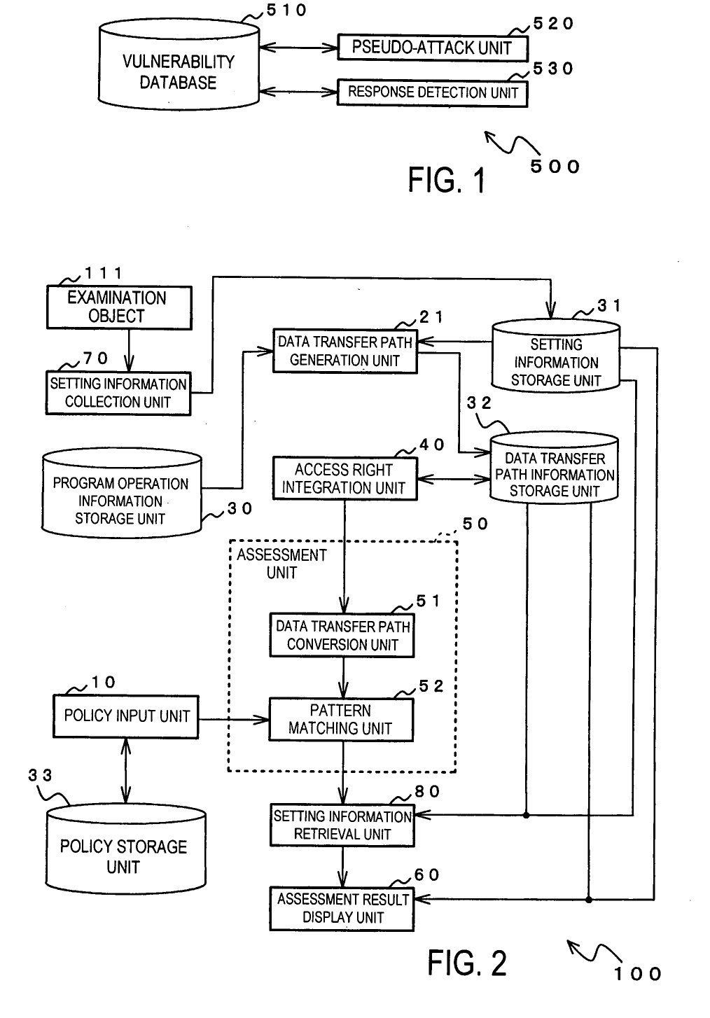

### DESCRIPTION OF REFERENCE SYMBOLS

1401 Computer system;
1402 System configuration information collection unit;
1403 Attribute information input unit;
1404 Attribute information storage unit;
1405 Access policy generation unit;
1406 Access policy storage unit;
1407 Assessment policy generation unit;
1408 Assessment policy storage unit;
1509 Data transfer path input unit;
1510 Assessment unit; and
1511 Assessment result display unit.

### BEST MODE FOR CARRYING OUT THE INVENTION

The present invention is related to a method and system for generating input data to be provided to a security assessment system. Accordingly, a security assessment system, to which input data generated according to the present invention will be provided, will be first described. While various security assessment systems are conceivable as systems in which input data created according to the present invention may be used, five exemplary configurations of such a security assessment system will be described below. Incidentally, in the following description, a user who is a user or an operator of a security assessment system and is attempting to perform an assessment of security settings of an examination object system shall be referred to as an assessor. In comparison, a user of the examination object system itself shall be referred as-is as a user.

First Security Assessment System:

FIG. 2 is a block diagram showing a configuration of first security assessment system 100. As shown in FIG. 2, security assessment system 100 is arranged to assess security settings of examination object 111, and includes: policy input unit 10; data transfer path generation unit 21; program operation information storage unit 30; setting information storage unit 31; data transfer path information storage unit 32; policy storage unit 33; access right integration unit 40; assessment unit 50; assessment result display unit 60; setting information collection unit 70; and setting information retrieval unit 80.

Examination object 111 denotes a computer that will become an assessment object of errors in security settings performed by security assessment system 100. More specifically, for instance, an OS (operating system), a Web server, a Web client and the like correspond to examination object 111.

Setting information collection unit 70 is provided with a function for collecting from assessment object system 111 security setting information that indicates security settings within assessment object system 111 and storing the collected information in setting information storage unit 31. In other words, setting information collection unit 70 collects setting information related to security from the computer system that is examination object 111. In this case, “setting information related to security” or security setting information refers to information including an object application, security unit information and a setting information file name. Incidentally, security unit information is also sometimes referred to as “security setting information.”

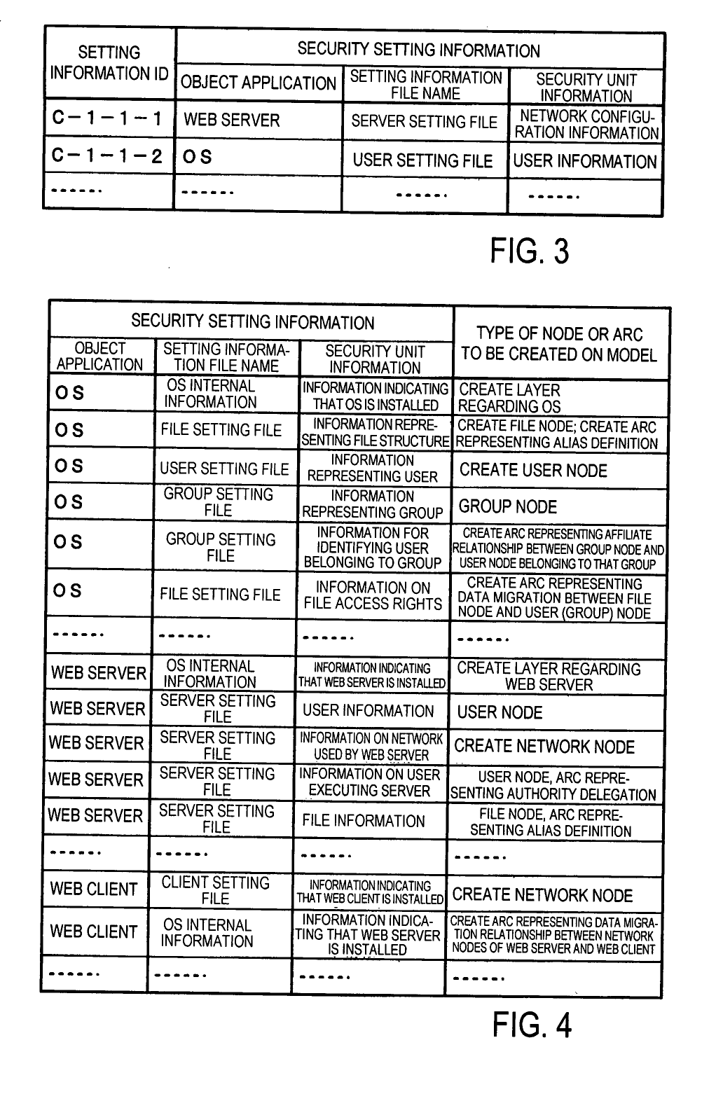

Setting information storage unit 31 is configured by, for instance, a database device, and stores security setting information collected by setting information collection unit 70 together with a setting information ID. FIG. 3 shows an example of a data storage mode of setting information storage unit 31. As shown, setting information storage unit 31 stores, for instance, setting information IDs and security setting information.

A “setting information ID” is an identification code that is assigned so as to correspond to each piece of security unit information and is uniquely determined in order to identify security unit information. In addition to security unit information, a setting information file name and an object application are associated with an “setting information ID.”

An “object application” refers to an application program that is a security assessment object. More specifically, for instance, among an OS, a Web server and a Web client, an application having security settings indicated by corresponding security unit information corresponds to an “object application.”

“Security unit information” refers to information indicating a minimum unit of security setting information which causes generation of arcs and nodes. More specifically, for instance, contents of a setting information file that is configured for an object application, contents of a user management file of an object application, access rights for files and directories and the like correspond to security unit information stored in setting information storage unit 31.

A “setting information file name” indicates a name of each piece of security unit information, and, more specifically, refers to information indicating a name of a file that includes security unit information, or information indicating a storage location of security unit information within the computer system.

Security unit information includes at least one of information such as: a name of an application program that is an object of security settings assessment; a name of a storage location of setting information such as a file name; file information indicating a structure of a file or a directory; user information indicating information of a user managed by the object application; access right information indicating an access right between a user and a file or a directory; program type; version information; network configuration information; network access right setting information; vulnerability remediation program application information; network filtering setting information, an IP (Internet Protocol) address; and a host name.

Program operation information storage unit 30 stores and retains program operation information, on which operation specifications of a program used by assessment object system 111 is described, from security setting information collected by security settings collection unit 70. “Program operation information” is information necessary for generating a node or an arc, and includes security setting information and a type of a node or an arc to be created on a model. Program operation information is stored in program operation information storage unit 30 according to type or version of the program used by assessment object system 111. In this case, a “type of a node or an arc to be created on a model” refers to a program type, version information, as well as a type of a node or an arc that is created on a model based on the version information.

Incidentally, “program operation information” may include vulnerability information. By including vulnerability information in program operation information, vulnerabilities such as flaws in the program may also be reflected as program operation information onto the model.

FIG. 4 exemplifies a data storage mode at program operation information storage unit 30. As shown, program operation information, in which security setting information and information indicating a type of a node or an arc to be created on the model are associated to each other, is stored in program operation information storage unit 30.

Security setting information included in program operation information includes: an object application indicating examination object 111; security unit information; and a setting information file name. As shown in FIG. 4, examples of “security unit information” include file information, user information, group information, and the like. “Information indicating a type of a node or an arc to be created on a model” is arranged as information indicating a host layer, a node or an arc to be created on a model such as the host layer, a file node, a user node, a group node, an arc indicating an alias and the like, which are described later.

Data transfer path generation unit 21 is provided with a function to generate a data transfer path based on security setting information (refer to FIG. 3) of examination object system 111 and program operation information (refer to FIG. 4). In the example presently described, a data transfer path that models a path in examination object system 111 on which data is transferred is generated.

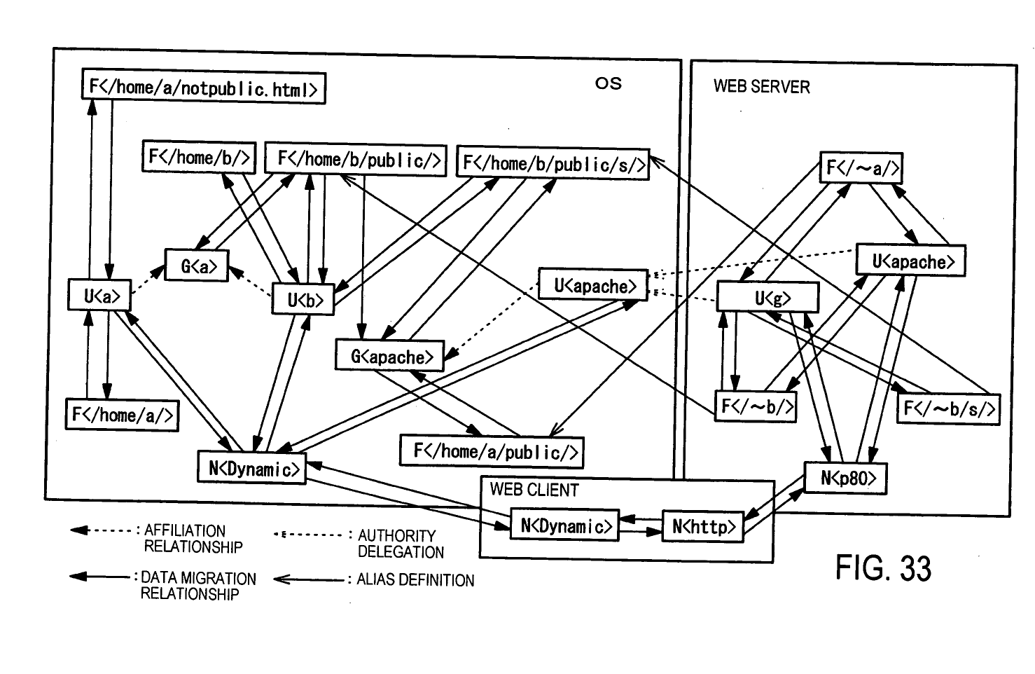

A “data transfer path” is a directed graph-representation of a modeled migration path (transfer path) of data within examination object system 111 that is determined by security setting information or program operation information of examination object system 111. While details of a data transfer path will be described later with reference to FIG. 33 and the like, a data transfer path is expressed as a host layer indicating a single computer and a program layer indicating a single program.

In a data transfer path, a program layer is expressed on top of a host layer. A plurality of program layers may exist on a host layer. A program layer is expressed as an arc and a node which are managed by a program that is an object. When there is a plurality of program layers, there may be inter-program layers that contain the arcs managed by the plurality of programs. Alternatively, when there is a plurality of host layers, there may be inter-host layers that contain the arcs managed by the plurality of host layers. When all nodes are represented uniquely, a layer structure is not necessary.

Host layers are created for each network device such as a computer or router, and contain inter-program layers and program layers that represent the programs contained in these devices.

Program layers are created for each program contained in network devices such as computers or routers. Program layers contain nodes managed by each of the programs and arcs representing the relationship between nodes.

In other words, “data transfer paths” are expressed by nodes, arcs representing the relationships between nodes, and layers representing the structures of these nodes and arcs. Arcs representing the relationships of nodes, that is, directed graph arcs, include at least one of a data migration relationship representing the migration of data; an affiliate relationship representing the affiliation between a user and a group; an alias definition relationship representing an alias definition of a file or directory and a user or group; and an authority delegation relationship for the delegation of authority to another user. Examples of data migration include writing and reading of data.

A “data migration relationship” represents that a user or a group has the rights to access files or directories, and that the user or the group has the ability to transmit or receive data with respect to the network stream. More specifically, for example, the arc of a data migration relationship from a user node or a group node towards a file node represents the ability of a user or group to write data to a file or directory. The arc of a data migration relationship from a file node or group node towards a user node represents the ability of the user or group to read the data of a file or directory. The arc of a data migration relationship from a user node or group node towards a network node represents the ability of the user or group to transmit data to the network stream. Additionally, the arc of a data migration relationship from a network node to a user node or group node represents the ability of the user or group to receive data from the network stream. The arc of a data migration relationship between network nodes represents the ability to send and receive data between network streams.

An “affiliation relationship” indicates that a user belongs to a group. More specifically, for example, the arc of an affiliation relationship from a user node to a group node represents the affiliation of the user to the group to which the user is linked by the arc.

An “alias definition relationship” represents that a plurality of files are the same file. More specifically, for example, the arc of an alias definition relationship from a file node to a file node indicates that although the names of files or the programs that manage the nodes at the two ends of an arc may differ, the two are in fact the same entity.

An “authority delegation relationship” represents that a plurality of users or groups is the same user or group. In addition, an “authority delegation relationship” represents that an operation performed by a particular user or group is realized under the authority of another user or group. More specifically, for example, the arc of an authority delegation relationship from a first user or group to a second user or group shows that the first user or group is identical to the second user or group, or that the first user or group performs an operation under the authority of the second user or group.

The nodes of the graph include at least one of: a file node representing data; a network node representing a network stream that is used by a network service; a user node representing a user account; and a group node representing a group of user accounts.

In security assessment system 100 shown in FIG. 2, according to security setting information collected by setting information collection unit 70, data transfer path generation unit 21 inquires program operation information storage unit 30 for operation specifications of a program used by examination object system 111, and generates a data transfer path within the program based on program operation information indicating operations executable by examination object system 111 and on the security setting information.

Data transfer path information storage unit 32 is constituted by, for example, a database device, and stores data transfer path information including: the data transfer paths that have been generated by data transfer path generation unit 21; security setting information that caused the creation of the arcs and nodes that are included in these data transfer paths, or information (setting information ID) indicating the location at which the security setting information is saved. The data transfer path information stored in this case is assumed to be information that enables the connection relationships of the nodes and arcs to be understood and modeled data transfer paths to be generated. Incidentally, the data transfer path information saved in data transfer path information storage unit 32 may also be data transfer path information subsequent to access right integration by access right integration unit 40.

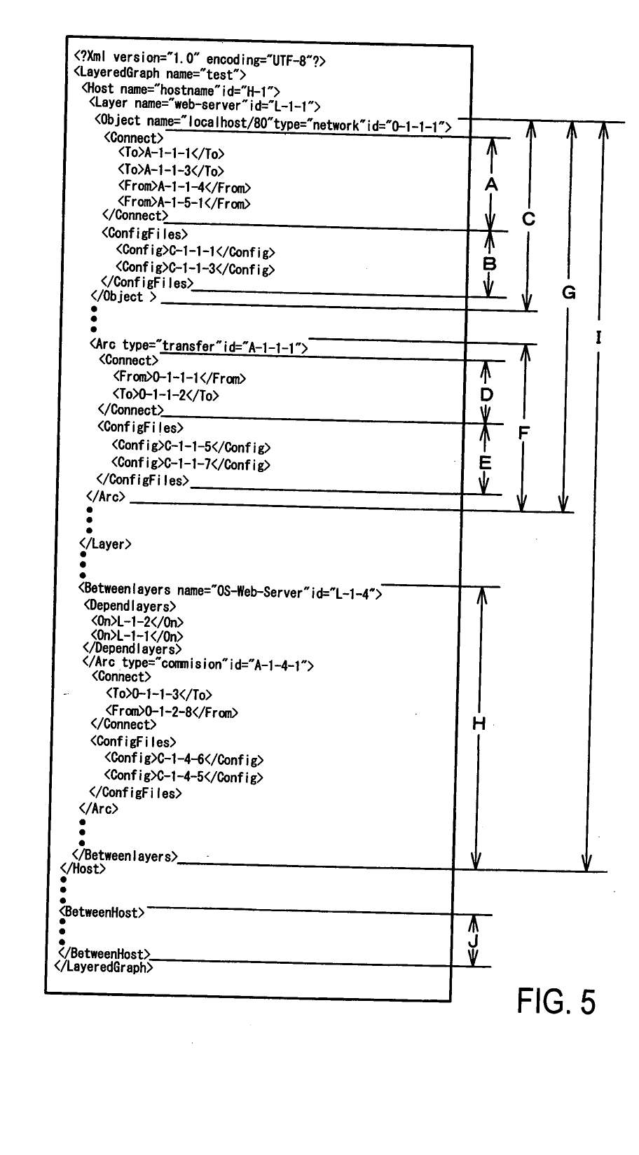

FIG. 5 shows an example of a data storage mode of data transfer path information storage unit 32. A program for modeling and expressing data transfer paths is stored in data transfer path information storage unit 32.

As shown in FIG. 5, the data structure of the program stored in data transfer path information storage unit 32 includes: an area (area “I” in FIG. 5) for storing information related to a single computer; an area (area “G” in FIG. 5) for storing information related to a program; an area (area “H” in FIG. 5) for storing information related to a plurality of programs; an area (area “F” in FIG. 5) for storing information related to arcs; an area (area “C” in FIG. 5) for storing information related to nodes; areas (areas “B” and “E” in FIG. 5) for storing identification codes (setting information IDs) of the security setting information that caused the generation of nodes or arcs; and areas (areas “A” and “D” in FIG. 5) for storing identification codes of arcs or nodes that are connected to nodes or arcs. Each of these areas may be a plurality of areas, and when a plurality of areas are provided for storing information related to a computer, an area (area “J” in FIG. 5) may be provided for storing information related to a plurality of computers.

In addition, in each of the areas shown in FIG. 5, a name is stored in the name attribute, an identification code is stored in the ID attribute, and a type of arc or node is stored in the type attribute. More specifically, the type attribute is, for example, “transfer” in the case of a data migration relationship, “commission” in the case of an authority delegation relationship, “alias” in the case of an alias definition relationship, “attach” in the case of an affiliation relationship, “user” in the case of a user node, “group” in the case of a group node, “file” in the case of a file node, and “network” in the case of a network node.

Access right integration unit 40 is provided with a function for executing processes for inquiring the operations of a plurality of programs to program operation information storage unit 30, and based on the program operation information, integrating the plurality of access rights that may be integrated to a single access right among the access rights of a plurality of programs. More specifically, access right integration unit 40 performs a process of integrating a maximum of four types of arcs (data migration relationships, affiliation relationships, alias definition relationships, authority delegation relationships) that represent the relationships of nodes to two types of arcs (data migration relationships, affiliation relationships). By integrating access rights, access right integration unit 40 converts data transfer path information to data that may be easily compared with security assessment policies.

Policy input unit 10 is provided with a function for reading security assessment policies stored in policy storage unit 33 and entering these policies to assessment unit 50.

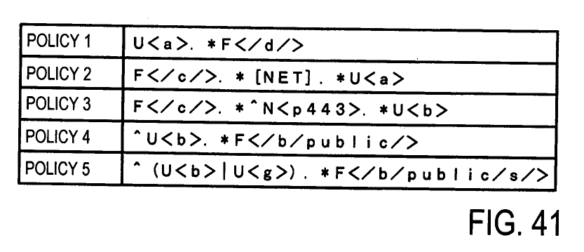

“Policies” represent access by the migration paths of data and specify at least the initial point and the final point of the migration path of data. Among policies, those in particular that represent improper access for the purpose of security assessment by data migration paths are called “security assessment policies,” as will be explained later with reference to FIG. 41. In other words, “security assessment policy” refers to a policy in which improper data transfer paths in examination object system 111 are specified. Improper data transfer paths include, for example, data transfer paths that should not exist and unauthorized data transfer paths. “Security assessment policies” are set in advance by, for example, a system administrator and are stored in policy storage unit 33. Alternatively, as described later, “security assessment policies” may be created by the security assessment data generation system according to the present invention and stored in policy storage unit 33.

“Policies” may specify not only the initial point and final point of data but also an intermediate path. If the intermediate path is specified, such risks as information leakage may be taken into consideration and a data transfer path that passes a specific path may be specified.

In policies, the nodes making up a computer system are specified for the initial point, final point, and intermediate path. Nodes include at least one of file nodes, network nodes, user nodes, and group nodes.

Assessment unit 50 is provided with a function for executing processing for retrieving paths that are described by security assessment policies among data transfer paths for which access rights have been integrated by access right integration unit 40. Assessment unit 50 includes data transfer path conversion unit 51 and pattern matching unit 52.

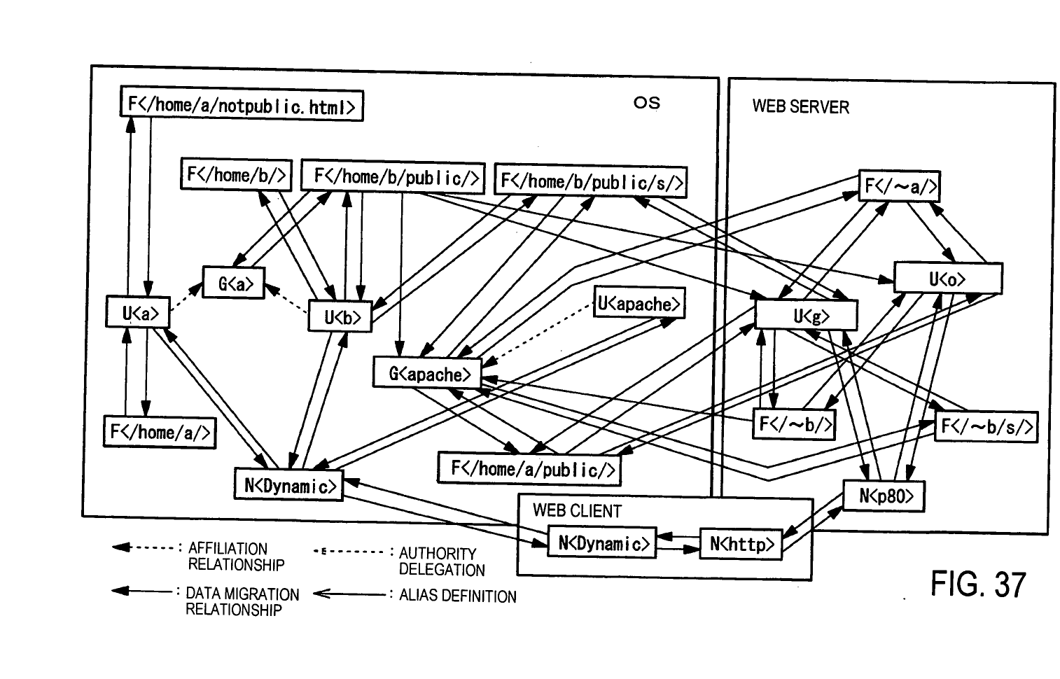

Data transfer path conversion unit 51 is provided with a function for converting data transfer paths in which a plurality of access rights have been integrated by access right integration unit 40 to data that allows comparison with security assessment policies that have been entered by policy input unit 10. In other words, data transfer path conversion unit 51 converts the form of expression of data transfer paths that have been generated by data transfer path generation unit 21. A data transfer path for which a plurality of access rights have been integrated will be described later with reference to FIG. 37, while data that may be compared with a security assessment policy will be described later with reference to FIG. 39.

Pattern matching unit 52 is provided with a function for retrieving, from data transfer paths that have been converted by data transfer path conversion unit 51, data transfer paths that conform with the security assessment policies that have been entered by policy input unit 10. A data transfer path that conforms with a security assessment policy is referred to as an improper path.

Setting information retrieval unit 80 is provided with a function for using information that indicates improper paths that have been retrieved and delivered by pattern matching unit 52 and data transfer path information that has been stored in data transfer path information storage unit 32 in order to search for security setting information that caused the generation of an improper path (i.e., improper setting information) from security setting information stored in setting information storage unit 31.

In the present embodiment, setting information retrieval unit 80 is configured to retrieve improper setting information from security setting information stored in setting information storage unit 31. However, if security setting information is stored in place of setting information ID in the data transfer path information (refer to FIG. 5), improper setting information may be retrieved without searching setting information storage unit 31. In such a case, setting information retrieval unit 80 is provided with a function for using improper path information that has been retrieved and outputted by pattern matching unit 52 and data transfer path information stored in data transfer path information storage unit 32 in order to search for all nodes and arcs that caused the generation of improper paths (refer to steps S291 to S294 described hereinbelow), and retrieving improper setting information by retrieving security setting information stored together with the nodes and arcs that have been retrieved using the above-described data transfer path information.

Assessment result display unit 60 is composed of a display device such as a liquid crystal display, and is provided with a function for performing a screen display of improper settings represented by improper setting information retrieved by setting information retrieval unit 80. This security assessment device 100 is thus capable of pointing out the locations at which setting errors were made, that is, the locations at which the security setting information is set; to the administrator of the examination object system. The improper paths represented by the improper path information may also be displayed.

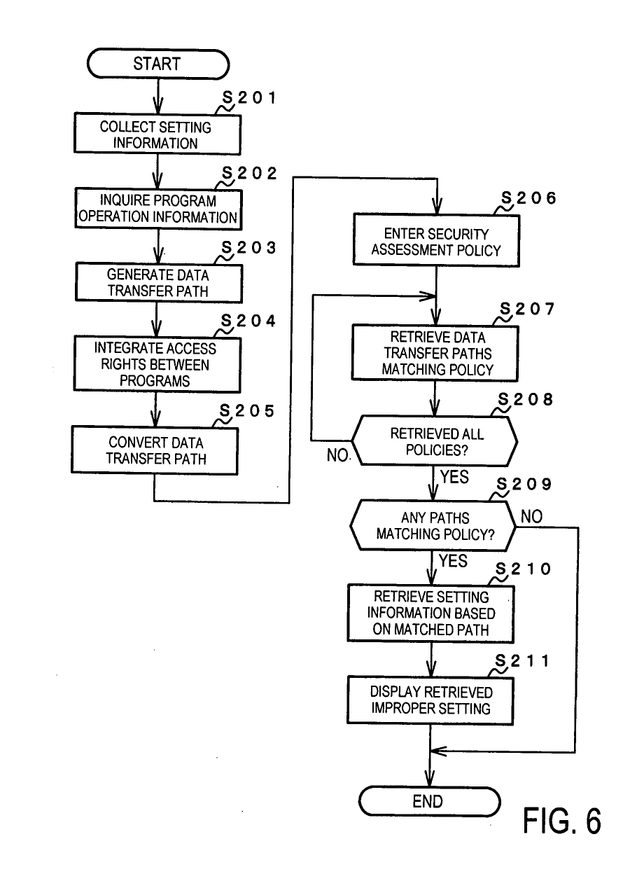

Next, operations of security assessment system 100 of a first exemplary configuration will be described in detail. FIG. 6 is a flowchart showing security assessment processing executed by security assessment system 100 shown in FIG. 2.

In the security assessment processing, in step S201, setting information collection unit 70 first collects security setting information of assessment object 111 and stores the collected security setting information in setting information storage unit 31. In step S202, data transfer path generation unit 21 refers to the security setting information that has been collected and stored in setting information storage unit 31 by setting information collection unit 70, and submits a request to program operation information storage unit 30 for program operation information related to assessment object 111. In other words, based on the program name of the object application, the setting information file name, and the security unit information corresponding to the setting file that is indicated by the setting information file name which have been collected by setting information collection unit 70, data transfer path generation unit 21 inquires program operation information storage unit 30 for the type of nodes or arcs to be generated on a model.

Subsequently, data transfer path generation unit 21 uses the security setting information collected by setting information collection unit 70 and stored in setting information storage unit 31 and the program operation information that has been read in accordance with the inquiry of step S202 to generate data transfer path information in step S203. After generating the data transfer path information, data transfer path generation unit 21 stores the generated data transfer path information in data transfer path information storage unit 32.

Since data transfer path generation unit 21 creates various nodes and arcs when creating data transfer path information in step S203, creation of such nodes and arcs will now be described.

Data transfer path generation unit 21 uses information that indicates the user contained in the security setting information to inquire program operation information storage unit 30 for the nodes to be created, and creates a user node that indicates the user contained in the user information. For example, if a user ID managed by a particular program is included, data transfer path generation unit 21 creates a user node.

Data transfer path generation unit 21 uses information that indicates the group contained in the security setting information to inquire program operation information storage unit 30 about nodes to be created, and creates a group node that indicates the group contained in the group information. For example, if a group ID managed by a particular program is included, a group node is created.

Data transfer path generation unit 21 uses network stream information that is used by a server included in the security setting information to inquire program operation information storage unit 30 for nodes to be created, and creates a network node representing the network stream. For example, if a network stream used by a particular program is written, data transfer path generation unit 21 creates a network node.

Data transfer path generation unit 21 uses information that represents a file structure included in the security setting information to inquire program operation information storage unit 30 for a node to be created, and creates a file node representing a file or directory. For example, if file or directory structures managed by a particular program are included, a file node corresponding to each file or directory is created.

Furthermore, data transfer path generation unit 21 uses a file structure, information indicating access rights, or information to the effect that a program is installed which is included in the security setting information to inquire program operation information storage unit 30 for arcs to be created, and creates arcs indicating the data migration relationships. For example, if a user is capable of reading a file, data transfer path generation unit 21 creates an arc representing the data migration relationship from the file node to the user node.

Similarly, if the user is capable of writing to the file, data transfer path generation unit 21 creates an arc representing the data migration relationship from the user node to the file node. If the user is capable of transmitting data to the network stream, data transfer path generation unit 21 creates an arc representing a data migration relationship from the user node to the network node. If the user is capable of receiving data from the network stream, data transfer path generation unit 21 creates an arc representing a data migration relationship from the network node to the user node. If a group is capable of reading the file, data transfer path generation unit 21 creates an arc representing a data migration relationship from a file node to a group node.

Similarly, if the group is capable of writing to the file, data transfer path generation unit 21 creates an arc representing the data migration relationship from the group node to the file node. If the group is capable of transmitting data to the network stream, data transfer path generation unit 21 creates an arc representing a data migration relationship from the group node to the network node. If the group is capable of receiving data from the network stream, data transfer path generation unit 21 creates an arc representing a data migration relationship from the network node to the group node. If data may be transmitted and received between network streams, data transfer path generation unit 21 creates an arc of a data migration relationship according to the direction of migration of data between the network streams.

Data transfer path generation unit 21 uses information specifying users that belong to a group contained in the security setting information to inquire program operation information storage unit 30 for arcs to be created, and thus creates arcs representing affiliation relationship. For example, if a user belongs to a group, data transfer path generation unit 21 creates an arc of an affiliation relationship from the user to the group.

Data transfer path generation unit 21 uses information indicating users that execute programs that are contained in the security setting information to inquire program operation information storage unit 30 for arcs to be created, and thus creates arcs representing authority delegation relationships. For example, if a user managed by a particular program executes the program by means of the settings of a user that executes the program as another user managed by another program, data transfer path generation unit 21 creates an arc of an authority delegation relationship from the particular user node toward another user node.

Data transfer path generation unit 21 uses the file information or the file structure information of a server that is included in the security setting information to inquire program operation information storage unit 30 for arcs to be created, and thus creates arcs representing authority delegation relationships. For example, if a file managed by a particular program is managed under an alias by another program, data transfer path generation unit 21 creates an arc of an alias definition relationship from the file node managed at the particular program toward the file node managed at the other program.

In step S204, access right integration unit 40 reads data transfer path information that has been generated by data transfer path generation unit 21 from data transfer path information storage unit 32, and if an arc indicating an alias definition relationship and an arc indicating an authority delegation relationship are included in the data transfer path that is indicated by the read data transfer path information, access right integration unit 40 performs a process for integrating the access rights between the nodes belonging to the same layer for the four nodes that are at both ends of these arcs, in a data migration relationship that exceeds a layer. In other words, when the migration of data between the node at the initial point of an arc representing an alias definition relationship and the node at the initial point of an arc representing an authority delegation relationship is the same direction as the migration of data between nodes at the final points of the respective arcs, the arcs of the integrated data migration relationship are newly created and the arcs of the relevant alias definition relationship and the authority delegation relationship are deleted. In this case, the direction of data migration is the direction of data migration from the user (group) nodes to the file nodes or the direction of data migration from the file nodes to the user (group) nodes.

In step S205, data transfer path conversion unit 51 accepts from access right integration unit 40 data transfer path information in which the access rights related to a plurality of programs have been integrated, and executes processing to convert the received data transfer path information to data transfer path information representing data transfer paths that allow retrieval of a data transfer path that conforms with the security assessment policies. As described later, an example of such a data transfer path is shown in FIG. 39.

Next, in step S206, in accordance with, for example, an instruction from an operator, policy input unit 10 reads security assessment policies indicating undesirable data migration paths from policy storage unit 33 and enters these policies to pattern matching unit 52.

In step S207, pattern matching unit 52 compares the data transfer path information that has been converted by data transfer path conversion unit 51 with the security assessment policies entered by policy input unit 10, and performs retrieval to determine whether a data transfer path that matches the security assessment policies exists within the data transfer paths indicated by the data transfer path information.

As shown in step S208, the retrieval process of step S207 is repeatedly executed for each of the security assessment policies that have been entered by policy input unit 10, and executed for all of the security assessment policies that have been entered by policy input unit 10. In step S208, when it is determined that retrieval processing has been concluded for all security assessment policies, pattern matching unit 52 outputs results of retrieval processing to setting information retrieval unit 80.

Upon receiving the results of the retrieval process, setting information retrieval unit 80 confirms in step S209 whether an improper path has been retrieved. When an improper path does not exist, the processing may be terminated as-is, or may be terminated after displaying that an improper setting has not been retrieved.

If an improper path is found in step S209, setting information retrieval unit 80 executes, in step S210, a process for retrieving to find the improper settings that were the cause for generating the retrieved improper path among the security setting information that is stored in setting information storage unit 31. Then, upon receiving the retrieval results, assessment result display unit 60 performs processing for displaying improper setting information indicating the retrieved improper setting in step S211, and subsequently concludes the series of processing.

As described above, the security assessment system shown in FIG. 2 is configured to compare data transfer paths that are based on the security setting information of programs that are used in examination object system 111 with security assessment policies indicating paths of undesirable migration of data to retrieve data transfer paths including improper paths that are based on improper settings. As a result, by using the security assessment system, it is capable to specify that a setting is an improper setting and pointing out the setting to an administrator even when it is impossible to determine whether a setting is an improper setting by identifying the separate setting of the examination object system. In other words, the security assessment system enables the retrieval of composite setting errors that may potentially cause difficulties by existing as a plurality even when each of the setting errors would not by itself cause a problem, and enables the assessment of the existence or absence of composite setting errors, which in turn allows a rigorous assessment of security settings.

The security assessment system shown in FIG. 2 is configured to collect security setting information from examination object system 111, model a data transfer path, and specify security assessment policies in order to assess the existence or absence of improper settings, and is thereby capable of specifying improper settings in accordance with the actual operating state of examination object system 111. Therefore, by using security assessment system 100, examination object system 111 may actually be operated in a safe manner. In other words, by performing assessment prior to the operation of examination object system 111, the assessment results may be employed as a guide for implementing security settings. Furthermore, since security assessment system 100 is configured to assess the existence or absence of composite setting errors without adopting a method such as a pseudo-attack that would place a large burden on examination object system 111, the load upon examination object system 111 during assessment may therefore be reduced.

Second Security Assessment System:

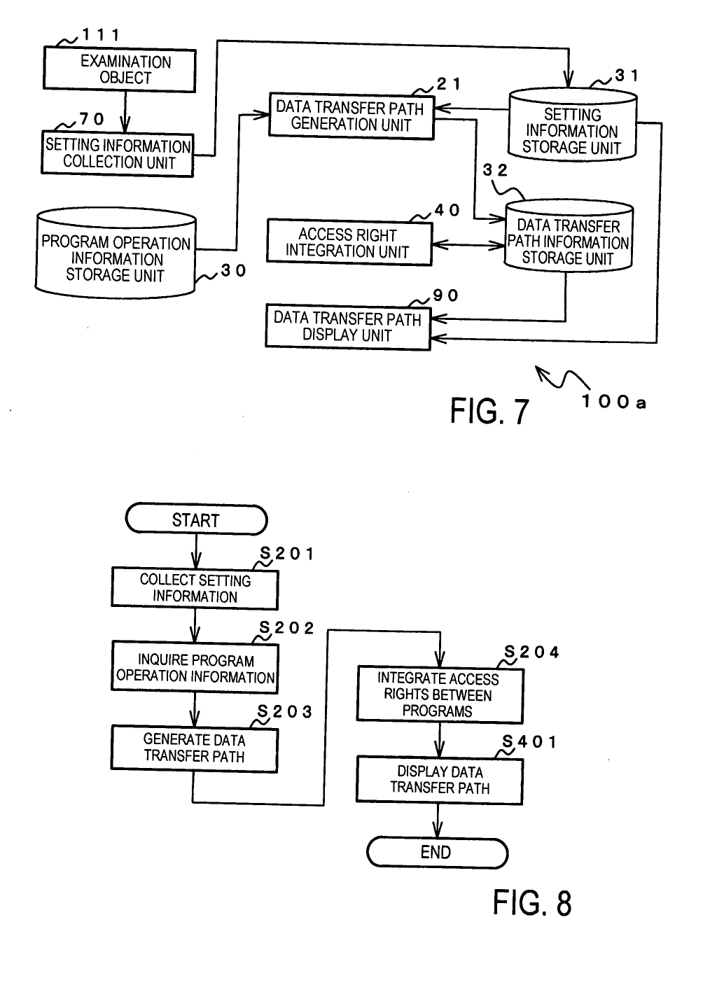

FIG. 7 shows an example of a configuration of second security assessment system 100a. In the following description, parts having the same configuration and perform the same processing as parts in above-described security assessment system 100 shown in FIG. 2 are assigned the same reference characters and detailed description of these parts is hereby omitted.

As shown in FIG. 7, security assessment system 100a assesses the security settings of examination object 111, and includes: setting information collection unit 70, setting information storage unit 31, program operation information storage unit 30, data transfer path generation unit 21, data transfer path information storage unit 32, access right integration unit 40, and data transfer path display unit 90.

Data transfer path display unit 90 is constituted by a display device such as a liquid crystal display and is provided with a function for performing screen display of data transfer paths that are indicated by data transfer path information stored in data transfer path information storage unit 32 in association with the security setting information stored in setting information storage unit 31. More specifically, data transfer path display unit 90 effects screen display of data transfer paths that have been generated by data transfer path generation unit 21 and data transfer paths that have been generated by access right integration unit 40.

Next, operations of security assessment system 100a will be described. FIG. 8 shows an example of security assessment processing executed by security assessment system 100a.

In the security assessment processing, the processes of steps S201 to S204 described above are first executed. Then, in step S401, data transfer path display unit 90 provides screen display of the data transfer paths indicated by the data transfer path information that was generated by access right integration unit 40 and that is stored in data transfer path information storage unit 32 in association with the security setting information stored in setting information storage unit 31. In other words, data transfer path display unit 90 displays the data transfer path information represented by the data transfer path information that was generated by access right integration unit 40 in association with security setting information that includes security unit information corresponding to the setting information ID that is contained in this data transfer path information.

In the above-described example, data transfer path display unit 90 is configured to retrieve and read, from setting information storage unit 31, security setting information corresponding to setting information IDs that are contained in data transfer path information that was generated by access right integration unit 40. However, when security setting information is stored in place of setting information IDs in data transfer path information that has been generated by access right integration unit 40, the security setting information may be specified without searching setting information storage unit 31. In such a case, data transfer path display unit 90 may display the data transfer paths that are indicated by data transfer path information generated by access right integration unit 40 in a display mode, such as highlighted display, that allows recognition of security setting information contained in this data transfer path information.

As described hereinabove, since security assessment system 100a is configured such that security setting information is collected from assessment object system 111, data transfer paths are modeled, and the data transfer paths are displayed on a screen, it is now possible to confirm the flow of data involving a plurality of programs which is not verifiable from the individual settings alone. As a result, an assessor of the system can assess the correctness of the settings by confirming the flow of data after performing actual settings. In addition, with security assessment system 100a, since the flow of data and the security settings that is causing the creation of this flow are displayed in association with each other, the assessor is now able to retrieve composite setting errors in an easy manner.

Third Security Assessment System

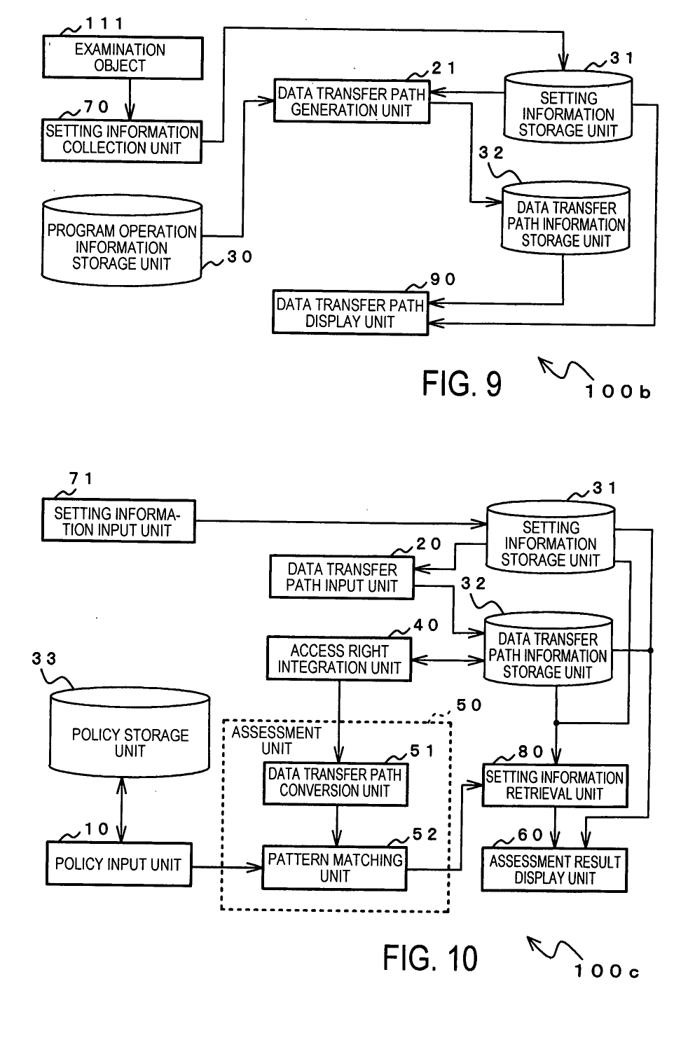

FIG. 9 shows an example of a configuration of third security assessment system 100b. In the following description, parts having the same configuration and perform the same processing as the parts in above-described security assessment system 100a shown in FIG. 7 are assigned the same reference characters and a detailed description of these parts is hereby omitted.

Security assessment system 100b shown in FIG. 9 is similar to security assessment system 100a shown in FIG. 7, with the exception of security assessment system 100b not provided with access right integration unit 40.

In the present embodiment, data transfer path display unit 90 screen-displays, without modification, the data transfer paths indicated by the data transfer path information that has been generated by data transfer path generation unit 21.

As seen, security assessment system 100b is configured to collect the security setting information of the computer system of examination object 111, generate data transfer paths in accordance with program operation information, and display the generated data transfer paths. Therefore, by using security assessment system 100b, individual security setting information may be confirmed by confirming the data transfer paths that are displayed. Accordingly, a person such as a system assessor can easily recognize errors in the composite settings of a specific program.

Fourth Security Assessment System:

FIG. 10 shows an example of a configuration of fourth security assessment system 100c. In the following description, parts having the same configuration and perform the same processing as parts in above-described security assessment system 100 shown in FIG. 2 are assigned the same reference characters, and detailed description of these parts is hereby omitted.

Security assessment system 100c shown in FIG. 10 is similar to security assessment system 100 shown in FIG. 2, with the exception of security assessment system 100c provided with a data transfer path input unit 20 provided in place of data transfer path generation unit 21, and setting information input unit 71 provided in place of setting information collection unit 70. In other words, this security assessment system 100c is configured to receive input of data transfer paths specified by an assessor or the like via data transfer path input unit 20, and to receive input of security setting information that has been specified by the assessor or the like via setting information input unit 71.

Data transfer path input unit 20 is provided with a function for delivering data transfer path information that has been specified (selected and entered) by the operation of a user such as a system assessor to data transfer path information storage unit 32, and for storing this information in data transfer path information storage unit 32.

Setting information input unit 71 is provided with a function for delivering security setting information (refer to FIG. 3) that has been specified (selected and entered) by means of the operations of a user such as a system assessor to setting information storage unit 31, and for storing the information in setting information storage unit 31. Setting information input unit 71 is further provided with a function for, in accordance with the operations of the assessor or the like, for each of the arcs and nodes of data transfer paths that have been entered by data transfer path input unit 20, entering security setting information indicating the security settings that causes entering of these data transfer paths, in association with the arcs and nodes. In response to the designation by the assessor or the like of nodes or arcs together with the security setting information that causes the creation of these nodes or arcs, setting information input unit 71 stores in setting information storage unit 31 the security setting information that has been associated with the arcs and nodes.

In addition to the above-described functions, setting information input unit 71 is provided with a function for delivering security setting information that has been specified by means of the operations of a user such as a system assessor to setting information storage unit 31 and of storing the security setting information in setting information storage unit 31, and a function for entering, in association with arcs and nodes for each arc and node of the data transfer paths that have been entered by data transfer path input unit 20 in accordance with operations by the assessor or the like, security setting information indicating the security settings that causes entering of these data transfer paths.

Security assessment system 100c is effective when the user such as a system assessor and a system administrator has a skill for checking the security setting information and operation information of the programs in examination object system 111 and generating data transfer path information that indicates the migration paths of data in assessment object system 111. In other words, security assessment system 100c is able to assess whether an improper path based on improper settings is included in data transfer path information generated by an assessor or an administrator.

In this example, setting information input unit 71 enters security setting information that has been set by the assessor or the like to setting information storage unit 31 in accordance with the operations of the assessor or the like in security assessment processing. Data transfer path input unit 20 next enters data transfer path information that has been set by the assessor or the like to data transfer path information storage unit 32 in accordance with operation by the assessor or the like. Subsequently, the processes of steps S204 to S211 described earlier are executed.

As seen, since security assessment system 100c is configured to execute security assessment processing using data transfer path information and security setting information that have been specified by a user such as a system assessor, it is now possible to assess whether an improper path based on improper settings is included in the data transfer path information generated by the system assessor or the system administrator. Further, the embodiment may be configured such that one of security setting information and data transfer path information is specified by the assessor or the like.

The foregoing description concerned a configuration of security assessment system 100c using data transfer path information and security setting information that have been specified by a user such as a system assessor. However, a configuration is also possible that employs data transfer path information generated by a system other than security assessment system 100c and security setting information that has been collected by another system. Such a configuration enables assessment of whether an improper path based on improper settings is included in data transfer path information that has been generated by another system. More specifically, using the output of a system that performs, for example, security settings or equipment settings, that is, a system that sets a network or equipment thereof, as the input to security assessment system 100c enables the assessment of whether settings to be made match security assessment policies and allows improper settings to be pointed out. This approach may facilitate responses for performing safer security settings and system design. Further, coordinating with, for example, resource management software for software and hardware and version management software for managing software versions and entering output based on this software to security assessment system 100c enables defects in the settings of a currently operating system to be pointed out.

Fifth Security Assessment System:

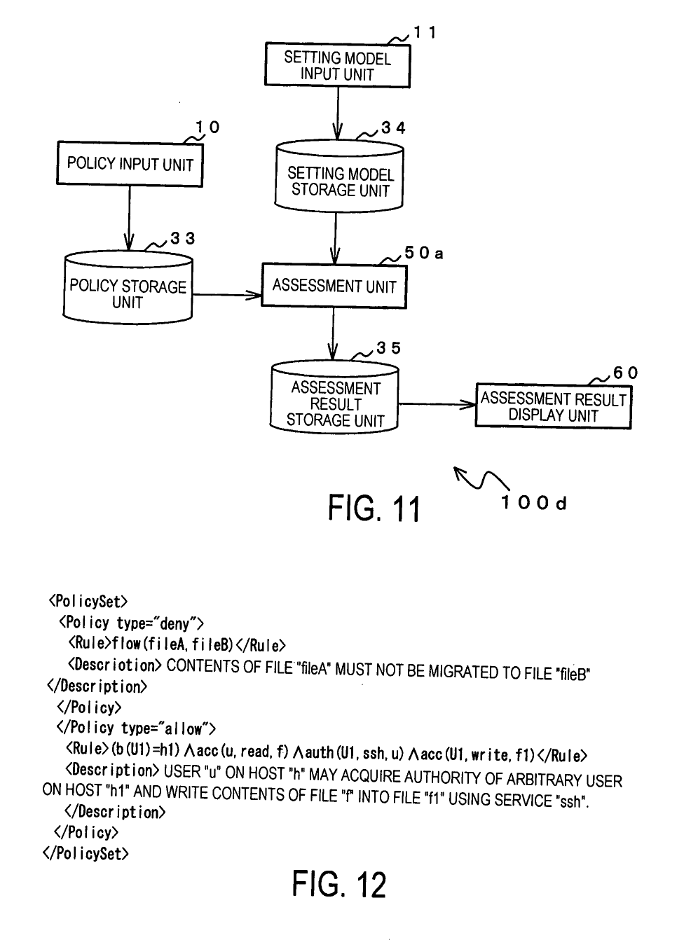

FIG. 11 shows an example of a configuration of fifth security assessment system 100d. In the following description, parts having the same configuration and perform the same processing as parts in above-described security assessment system 100 shown in FIG. 2 are assigned the same reference characters, and detailed description of these parts is thereby omitted.

As shown in FIG. 11, security assessment system 100d includes: setting model input unit 11, setting model storage unit 34, policy input unit 10, policy storage unit 33, assessment unit 50a, assessment result storage unit 35, and assessment result display unit 60.

Policy input unit 10 is operated by a user such as a system assessor and is provided with a function for describing security assessment policies and storing these policies in policy storage unit 33.

Setting model input unit 11 is operated by a user such as a system assessor, and a setting model in accordance with the system configuration is entered. A detailed description on “setting models” will be given hereinbelow. In this case, setting models that reflect the security setting information, which is setting information that relates to the security of devices that make up the examination object system are entered to setting model input unit 11.

Setting model storage unit 34 is made up by, for example, a database device, and stores the setting models that have been entered to setting model input unit 11.

Assessment unit 50a extracts policies that have been stored in policy storage unit 33, compares these with setting models that have been stored in setting model storage unit 34, and assesses whether setting models are present or absent that match the security assessment policies or whether setting models are present or absent that do not match the security assessment policies.

In this example using security assessment system 100d, the term “security assessment policies” refers not only to policies describing conditions that should not be met by the examination object system, but also to policies describing conditions that should be met by the examination object system. In addition, to distinguish the two types of policies, the former shall be referred to as “prohibition policies” and the latter shall be referred to as “permission policies.” “Security assessment policies” are later described in detail, but are described using symbols such as: b( ), acc( ), cas( ), auth( ), and flow( ).

Assessment result storage unit 35 is made up by, for example, a database device, and stores the assessment results from assessment unit 50a. More specifically, when the obtained results match the security assessment policies, assessment result storage unit 35 stores as assessment results both the relevant security assessment policy and the setting model that matched the policy. When the obtained results do not match the security assessment policies, assessment result storage unit 35 stores the relevant security assessment policies. In this case, assessment result storage unit 35 may store the policies together with a symbol indicating that matching did not occur.

To present the assessor or the like with the assessment results from assessment unit 50a which are stored in assessment result storage unit 35, assessment result display unit 60 is provided with a function for executing a process for displaying security assessment policies together with setting models that have matched with these security assessment policies or symbols indicating that no matching occurred.

“Setting models” will now be described.

“Setting models” are models of the configuration of the examination object system that are based on the security setting information and program operation information of the examination object system. Setting models are descriptions of, for example, the overall configuration and operations of the object system by an assessor or designer which is described in a model description language. “Model description language” is a descriptive language capable of representing, for example, system configuration and security settings.

This type of “setting model” is composed of a plurality of elements that are specified by program operation information (e.g., refer to FIG. 4). More specifically, the elements composing a setting model correspond to, for example: a set of hosts that represents the hosts making up the examination object system; a network connection expression representing the network configuration of the examination object system; a set of users that represents users or groups; a set of files that represents data storage locations; a set of service names that represents operations by users upon files or the network service; an access control matrix expression that represents the authority of users with respect to files; a network access expression that expresses network filtering; an authority acquisition relationship of network service that represents the authority acquisition relationship between users using a network; and a cascade relationship that represents services that, when a user uses a network service or an affiliation relationship between users and groups to acquire the authority of another user, may be used under the authority of the user having acquired authority.

A detailed description of the elements that make up setting models will now be provided.

“Host” represents a network device such as a computer or router and has one or more IP addresses.

“Network connection expression” represents the network configuration on the level of the Internet layer of the assessment object system, and is represented as a non-directed graph that takes IP addresses as nodes. More specifically, a network connection expression that is composed of the five IP addresses, for example, “192.168.1.1”, “192.168.1.2”, “192.168.2.3”, “192.168.2.4”, and “192.168.2.5” takes these five IP addresses as nodes and expresses the connection configuration of each node by a graph that shows a connection relationship without directionality. An example of such a network connection expression is shown in FIG. 68, to be explained hereinbelow.

A “network access expression” expresses as a model the operations of a network filtering device that denies or permits the passage of a packet according to the IP address or port number of this packet when the packet is communicated through a network. Such a “network access expression” is expressed by the set of the four items: IP address of a host on which network filtering is implemented; IP address of the transmission source of the packet that is an object of control; IP address of the transmission destination; and port number of the transmission destination. More specifically, a network access expression is expressed by means of symbols that signify the content of the above-described four items, such as “n(ip1, s-ip, d-ip, d-port).” This expression “n(ip1, s-ip, d-ip, d-port)” means that a TCP (Transmission Control Protocol) connection is permitted at the host having the IP address “ip1” in which the transmission source IP address is “s-ip,” the transmission destination IP address is “d-ip,” and the port number of the transmission destination is “d-port.”

A “network access expression” may include the source port number. With such a configuration, packet filtering by means of the source port number can also be expressed. A “network access expression” may also include the protocol type. With such a configuration, the expression of not only TCP packet filtering, but also of UDP (User Datagram Protocol) packet filtering will be possible.

In addition, a “network access expression” may also express a prohibition case as a model without expressing a permission case. With such a configuration, network access expressions may be described concisely and simply in a system in which permission is set in principle. Such a case necessitates inversion of the determination of the permission or denial of the passage of packets, which will be described hereinbelow. More specifically, in a case of a permitted network access expression, the inclusion of a network access expression in the setting model allows determination that communication is permitted, while in a case of a prohibited network access expression, the lack of a network access expression in the setting model allows determination that communication is permitted.

“User” refers to the subject of access control in the file access control mechanism of an operating system (OS) and application software. More specifically, “user” is defined by means of file “/etc/passwd” and group is defined by means of file “/etc/group” in the Linux operating system, and a user and group that are thus defined are “users” in a setting model. In an Apache server, the subjects of the file access control mechanism belonging to a server may be defined by the file “htpasswd,” and these subjects also correspond to “users.”

A “user” belongs to any of the hosts. The affiliation relationship of this user is expressed by, for example, “b(u1)=h1.” The expression “b(u1)=h1” means that user “u1” belongs to host “h1.”

“File” refers to the object of access control in the file access control mechanism of an OS or application software. “File” does not refer to the actual content of data, but rather, to the location of data that is identified by, for example, a path name. A “file” belongs to any of the hosts. The affiliation relationship of this file is expressed by, for example, “b(f1)=h1.” The expression “b(f1)=h1” means that file “f1” belongs to host “h1.”

“Service name” refers to the name of an operation that a user can execute upon a file, or to the name of a service that is receivable by a user via a network. Operations that a user may execute upon a file include, for example, “read” or “write,” while services that are receivable by a user via a network include, for example “http” or “ssh.” The service name “null” that represents a vacant service is also defined. As will later be explained, service “null” can also describe the relationship of user and group in a typical OS.

“Access control matrix expression” represents whether a user is permitted to read from or write to a file and is expressed by user “u,” file “f,” and service “s” representing read or write. Access control matrix expression “acc(u, s, f)” indicates that user “u” is able to perform service “s” with respect to file “f.” More specifically, if user “tutor” is able to read file “answer.txt,” the access control matrix expression is acc(tutor, read, answer.txt).

“Authority acquisition relationship” indicates that a user of a particular host can use a service to acquire the authority of another user. The authority acquisition relationship “auth (u1, s, u2)” indicates that user “u1” can use service “s” to acquire the authority of user “u2.” More specifically, auth(student, telnet, guest) indicates that user “student” can use service “telnet” to log in as a user “guest.” In this case, user “student” can access files on the host to which user “guest” belongs by the authority of user “guest.” Alternatively, auth(taro, null, student) indicates that when user “taro” and group “student” belong to the same host, user “taro” belongs to group “student.” In this case, user “taro” can unconditionally access files on the host to which the group “student” belongs by the authority of the user “student.”

“Cascade relationship” indicates a relationship in which a user uses a service to acquire the authority of another user and there is a service that can be used by the acquired authority of another user. This “cascade relationship” is determined by the user after acquisition of authority and the type of service that was used to acquire authority, and is expressed by the symbol cas(s1, u, s2) when service “s1” is used to acquire the authority of user “u” and thus gain the ability to use service “s2.” More specifically, when service “telnet” is used to acquire the authority of user “u” and thus enable use of service “ftp,” the expression is cas(telnet, u, ftp).

The respective symbols for composing a security assessment policy will now be described.

The symbols b( ), acc( ), auth( ), and cas( ) composing security assessment policies are used for respectively expressing an affiliation relationship, an access control matrix expression, an authority acquisition relationship, and a cascade relationship. In addition, flow( ) that composes a security assessment policy is used for expressing a data flow relationship between two files. For example, the security assessment policy “flow(file-a, file-b)” indicates that data flows from file “file-a” to file “file-b.” In other words, this expression indicates that the content of file “file-a” is written via any user or service to file “file-b.”

Linking each of these predicates (symbols) enables the expression of the flow of data within a system. This linking is an AND combination (represented by “̂”) and indicates that the entirety is realized for such cases in which all predicates are true. In addition, logic variables may be used for each predicate.

For example, the expression (b(U)=h)̂(b(F1)=h1)acc(U, read, f)̂auth(u1, ftp, U)̂acc(u1, write, F1) indicates that a particular user “U” belongs to host “h,” a particular file “F1” belongs to host “h1,” user “U” is capable of reading file “f,” user “u1” is capable of using service “ftp” to acquire the authority of user “U,” and user “u1” is capable of writing to file “F1.” In other words, user “u1” can use service “ftp” to read file “f” on host “h” and then write to a file on host “h1.” The use of an upper-case alphabetical character in a predicate indicates a logical variable, that is, indicates an arbitrary user, file, host, or service.

Policy storage unit 33 stores and retains security assessment policies that have been entered at policy input unit 10. More specifically, policy storage unit 33 stores security assessment policies in a format such as shown in FIG. 12. A plurality of security assessment policies may be stored in a file or database for storing security assessment policies, and these files or databases may be used to store not only security assessment policies, but also information accompanying security assessment policies.

Information accompanying security assessment policies includes policy classifications and descriptions that describe the meanings of policies in a manner that is human-legible. Furthermore, policy storage unit 33 stores whether a security assessment policy represents a permission policy or a prohibition policy. For example, as shown in FIG. 12, when the type attribute of the Policy element is “allow,” a permission policy is represented which indicates that the setting model corresponding to the policy must exist, and when the type attribute is “deny,” a prohibition policy is represented in which the model corresponding to the policy should not exist.

Next, operations of security assessment system 100d will be described in detail.

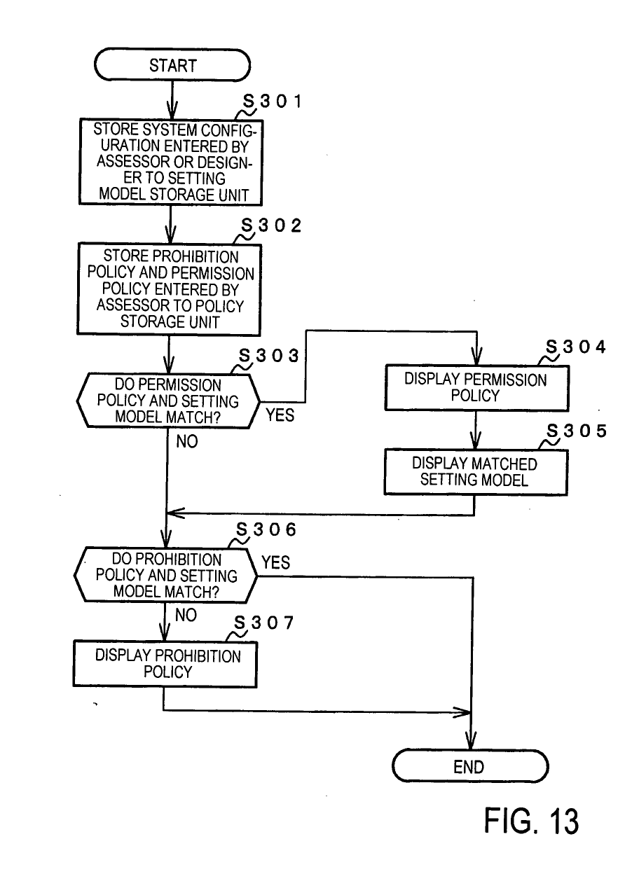

FIG. 13 shows security assessment processing that is executed by security assessment system 100d.

First, when a user such as a security assessor or a system builder operates setting model input unit 11 and enters a setting model in accordance with the system that is the assessment object or the system configuration of a system that is to be constructed, setting model input unit 11 stores the setting model that is entered in setting model storage unit 34 in step S301. When the assessor or the like operates policy input unit 10 to enter security assessment policies indicating the conditions that the system must or must not fulfill, policy input unit 10 stores the entered security assessment policies in policy storage unit 33 in step S302. Next, in accordance with the assessor's instructions, assessment unit 50a extracts one or more security assessment policies from policy storage unit 33.

If the entered policy is a permission policy, assessment unit 50a searches to determine whether a setting model that matches this permission policy exists in step S303. If the result of the search shows that a matching setting model exists, assessment unit 50a displays the permission policy in step S304, and displays the setting model that matches this permission policy in step S305. The processing subsequently proceeds to step S306. In step S306, the processing proceeds to step S306 even when a setting model that does not match the permission policy does not exist.

In step S306, if the entered policy is a prohibition policy, assessment unit 50a searches to determine whether a setting model that matches this prohibition policy exists. If the prohibition policy matches a setting model, the process simply ends at this point, but if the prohibition policy does not match a setting model, assessment result display unit 60 displays this prohibition policy together with a symbol indicating that matching did not occur in step S307.

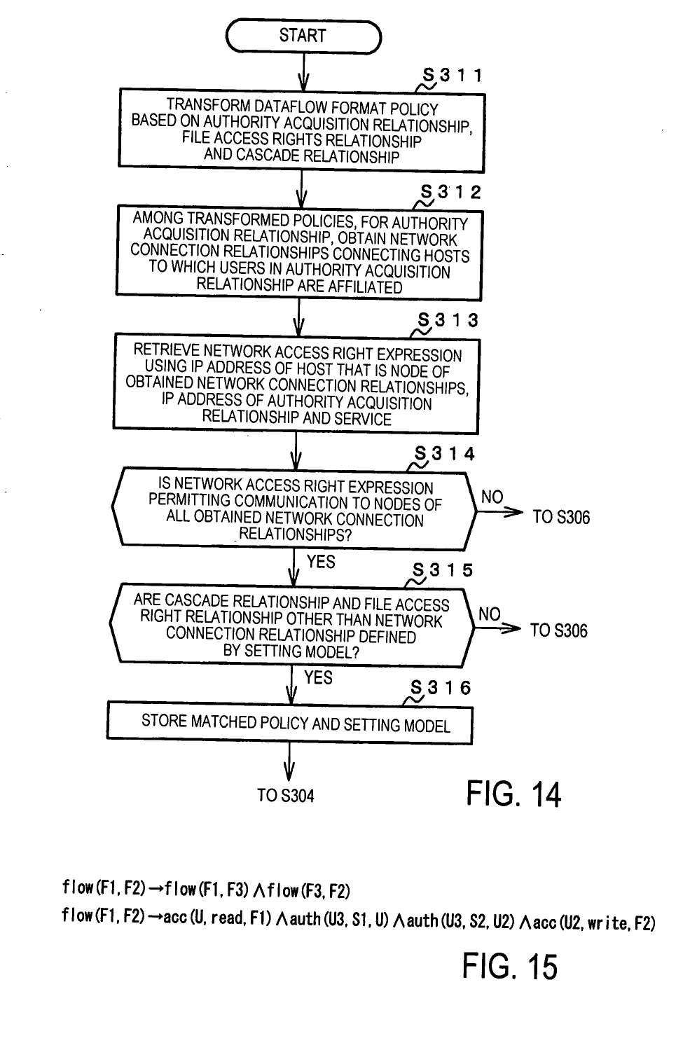

FIG. 14 is a flow chart showing a specific example of the process in step S303 of the security assessment processing shown in FIG. 13. FIG. 15 shows an example of a rewrite rule used in this process.

When a data flow relationship is included in a policy that is an assessment object, assessment unit 50a in step S311 transforms the data flow relationship to an expression in accordance with an authority acquisition relationship or the like by means of a predetermined rewrite rule shown in FIG. 15. In the example described here, assessment unit 50a assesses whether each of the relationships indicating a permission policy after transformation respectively satisfies a setting model. If the policy includes an authority acquisition relationship, assessment unit 50a uses the IP addresses of the hosts to which the two users included in the authority acquisition relationship belong, and finds from the network connection expression the structure of the network connecting the two users in step S312. In this manner, the set of IP addresses that make up the network connecting the two users is obtained.

Next, in step S313, assessment unit 50a uses the IP addresses of the obtained network structure, the IP addresses to which the two users belong, and the port numbers that are used by services included in the authority acquisition relationship to search for a network access right expression. Upon retrieving the network access rights expression, assessment unit 50a confirms whether the relevant network access is permitted based on the retrieved network access rights expression in step S314. More specifically, when the IP addresses of the users of the authority acquisition relationship are transmission source IP address “10.56.1.2” and transmission destination IP address “10.56.1.3,” the port number used by the service is “80,” and the set of IP addresses connecting the two users is IP address “10.56.3.1” and IP address “10.56.3.2,” assessment unit 50a performs a search to determine whether n(10.56.3.1, 10.56.1.2, 10.56.1.3, 80) and n(10.56.3.2, 10.56.1.2, 10.56.1.3, 80) are included in the retrieved network access rights expression. If either of the above-described symbols is not included in the network access rights expression, assessment unit 50a determines that the authority acquisition relationship included in the security assessment policy does not match the setting model, and processing then proceeds to step S306.

If communication is permitted in the network access rights expression in step S314, assessment unit 50a performs a search to determine whether each of the relationships included in the security assessment policy other than the network connection relationship is defined by a setting model in step S315. If a relationship that is not defined by a setting model is present in any of the relationships other than the network connection relationship, assessment unit 50a judges that the policy does not match the setting model and proceeds to step S306.

If all of the respective relationships included in the security assessment policy are defined by a setting model in step S315, assessment unit 50a judges that the policy matches the setting model and stores the policy together with the retrieved results in the retrieval result storage unit in step S316.

As described above, security assessment system 100d is configured such that policies representing the migration of data within the assessment object system are used to retrieve a setting model representing the settings of the overall system. Therefore, by using security assessment system 100d, settings that differ from the operations intended by a designer or assessor or setting errors that relate to a plurality of computers may be discovered.

Incidentally, each parts of security assessment systems 100, 100a, 100b, 100c, and 100d executes the various processes described above in accordance with a computer program, that is, a security assessment program, which is provided either inside or outside the relevant part. In other words, security assessment system 100 executes the processes shown in the above-described FIG. 6 in accordance with a security assessment program. More specifically, the security assessment program is, for example, a security assessment program for assessing the presence or absence of improper settings indicating composite errors in the security settings in examination object system 111, and is a program for causing, for example, security assessment system 100 to execute the steps of: reading data transfer paths, which represent migration of data in an examination object system and which are generated based on program operation information that describes the operations of programs used in the examination object system, from a data transfer path storage unit storing the data transfer paths; integrating access rights of data transfer paths that have been read; and retrieving improper paths from data transfer paths for which access rights have been integrated based on security assessment policies in which improper paths, which are paths of data migration that are inappropriate from a security perspective, have been set in advance. Further, the security assessment program may be a program for causing security assessment system 100 to execute, for example, a step of retrieving composite security settings that permit data migration on improper paths that have been retrieved based on program operation information.

According to the respective security assessment systems described above, by providing a configuration that compares a data transfer path representing data migration in an examination object computer with a security assessment policy in which a migration path of data that is inappropriate from a security perspective is set, an assessment on whether an assessment object computer has an improper setting that is a composite security setting error may be performed easily. By including a configuration that retrieves improper settings that are composite errors, security settings that cause improper settings may be pointed out, and remediation of settings may be promoted. In addition, since the configuration only collects security setting information of an examination object computer without using methods such as a pseudo-attack that impose heavy loads, assessment of an examination object computer may be performed at a light load.

### FIRST EMBODIMENT

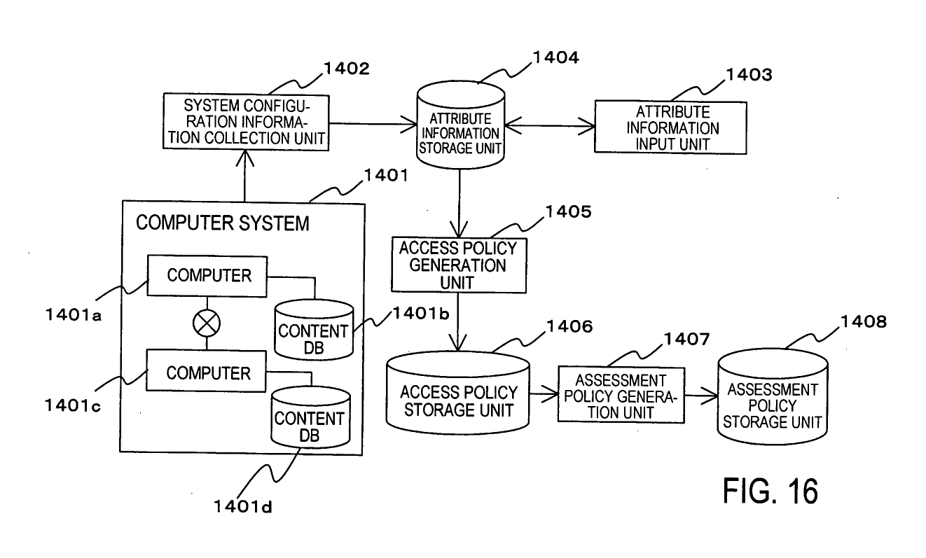

Next, in line with respective security assessment systems 100, 100a, 100b, 100c and 100d described above, a description will be provided on a security assessment data generation system according to the present invention which creates data for assessment to be applied to the security assessment systems. FIG. 16 shows a configuration of a security assessment data generation system according to a first embodiment of the present invention. The security assessment data generation system is arranged to generate data or, more specifically, policies to be entered to the security assessment system shown in FIG. 2 or FIG. 10. Incidentally, in the following description, a user of the security assessment data generation system itself shall be referred to as an operator.

The security assessment data generation system shown in FIG. 16 is arranged to create policies in correspondence to computer system 1401 that is a security assessment object, and is provided with: system configuration information collection unit 1402; attribute information input unit 1403; attribute information storage unit 1404; access policy generation unit 1405; access policy storage unit 1406; assessment policy generation unit 1407; and assessment policy storage unit 1408.

In the example shown in FIG. 16, computer system 1401 that is the security assessment object includes two computers 1401a and 1401c, and two content DBs (databases) 1401b and 1401d. As contents, content DBs 1401b and 1401d stores, for example, files and the like. Incidentally, it is needless to say that the configuration of computer system 1401 is not limited to the configuration exemplified in FIG. 16.

In the present security assessment data generation system, system configuration information collection unit 1402 collects system configuration information from computer system 1401 that is the assessment object. System configuration information will be described later. Attribute information input unit 1403 receives input of attribute information. Attribute information will be described later. In addition, attribute information input unit 1403 adds entered attribute information to system configuration information collected by system configuration information collection unit 1402, and stores the same in attribute information storage unit 1404. Incidentally, attribute information input unit 1403 may receive system configuration information to which attribute information is added as input, and may store the system configuration information in attribute information storage unit 1404. Attribute information storage unit 1404 stores information in which system configuration information and attribute information are associated with each other. More specifically, attribute information storage unit 1404 stores system configuration information to which attribute information has been added.

Access policy generation unit 1405 creates an access policy using system configuration information or attribute information stored or memorized in attribute information storage unit 1404. Access policies will be described later. For instance, access policy generation unit 1405 displays attribute information on a display device (not shown) to prompt the operator to select attribute information. Then, an access policy is created based on the selected attribute information. In addition, as described later, an access policy includes at least one of information regarding a “migration source”, a “migration destination”, and a “migration path.” Access policy generation unit 1405 may display input fields of “migration source”, “migration destination” and “migration path” on the display device so as to receive information on “migration source”, “migration destination” and “migration path” via such input fields. At this point, instead of attribute information, information indicating a “migration source”, a “migration destination”, and a “migration path” may be arranged to be directly entered via the input fields of “migration source”, “migration destination” and “migration path.” Access policy generation unit 1405 may create an access policy based on information directly indicating a “migration source”, a “migration destination”, and a “migration path”, instead of attribute information.

Access policy storage unit 1406 stores access policies created by access policy generation unit 1405. Assessment policy generation unit 1407 performs processing for converting access policies into assessment policies. Incidentally. Assessment policies will be described later. Assessment policy storage unit 1408 stores assessment policies generated by assessment policy generation unit 1407.

System configuration information collection unit 1402 is realized by, for instance, a CPU that operates according to a program, and an interface to computer system 1401. Attribute information input unit 1403 is realized by, for instance, a CPU that operates according to a program, and an input device such as a keyboard. Access policy generation unit 1405 is realized by, for instance, a CPU that operates according to a program, a display device, and an input device such as a keyboard. Assessment policy generation unit 1407 is realized by, for instance, a CPU that operates according to a program. These programs are stored in advance in a storage device (not shown). In addition, attribute information storage unit 1404, access policy storage unit 1406 and assessment policy storage unit 1408 are realized by, for instance, storage devices. It is needless to say that system configuration information collection unit 1402, attribute information input unit 1403, access policy generation unit 1405 and assessment policy generation unit 1407 may be realized using a single CPU, while attribute information storage unit 1404, access policy storage unit 1406 and assessment policy storage unit 1408 may be realized using a single storage device.

Next, system configuration information will be described. System configuration information includes information regarding at least one of a network, an application, a file, a service and a user in a computer system that is an assessment object. Accordingly, system configuration information is information that includes at least one of network configuration information, application information, file information, service information and user information in computer system 1401 that is an assessment object.

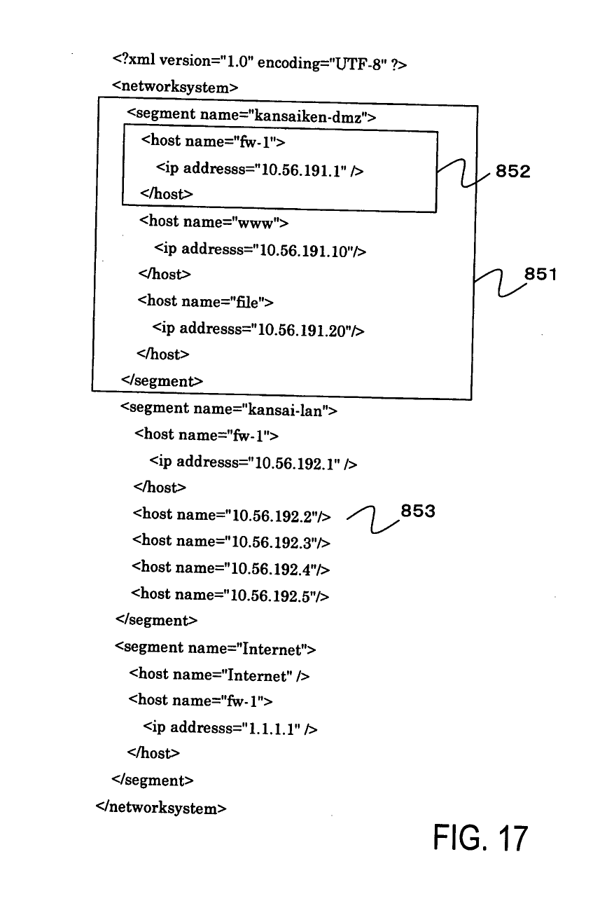

Network configuration information represents information regarding a network system in computer system 1401. Network configuration information includes, for instance, information regarding a host, connection configuration of network devices, segment configurations, segment names and the like. However, all of these information need not be included. FIG. 17 shows an example of network configuration information. In this example, network configuration information is described in XML (eXtensible Markup Language) format.

In the network configuration information exemplified in FIG. 17, information on a plurality of segments is described within a range enclosed between networksystem tags. Information on respective segments is described in a range enclosed between segment tags. For instance, description 851 that is enclosed between segment tags represent a single piece of segment information. In addition, information on a segment includes a name of the segment and information of a host belonging to the segment. For instance, description 851 includes a segment name “kansaiken-dmz.” In addition, description 851 includes three pieces of host information. Each piece of host information is represented by a host tag. For instance, description 852 that is enclosed between host tags represent a single piece of host information. Information on a host includes a name of the host and information on an IP address of the host. Through such descriptions, network configuration information indicates which host belongs to which segment. Incidentally, as indicated by description 853, an IP address may be described as a host name. In addition, in the example shown in FIG. 17, attribute information such as a name attribute is also included in the description enclosed between segment tags.

Individual pieces of host information included in network configuration information shall be referred to as host configuration information. Host configuration information represents a name, an IP address or the like of a host. For instance, description 852 is host configuration information indicating that the host name is “fw-1” and the IP address is “10.56.191.1.”

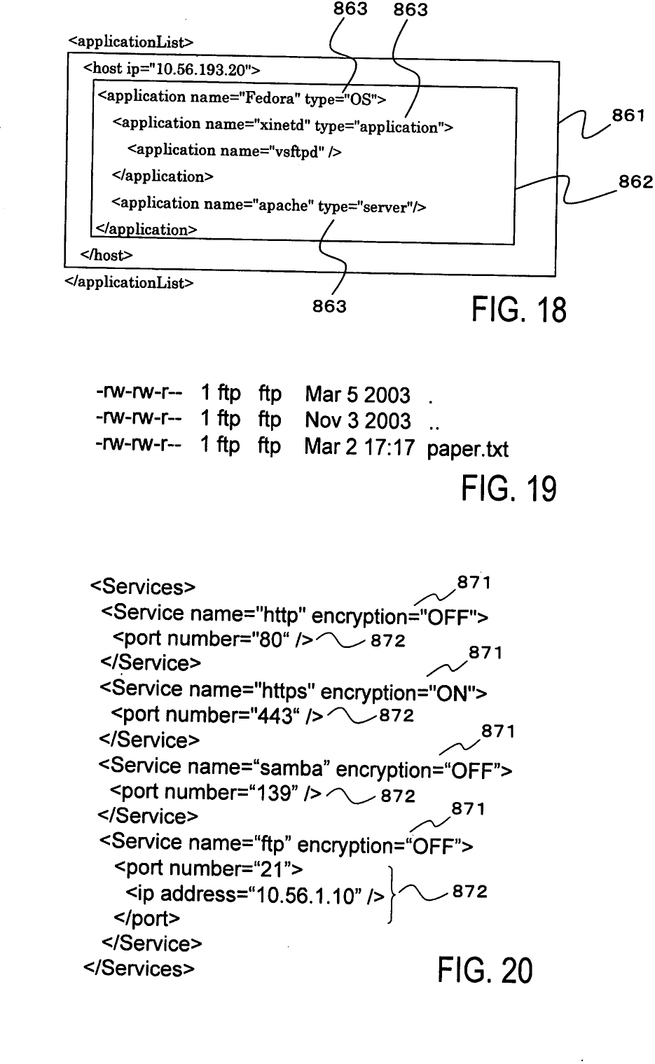

Application information represents information regarding an OS (Operating System) and application software installed in each host of computer system 1401. Application information includes, for instance, information regarding the type and the name of the installed application, information regarding a start-up sequence of the applications, and the like. However, all of these information need not be included. FIG. 18 shows an example of application information. In this example, application information is described in XML format.

In the example shown in FIG. 18, the range enclosed between applicationList tags is application information. In addition, information on each application is described as description 862 in a range enclosed between host tags, that is, the description 861. In this example, IP addresses of hosts are indicated together with the host tags, and the names of respective applications (“Fedora”, “xinetd”, “vsftpd” and the like) installed in the hosts are described in the range (description 861) enclosed between the host tags.

In addition, in the example shown in FIG. 18, type attribute 863 that indicates types of respective applications is described together with application tags. Type attribute 863 is not included in application information collected by system configuration information collection unit 1402 from computer system 1401. Type attribute 863 exemplified in FIG. 18 is attached to application information that is entered to attribute information input unit 1403 and collected by system information collection unit 1402.

File information is information indicating information such as the name and the configuration of a file, configuration of a file system, and the like. FIG. 19 shows an example of file information. The exemplified file information indicates a file name “paper.txt.”

Service information is information regarding a protocol and service used by an application and indicates, for instance, a name of a service, a name of a protocol used by the service, and the like. FIG. 20 shows an example of service information. In this example, service names such as “http”, “https”, “samba”, “ftp” and the like are indicated together with Service tags. Incidentally, the example shown in FIG. 20 includes encryption attribute 871 indicating whether encryption will be performed and attribute 872 regarding port number.

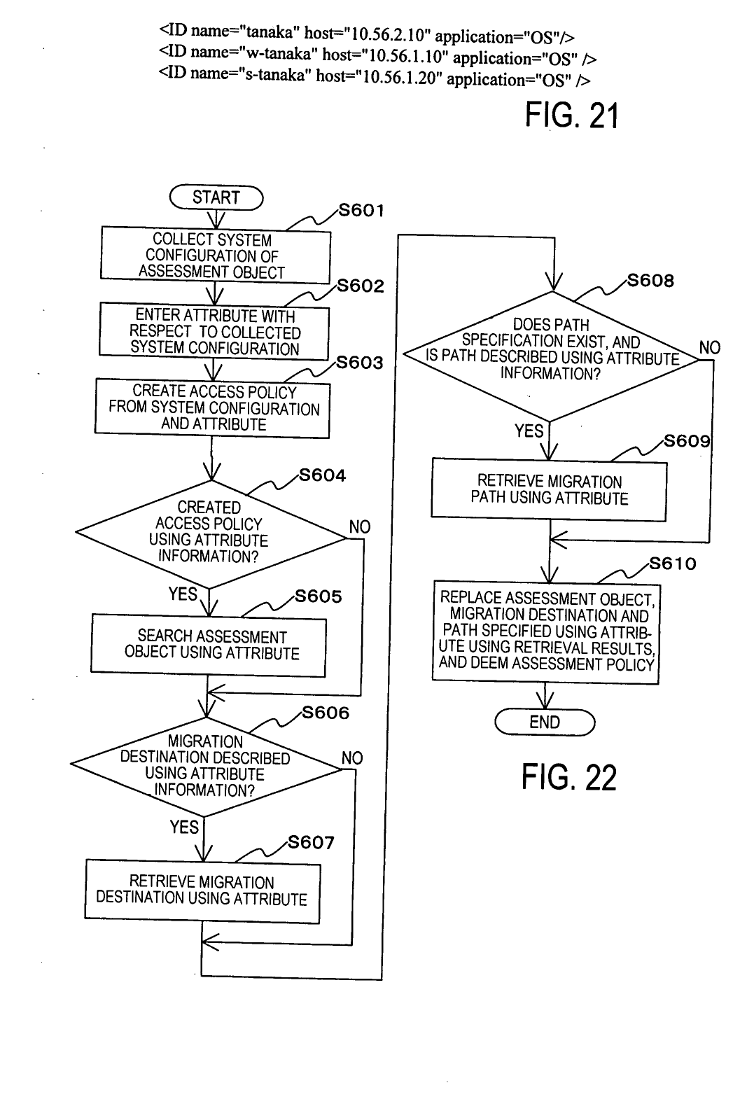

User information is information indicating information such as configuration of a user account, configuration of an authentication mechanism, and the like. FIG. 21 shows an example of user information. In the exemplified user information, user accounts such as “tanaka”, “w-tanaka”, “s-tanaka” and the like are indicated.

Attribute information is information that is added to system configuration information, which represents attributes of contents indicated by system configuration information, such as attributes of functions and the like. Types of attribute information include network configuration information attribute, host configuration information attribute, application configuration information attribute, user information attribute, file information attribute and the like.

A network configuration information attribute is an attribute given to network configuration information. A network configuration information attribute includes a segment name, network segment function information and the like. Network segment function information indicates, for instance, that a segment functions as a public segment, an in-house LAN (local area network) segment, an in-unit LAN segment or the like.

A host configuration information attribute is an attribute with respect to a host and a configuration of a host. Types of host configuration information attributes include, for instance, a host name, attributes of a user or an owner, function information representing functions such as a public server on the Web, or the like.

An application configuration information attribute is an attribute of an OS and application software. Types of application attributes include, for instance, functions of applications such as server applications, client applications and the like, and application types such as Web client, FTP (file transfer protocol) server and the like.

A user information attribute is an attribute of individual users and user accounts. Types of user information attributes include, for instance, a name of a person using a user account, a function such as system administrator, content manager or Web master, a title and the like.

A file information attribute is an attribute of a file or directory, and an attribute of contents stored in such a file or directory. In addition, types of file information attributes include: a disclosure attribute such as public information, confidential information, confidential except persons involved and the like; a category attribute such as management level, individual information, technical information and the like; an editing attribute such as a time and date of creation, a name of creator or the like; and a confidential attribute such as a presence or absence of encryption, a presence or absence of compression, a presence or absence of a digital authority management mechanism or the like.

A service information attribute is an attribute such as a name of a host or an application that is using the service, a port number, a presence or absence of encryption and the like.

Attribute information input unit 1403 displays system configuration information to the operator by, for instance, causing a display device (not shown) to display system configuration information. Then, attribute information input unit 1403 prompts the operator to enter attribute information to be added to the system configuration information. Attribute information is entered from the operator to attribute information input unit 1403. In addition, among category attributes, a disclosure attribute or a degree of confidentiality of contents may be extracted using means for analyzing contents and used as a file information attribute. Regarding user attributes, in coordination with an account management system, an attribute regarding a user registered in the account management system may be used as a user attribute.

An access policy is information describing an access authority as a policy using attribute information, and includes at least one of information on a migration source, a migration destination and a migration path in an improper data migration path. Therefore, an access policy may include only information regarding a migration source. A case where only information on a migration source is included means that all migration destinations and migration paths are specified. An access policy may include only information on a migration destination or only information on a migration path.

In access policies, a migration source is a file or user that becomes an assessment object of the validity of an access right. When a migration source is a file, the migration source is specified using a name of a storage location of information that is the migration source, such as a file name, a directory name, a host name, a segment name and the like, or otherwise attribute information that enables identification of the same. When a migration source is a user, the migration source is specified using a name of a registration location of the user such as a user account name, a host name, a segment name and the like, or otherwise attribute information that enables identification of the same. A migration destination is a transfer destination of information of a file or user of a migration source. Migration destinations are specified in the same manner as migration sources. When both a migration source and a migration destination are files, an access policy thereof indicates that all or part of the file of the migration source may be copied to the file of the migration destination. When a migration source is a file and a migration destination is a user, an access policy thereof indicates that the user is capable of reading the file. When both a migration source and a migration destination are users, an access policy thereof indicates that information is transferable from the user of the migration source to the user of the migration destination by, for instance, having the user of the migration source write the user's own information into a file and having the user of the migration destination read the file. When a migration source is a user and a migration destination is a file, an access policy thereof indicates that the user of the migration source is capable of writing information into the file of the migration destination.

A migration path is an intermediate path such as an IP address of a network interface or a host name through which migration source information passes, service information such as a port used by an application that is disclosing migration source information or a service name thereof, and the like. Designation of a migration path is performed by directly specifying information representing the migration path, or by specifying attribute information capable of specifying such information.

An assessment policy is a judgment criterion for assessing whether a computer system is configured as intended or whether the computer system operates as intended. A policy to be entered to policy input unit 10 in security assessment system 100 shown in FIG. 2 or in security assessment system 100c shown in FIG. 10 corresponds to an assessment policy. An assessment policy represents an improper data migration path.

Next, operations of the security assessment data generation system shown in FIG. 16 will be described. FIG. 22 is a flowchart showing operations of the security assessment data generation system.

First, in step S601, system configuration information collection unit 1401 collects system configuration information of computer system 1401 that is the assessment object. In this case, collecting system configuration information by performing communication with an agent installed in advance in computer system 1401 shall suffice. In other words, system configuration information collection unit 1401 may collect system configuration information by receiving system configuration information from a computer that operates according to the agent. Incidentally, the agent installed in advance in computer system 1401 is prepared for each application installed in computer system 1401, whereby an agent responsible for the OS collects an installation configuration, a file configuration and a user/group configuration of each application. The agent responsible for the OS may either directly collect application configurations and the like, or collect application configurations and the like by analyzing setting files prepared in advance.

The agent responsible for the OS activates agents corresponding to the respective applications according to the collected configurations. Each agent performs processing for collecting system configuration information to the computer and for transmitting the system configuration information to system configuration information collection unit 1402. In addition, in a case where one application is configured to activate or execute another application, an agent corresponding to the application activates an agent of the other application.

Next, attribute information is entered to attribute information input unit 1403. For example, assuming that system configuration information collected in step S601 is displayed on a display device (not shown), an operator enters attribute information corresponding to the system configuration information to attribute information input unit 1403. In step S602, attribute information input unit 1403 adds the entered attribute information to the system configuration information, and stores the information in attribute information storage unit 1404. In step S603, access policy generation unit 1405 creates an access policy based on system configuration information or attribute information, and stores the access policy in access policy storage unit 1406.

Subsequently, assessment policy generation unit 1407 reads the access policy from access policy storage unit 1406, and creates an assessment policy from the access policy. Assessment policy generation unit 1407 then stores the assessment policy in assessment policy storage unit 1408. Assessment policy generation unit 1407 creates an assessment policy as described below.

First, in step S604, assessment policy generation unit 1407 judges whether a migration source of the access policy has been created using attribute information. In other words, judgment is performed on whether a migration source of the access policy is created using a user attribute or a file information attribute. When a migration source of the access policy has been created using attribute information, in step S605, assessment policy generation unit 1407 uses the attribute information to retrieve information to be used as a migration source from system configuration information, and proceeds to step S606. On the other hand, when it is judged in step S604 that the migration source of the access policy is created without using attribute information, for instance, in the event that the migration source of the access policy has been directly entered by the operator, the processing proceeds to step S606 without executing step S605.

In step S606, assessment policy generation unit 1407 judges whether a migration destination of the access policy has been created using attribute information. When a migration destination of the access policy is created using attribute information, in step S607, assessment policy generation unit 1407 uses the attribute information to retrieve information to be used as a migration destination from system configuration information, and proceeds to step S608. On the other hand, when it is judged in step S606 that the migration destination of the access policy is created without using attribute information, for instance, in the event that the migration destination of the access policy has been directly entered by the operator, the processing proceeds to step S608 without executing step S607.

In step S608, assessment policy generation unit 1407 judges whether the access policy includes a migration path and whether the migration path has been created using attribute information. When the access policy includes a migration path and the migration path has been created using attribute information, in step S609, assessment policy generation unit 1407 uses the attribute information to retrieve information to be used as a migration path from system configuration information, and proceeds to step S610. On the other hand, when the access policy does not include a migration path or when the migration path has been created without using attribute information, for instance, in the event that a migration path of the access policy has been directly entered by the operator, the process proceeds to step S610 without executing step S609.

In step S610, when there exists migration source information that has been retrieved in step S605, assessment policy generation unit 1407 replaces the migration source included in the access policy, that is, the migration source created using attribute information with information on the retrieved migration source. In the same manner, when there exists migration destination information that has been retrieved in step S607, assessment policy generation unit 1407 replaces the migration destination included in the access policy, that is, the migration destination created using attribute information with information on the retrieved migration destination. Additionally, in the same manner, when there exists migration path information that has been retrieved in step S609, assessment policy generation unit 1407 replaces the migration path included in the access policy, that is, the migration path created using attribute information with information on the retrieved migration path. As a result, an assessment policy is obtained.

Assessment policy generation unit 1407 stores the assessment policy created through the processing of steps S604 to S610 in assessment policy storage unit 1408. The assessment policy stored in assessment policy storage unit 1408 is used as input data, that is, the policy to policy input unit 10 in security assessment system 100 shown in FIG. 2 or in security assessment system 100c shown in FIG. 10.

According to the present embodiment, the security assessment data generation system is configured to create an access policy using system configuration information and to convert the access policy into an assessment policy. Therefore, the security assessment data generation system is able to easily create an assessment policy that conforms to the system configuration of an assessment object. In addition, since the security assessment data generation system is configured to add attribute information to system configuration information, create an access policy using the attribute information and convert the access policy into an assessment policy, an operator will be able to create an access policy without having detailed knowledge on the system configuration of the assessment object. As a result, the operator will be able to easily create an assessment policy without having to know details of the system configuration of the assessment object system. In addition, since the security assessment data generation system is configured to add attribute information to system configuration information, create an access policy using the attribute information and convert the access policy into an assessment policy, an operator will be able to easily create an assessment policy without having knowledge on complicated grammar that is inherent in assessment policies. Furthermore, since a plurality of system components may be simultaneously specified with a single piece of attribute information, a necessary and sufficient number of assessment policies may be created with a small number of access policies.

### SECOND EMBODIMENT

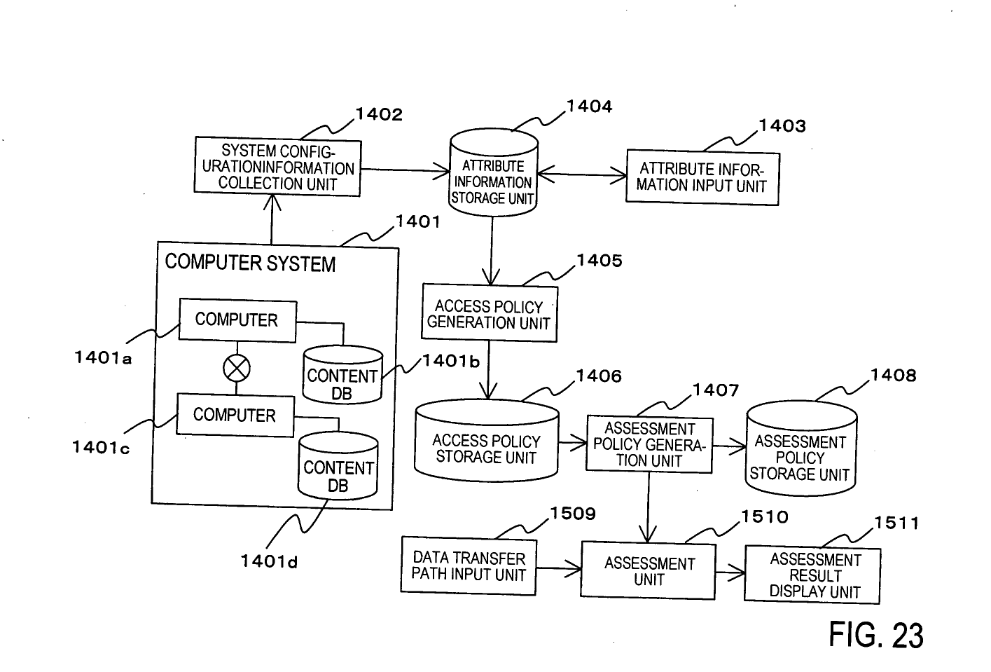

FIG. 23 shows a configuration of a security assessment data generation system according to a second embodiment of the present invention. In the following description, parts having the same configuration and perform the same processing as parts in the security assessment data generation system according to the first embodiment shown in FIG. 16 are assigned the same reference characters, and detailed description of these parts is hereby omitted. As shown in FIG. 23, the security assessment data generation system according to the present embodiment is arranged to create policies in correspondence to computer system 1401 that is a security assessment object, and is provided with: system configuration information collection unit 1402; attribute information input unit 1403; attribute information storage unit 1404; access policy generation unit 1405; access policy storage unit 1406; assessment policy generation unit 1407; assessment policy storage unit 1408; data transfer path input unit 1509; assessment unit 1510; and assessment result display unit 1511.

Data transfer path input unit 1509 hands over data transfer path information to assessment unit 1510. The data transfer path information is, for instance, similar to the data transfer path information after access right integration that is outputted by access right integration unit 40 of security assessment system 100 shown in FIG. 2 or security assessment system 100c shown in FIG. 10. Incidentally, data transfer path information after access right integration may be created according to the same processing as described above with respect to security assessment system 100 shown in FIG. 2 or security assessment system 100c shown in FIG. 10.

Assessment unit 1510 is configured in the same manner as assessment unit 50 in security assessment system 100 shown in FIG. 2 or in security assessment system 100c shown in FIG. 10, and operates in the same manner as assessment unit 50. Assessment unit 1510 uses an assessment policy generated by assessment policy generation unit 1407 to assess whether data transfer paths in computer system 1401 that is an assessment object system is inappropriate.

Assessment result display unit 1511 is, for instance, a display device, and displays assessment results of assessment unit 1510, such as a data transfer path that is judged to be inappropriate.

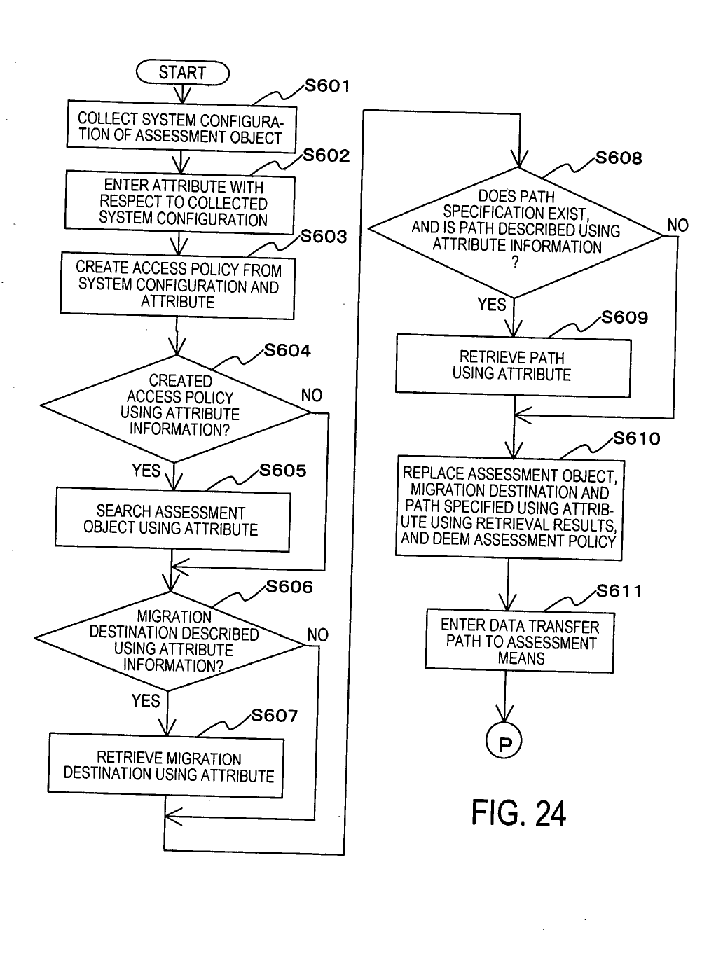

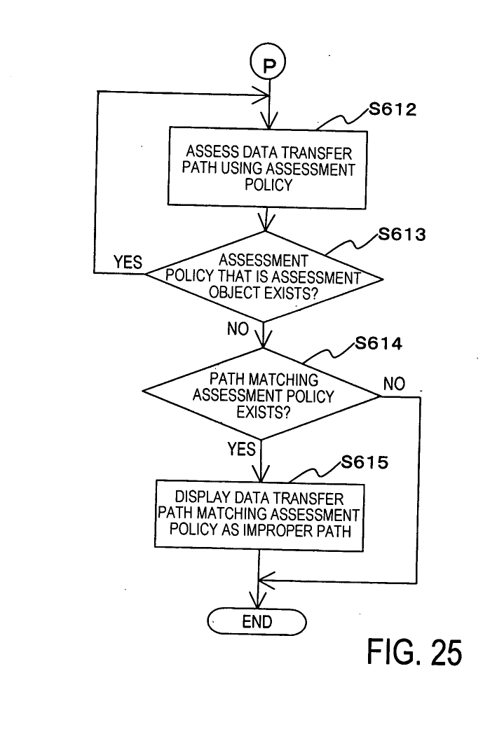

Next, operations of the security assessment data generation system according to the second embodiment will be described. FIGS. 24 and 25 are flowcharts showing operations of the security assessment data generation system according to the present embodiment. Processing of steps S601 to S610 shown in FIG. 24 is the same as the processing of steps S601 to S610 described in the above first embodiment with reference to FIG. 22.

After step S610, data transfer path input unit 1509 enters data transfer path information to assessment unit 1510 in step S611. Then, in step S612, assessment unit 1510 uses the assessment policy generated by assessment policy generation unit 1407 in step S610 to assess whether a data transfer path indicated by data transfer path information is inappropriate. The assessment processing may be performed by judging whether a data transfer path matching the assessment policy exists. Accordingly, a data transfer path that matches the assessment policy may be judged as an improper data transfer path. Incidentally, assessment unit 1510 may read in an assessment policy from assessment policy storage unit 1408.

After the assessment processing of step S612, in step S613, assessment unit 1510 judges whether an assessment policy exists that is yet to be used for assessment. If there is an assessment policy that is yet to be used for assessment, the processing proceeds to step S612 to perform assessment processing using the assessment policy. When there are no more assessment policies that have not been used for assessment, that is, when it is judged in step S613 that there are no more assessment policies, in step S614, assessment unit 1510 judges whether a data transfer path that matches the assessment policy exists. At this point, if there are no data transfer paths that match the assessment policy, the processing is concluded. If a data transfer path that matches the assessment policy exists in step S614, in step S616, assessment unit 1510 displays the data transfer path as an improper data transfer path on assessment result display unit 1511. At this point, assessment unit 1510 may display a setting or system configuration information that caused the creation of the improper data transfer path, together with the improper data transfer path.

The security assessment data generation system shown in FIG. 23 is configured to generate input data (assessment policy) for the assessment unit using an access policy created using attribute information, and to display a data transfer path that matches the assessment policy. Therefore, by using this security assessment data generation system, the operator will be able to retrieve files or system configurations that violate the policy without having to know the complicated grammar of assessment policies. In addition, the operator will be able to retrieve improper files or system configurations without having detailed knowledge on system configuration information of the assessment object system, information on saved files, or the like.

The security assessment data generation system according to the respective embodiments of the present invention described above may be used in combination with the respective security assessment systems described above. For instance, in a possible configuration, the security assessment data generation system shown in FIG. 16 may be combined with the security assessment system shown in FIG. 2 or FIG. 10. Through such a configuration, similar effects as the security assessment system shown in FIG. 2 or FIG. 10 may be obtained.

For instance, setting information collection unit 70, program operation information storage unit 30, data transfer path generation unit 21, setting information storage unit 31, data transfer path information storage unit 32, access right integration unit 40, assessment unit 50, setting information retrieval unit 80 and assessment result display unit 60 (refer to FIG. 2) of security assessment system 100 shown in FIG. 2 may be added to the security assessment data generation system shown in FIG. 16, whereby assessment policy generation unit 1407 is configured so as to enter assessment policies to assessment unit 50.

Alternatively, setting information collection unit 71, setting information storage unit 31, data transfer path input unit 20, data transfer path information storage unit 32, access right integration unit 40, assessment unit 50, setting information retrieval unit 80 and assessment result display unit 60 of security assessment system 100c shown in FIG. 10 may be added to the security assessment data generation system shown in FIG. 16, whereby assessment policy generation unit 1407 is configured so as to enter assessment policies to assessment unit 50.

### EXAMPLES

The present invention will now be further explained using specific examples.

### Example 1

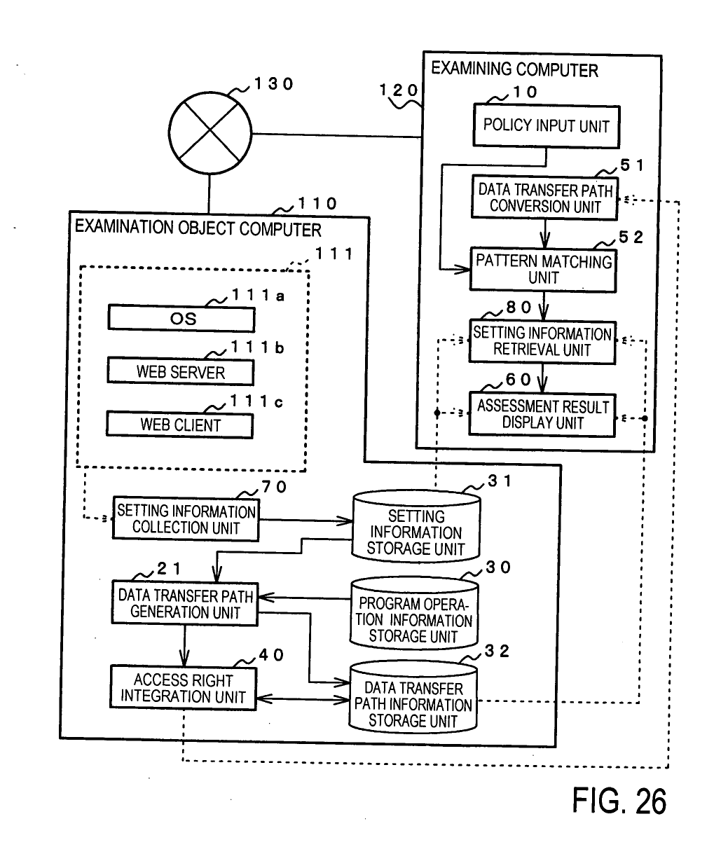

FIG. 26 shows a specific configuration of security assessment system 100 shown in FIG. 2. Incidentally, FIG. 26 is depicted omitting policy storage unit 33 of the configuration shown in FIG. 2.

As shown in FIG. 26, security assessment system 100 is provided with examination object computer 110 and examining computer 120. Examination object computer 110 and examining computer 120 are respectively connected to communication network 130 such as the Internet or an exclusive line. Incidentally, a plurality of examination object computers 110 may be provided.

Examination object computer 110 includes: examination object 111, setting information collection unit 70, data transfer path generation unit 21, access right integration unit 40, setting information storage unit 31, program operation information storage unit 30, and data transfer path information storage unit 32. Examining computer 120 includes: policy input unit 10, data transfer path conversion unit 51, pattern matching unit 52, setting information retrieval unit 80, and assessment result display unit 60.

In this case, all or a part of: setting information collection unit 70, data transfer path generation unit 21, access right integration unit 40, setting information storage unit 31, program operation information storage unit 30, and data transfer path information storage unit 32 may be included in examining computer 120. Alternatively, examining computer 120 may be included in examination object computer 110.

Examination object 111 is composed of: OS 111a, Web server 111b, and Web client 111c. In this example, a Linux 2.4 system is used in OS 111a, Apache 1.3 is used for Web server 111b, and Mozilla 1.5 is used for Web client 111c.

Next, a description will be provided on security assessment processing according to the security assessment system with reference to the above-described FIG. 6.

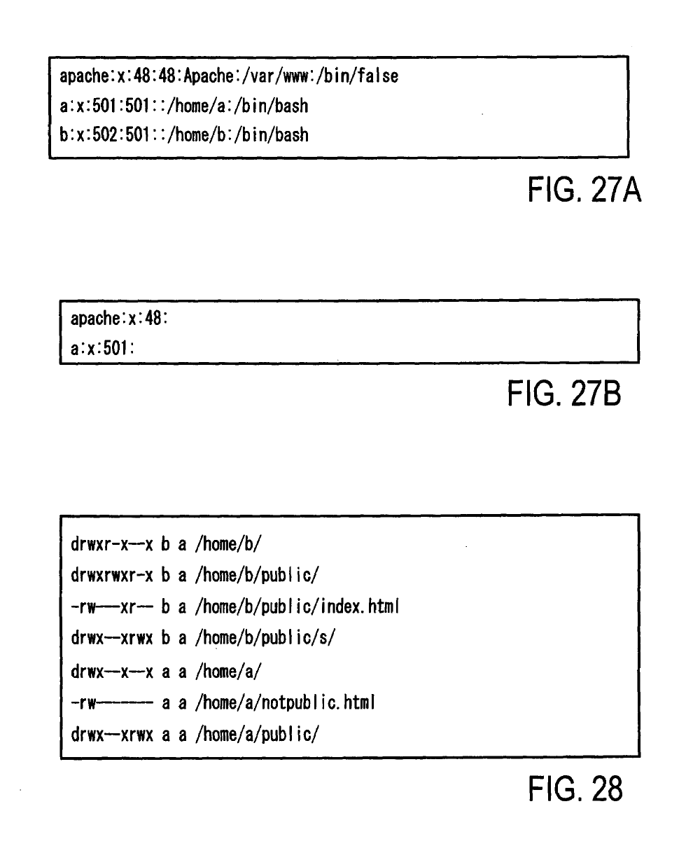

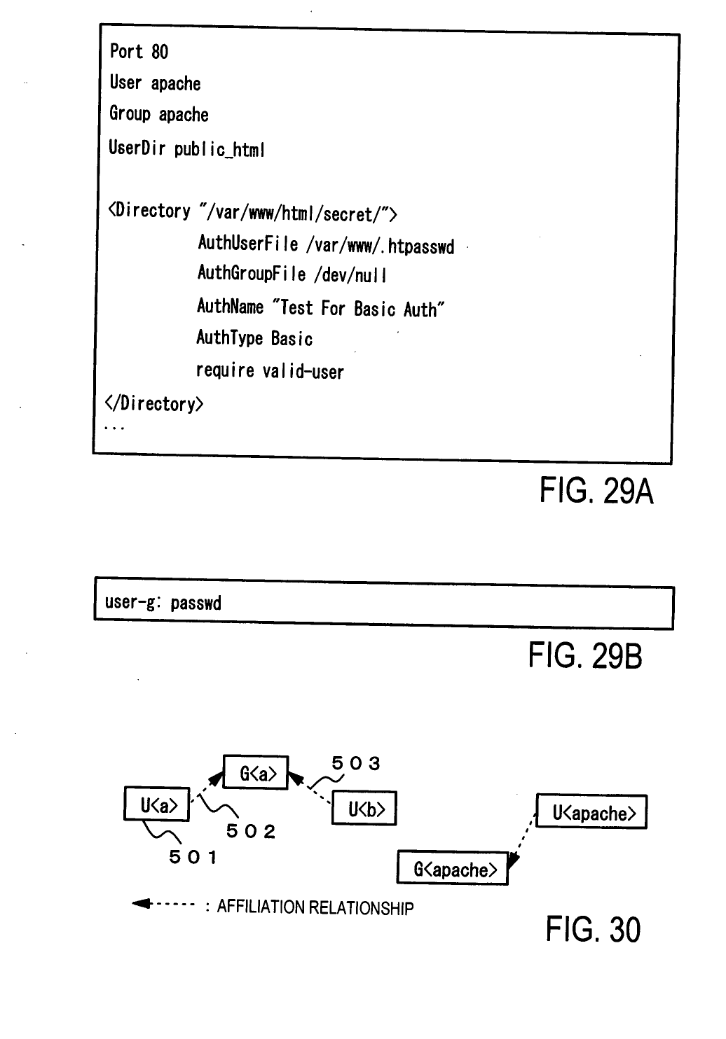

FIGS. 27A and 27B respectively show examples of the settings of a user account and group of OS 111a; FIG. 28 shows an example of the settings of file access rights; and FIGS. 29A and 29B show an example of the settings of Web server 111b. These diagrams show examples of settings of each part that have been realized by means of widely used OS software known as Linux, as in the settings shown in the above-described FIG. 5. Settings may be realized by means of other software.

FIG. 27A shows an example of the content of a user setting file “/etc/passwd” in OS 111a. In this case, an excerpt of the content of the user setting file “/etc/passwd” is shown. As shown in FIG. 27A, the user setting file “/etc/passwd” records information indicating users that are managed on OS 111a and information indicating the groups to which these users belong.

FIG. 27B shows an example of the content of a group setting file “/etc/group” in OS 111a. In this case, an excerpt of the content of the group setting file “/etc/group” is shown. As shown in FIG. 27B, the group setting file “/etc/group” records information indicating the groups that are managed on OS 111a, and information indicating the users that belong to these groups.

FIG. 28 shows an example of the structure of a file or directory in OS 111a and the settings of the access rights of the group or directory. FIG. 28 shows an excerpt of information obtained by executing a list command “ls-lar.”

FIG. 29A shows an example of the content of a setting file “httpd.conf” of Web server 111b. In this case, an excerpt of the content of an Apache setting file “httpd.conf” is shown. As shown in FIG. 29A, the setting file “httpd.conf” records, for example, information indicating the specifications of files or directories that are used by Web server 111b, information indicating the access rights to the files or directories, information indicating network port settings, and information indicating user setting files that are used for authentication.

FIG. 29B shows an example of the content of a setting file of Web server 111b. In this case, the content of a file “/var/www/.htpasswd” that is recorded in the setting file shown in FIG. 29A is shown as a user setting file used for authentication. As shown in FIG. 29B, the file “/var/www/.htpasswd” records information indicating the authenticated users used by Web server 111b.

In the security assessment processing, setting information collection unit 70 first collects the security settings shown in FIGS. 27A, 27B, 28, 29A, and 29B from examination object 111 in step S201. Subsequently, setting information collection unit 70 stores the collected security setting information in setting information storage unit 31.

Data transfer path generation unit 21 submits inquiries for program specifications for each program to program operation information storage unit 30 in accordance with the security setting information collected by setting information collection unit 70 and stored in setting information storage unit 31. More specifically, data transfer path generation unit 21 refers to program operation information (refer to FIG. 4), inquires the types of nodes or arcs to be created on a model for each program in the security setting information shown in FIGS. 27A, 27B, 28, 29A, and 29B, and reads program operation information that includes the program specifications and that corresponds to each program. In step S203, data transfer path generation unit 21 next creates nodes and arcs based on security setting information collected by setting information collection unit 70 and stored in setting information storage unit 31 and program operation information that has been read from program operation information storage unit 30, and thus generates data transfer path information.

In this example, it may be seen from the security setting information of OS 111a (refer to FIGS. 27A and 27B) that the users are “a,” “b,” and “apache.” It may be further seen that the groups are “a” and “apache.” Still further, it may be seen that user “a” and user “b” belong to group “a” and that user “apache” belongs to group “apache.” FIG. 30 shows data transfer paths that are generated based on the security setting information of OS 111a.

In step S203, data transfer path generation unit 21 creates data transfer paths based on the above-described security setting information according to the following procedure.

Data transfer path generation unit 21 first creates node U<a> 501 in accordance with the existence of user “a,” and then creates node G<a> 503 in accordance with the existence of group “a.” Data transfer path generation unit 21 further creates arc 502 representing an affiliation relationship in accordance with the affiliation of user “a” to group “a.” When all users, all groups, and affiliation relationships thereof are reflected by means of the above-described procedures, the data transfer paths shown in FIG. 30 are generated. In this case, U< > represents a user node, G< > represents a group node, F< > represents a file node, and N< > represents a network node. In the respective graphs shown in FIG. 30 and thereafter, except when specifically stated, solid black arrows represent data migration relationships, dotted black arrows represent affiliation relationships, solid arrows represent alias definitions, and dotted arrows represent authority delegations.

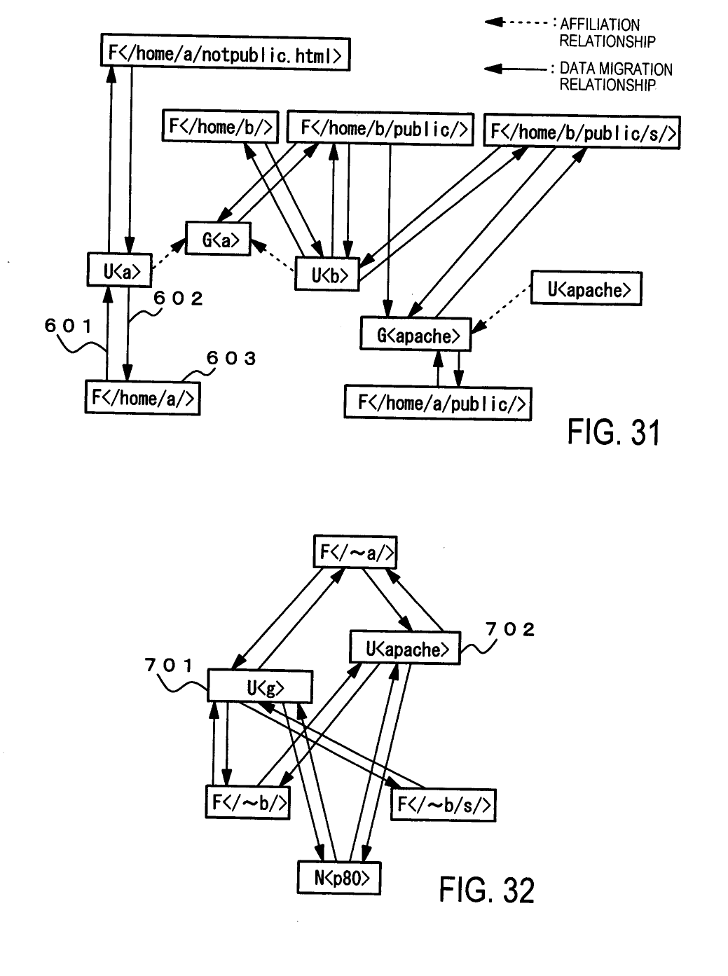

FIG. 31 shows data transfer paths to which are added objects and arcs that are created from the directory structure (refer to FIG. 28) managed by OS 111a. Data transfer path generation unit 21 creates node F</home/a/> 603 in accordance with the existence of file “/home/a/” in the directory structure. In addition, data transfer path generation unit 21 creates data migration relationship arc 601 according to the authority of user “a” to write to the file due to the settings of the access rights of this file “/home/a/,” and creates data migration relationship arc 602 according to the authority of user “a” to read the file. The data transfer paths shown in FIG. 31 are generated as explained above. FIG. 32 shows data transfer paths that are generated based on the security setting information (refer to FIG. 29) of Web server 111b. According to the security setting information of Web server 111b, the described “User apache” indicates that the user that executes Web server 111b is U<apache>. Accordingly, data transfer path generation unit 21 creates user node U<apache> 702.

In addition, since Basic authentication is set in directory “/home/b/public/s/” and user “g” is set in “.htpasswd” file, data transfer path generation unit 21 creates user node U<g> 701. Further, based on the operation information of Web server 111b, U<apache> may read from and write to file nodes other than file nodes that require the Basic authentication. As a result, data transfer path generation unit 21 creates data migration relationship arcs to directories other than the Basic authentication directory, and since U<g> is a Basic authentication user, data transfer path generation unit 21 creates Basic authentication file nodes, as well as other file nodes and data migration relationship arcs.

Data transfer path generation unit 21 next inquires program operation information storage unit 30 for operation information between Web client 111c and the programs. Since Web client 111c uses http (hypertext transfer protocol) to migrate data, data transfer path generation unit 21 creates a network node related to http. In this manner, as described above, nodes and arcs are generated within each layer.

Generation of an inter-program layer and generation of arcs contained in this inter-program layer will now be described. First, the installation of Web server 111b and OS 111a results in the creation of an inter-program layer associated to the layer of Web server 111b and the layer of OS 111a. Next, from the operation information of Web server 111b, it may be understood that an alias definition of the file node of OS 111a exists in the file node of Web server 111b. Data transfer path generation unit 21 therefore creates an inter-program layer, and, as shown in FIG. 33, creates an alias definition relationship arc from the relevant file node of Web server 111b to the relevant file node of OS 111a. Incidentally, inter-program layers are not specified in FIG. 33.

Similarly, it may be understood from the operation information of Web server 111b that, among the users of Web server 111b, there are users who have received authority delegation from users on OS 111a. Data transfer path generation unit 21 therefore creates arcs representing authority delegation relationships from the relevant users of Web server 111b to the relevant users of OS 111a, as shown in FIG. 33.

It may be seen that Web client 111c uses the number 80 port of Web server 111b to migrate data and also migrates data to the dynamic port of OS 111a. Data transfer path generation unit 21 therefore creates an inter-program layer associated with OS 111a and Web client 111c and an inter-program layer associated with Web server 111b and Web client 111c, and as shown in FIG. 33, creates an arcs representing data migration relationships to each of the above-described ports.

It may be seen that Web client 111c uses the number 80 port of Web server 111b to migrate data and also migrates data to the dynamic port of OS 111a. Data transfer path generation unit 21 therefore creates arcs representing data migration relationships to each of the above-described ports as shown in FIG. 33.

Data transfer path information is generated by data transfer path generation unit 21 as explained above. FIG. 33 shows data transfer paths indicated by the data transfer path information that is generated in step S203.

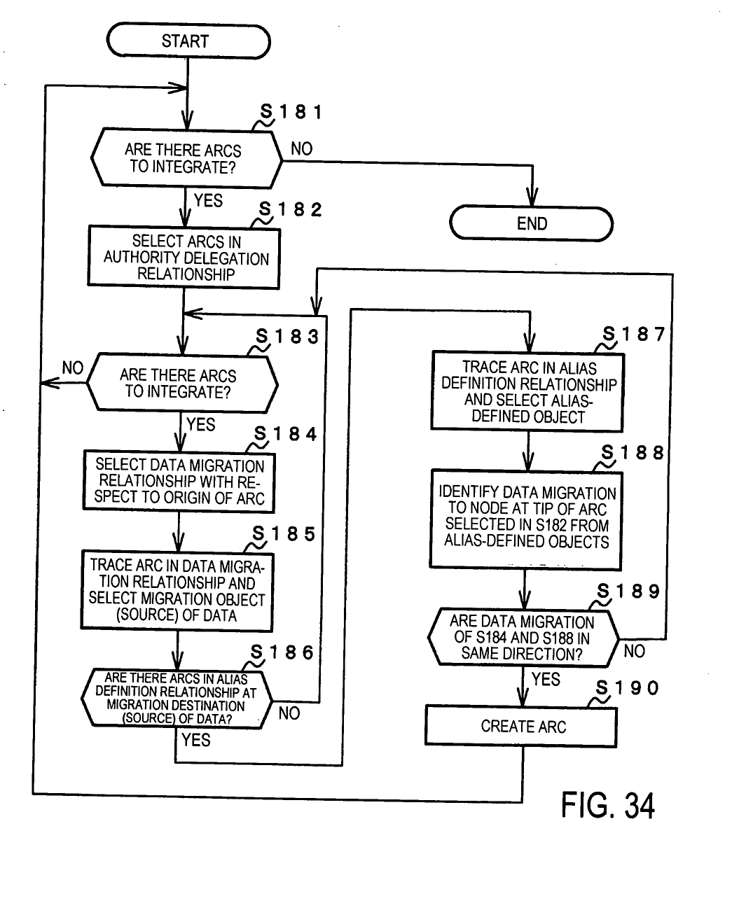

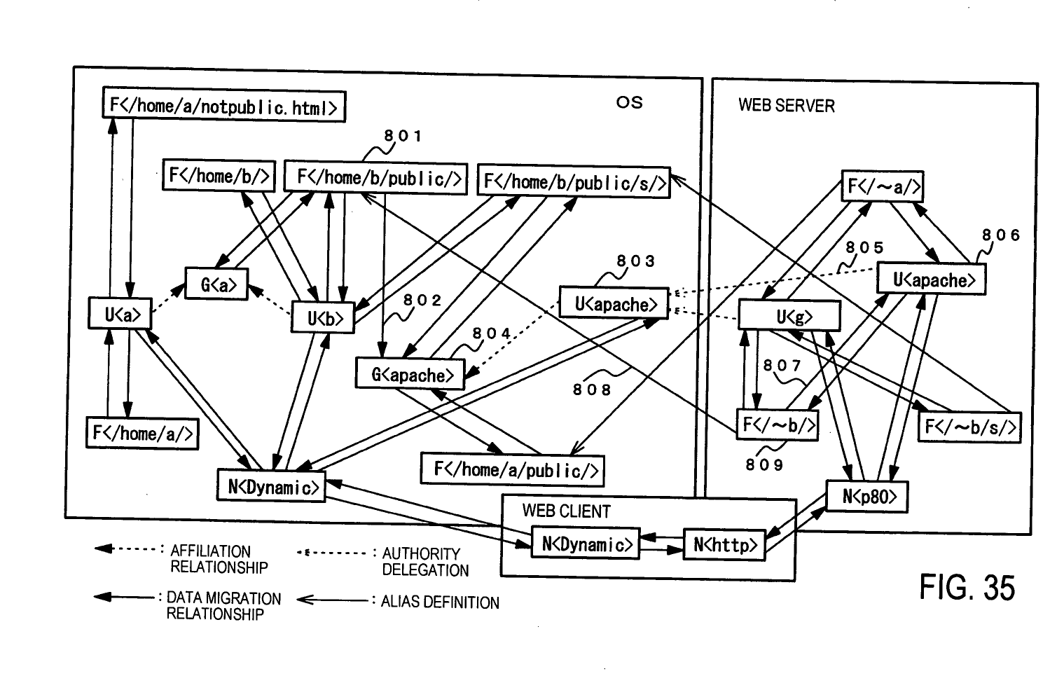

Next, a description will be provided on a specific example of the access right integration processing executed in step S204 by access right integration unit 40. FIG. 34 is a flowchart showing an example of access right integration processing. The access right integration processing is processing for integrating the access rights involving a plurality of programs. FIG. 35 is a diagram in which reference characters for providing the following description have been given to the data transfer paths indicated by the data transfer path information that was generated in step S203.

As shown in FIG. 35, the types of access or the accessible files on OS 111a that are available to user U<apache> 806 on Web server 111b is not readily recognizable. Thus, the access rights between Web server 111b and OS 111a must be integrated.

In access right integration processing, access right integration unit 40 investigates in step S181 whether arcs that should be integrated are present. If arcs that should be integrated exist, access right integration unit 40 selects in step S182 an arc of an authority delegation relationship or an alias definition relationship and thus focuses upon, of the arcs between Web server 111b and OS 111a, any arc representing an authority delegation relationship or any arc representing an alias definition relationship. In this case, it shall be assumed that attention is placed on arc 805 representing an authority delegation. Access right integration unit 40 next confirms in step S183 whether an arc of a data migration relationship exists at node 806 that is at the initial point of the authority delegation relationship arc. If an arc of a data migration relationship does not exist, the processing returns to step S181. If arc 807 in a data migration relationship exists, the arc is selected in step S184. Access right integration unit 40 traces arc 807 representing the selected data migration relationship, and selects node 809, the source of migration, in step S185.

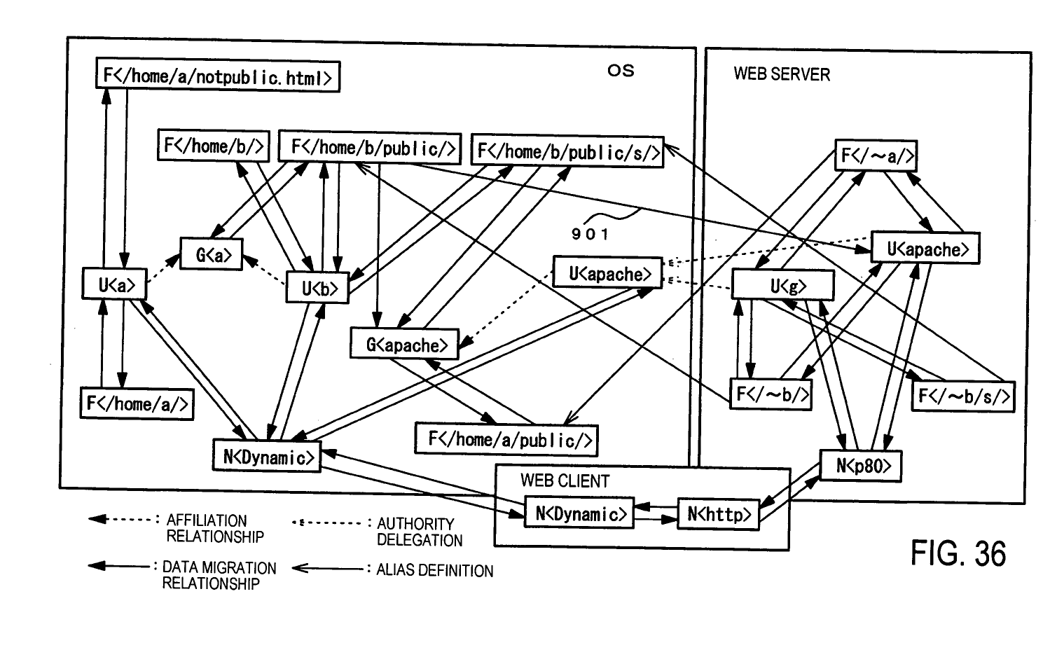

Access right integration unit 40 next confirms in step S186 that an arc 808 of a data migration relationship exists at selected node 809. If an alias definition relationship arc does not exist, the processing returns to step S186. If alias definition relationship arc 808 exists, in step S187, arc 808 is traced to select alias-defined node 801. Access right integration unit 40 then specifies in step S188 that there is data migration from alias-defined node 801 towards authority-delegated node 803. At this point, it is assumed that the arc is not described. Then, in step S189, access integration unit 40 determines whether the direction of data migration that was specified in step S188 is the same as the direction of data migration of step S184. If the directions are not the same, the processing returns to step S183. If the directions are the same, access right integration unit 40 creates in step S190 a new data migration relationship arc 901 from alias-defined node 801 towards node 806, which is at the initial point of the authority delegation relationship arc, as shown in FIG. 36. After step S190, the processing returns to step S181.

Access right integration unit 40 repeatedly executes the above-described process until there are no more arcs that should be integrated, that is, arcs representing authority delegation relationships and alias definition relationship arcs, and creates new data migration relationship arcs while also eliminating arcs representing authority delegation relationships and alias definition relationship arcs to create graphs that are integrated to the two types of arcs shown in FIG. 37, that is, arcs representing affiliation relationships and arcs representing data migration relationships.

Next, a description will be provided on a specific example of the data transfer path conversion processing by data transfer path conversion unit 51 in step S205. The data transfer path conversion processing is processing for converting graphs composed of two types of arcs, namely, arcs representing affiliation relationships and arcs representing data migration relationships, to a tree structure composed solely of data migration relationship arcs in order to enable retrieval of data transfer paths that match security assessment policies. In other words, data transfer path conversion unit 51 converts graphs composed of two types of arcs to a tree structure composed of one type of arc. Hereinafter, a tree structure may be referred to simply as tree.

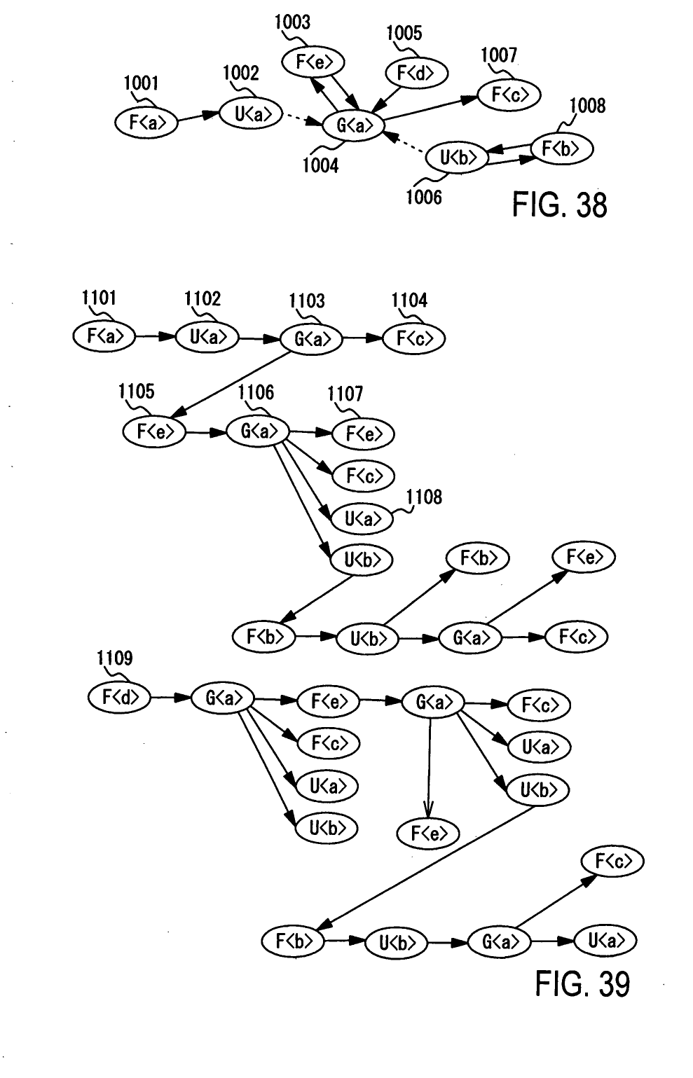

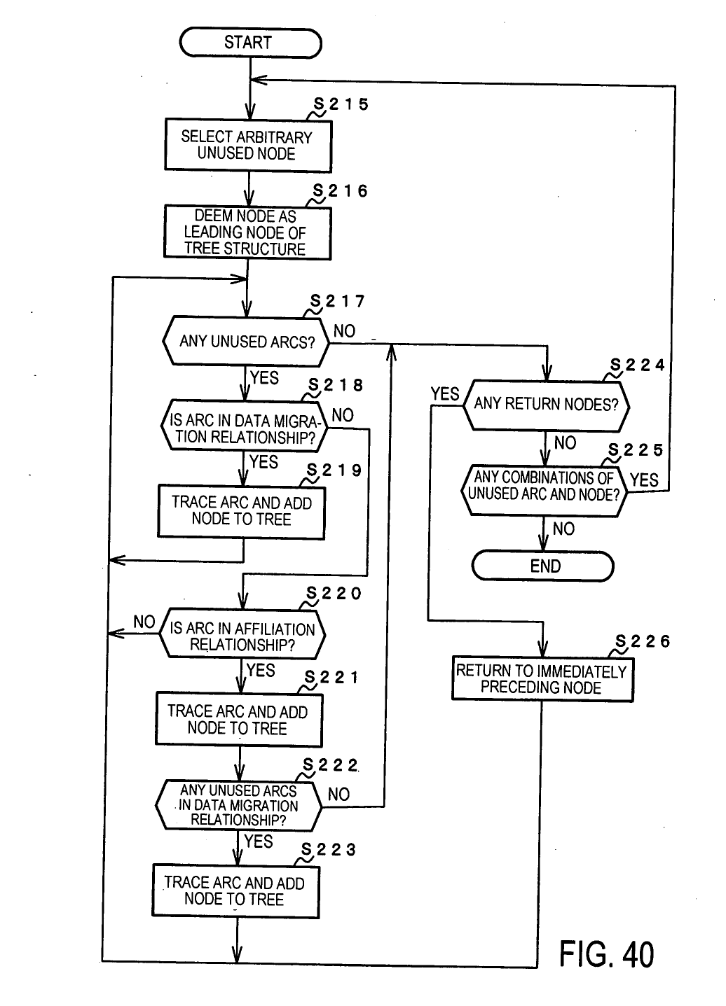

In this case, for instance, a description will be provided on the data transfer path conversion process when the data transfer paths shown in FIG. 38 are given. FIG. 39 shows the data transfer paths after conversion of the data transfer paths shown in FIG. 38 by the data transfer path conversion process. FIG. 40 is a flowchart showing the data transfer path conversion processing.

In the data transfer path conversion processing, data transfer path conversion unit 51 first selects any node that is not in use in step S215. A “node that is not in use” refers to a node that is still not being used in the current data transfer path conversion processing. Of each of the nodes of the data transfer paths, any node to which an arrow indicating an arc is not directed is selected in step S215. In this case, node 1001 or node 1005 shown in FIG. 38 is selected in step S215.

When node 1001 is selected in step 215, data transfer path conversion unit 51 takes the selected node 1001 as node 1101 and adds it as a root of the tree structure in step S216. When node 1001 is added to the tree, data transfer path conversion unit 51 confirms the existence of arcs that are not being used in node 1001 that has been added to the tree in step S217. An “arc that is not being used” refers to an arc that is still not being used in the current data transfer path conversion processing.

If an unused arc exists, data transfer path conversion unit 51 determines in step S218 whether this arc is in a data migration relationship. If the arc is in a data migration relationship, node 1002 that is at the destination of this arc is added to the tree as node 1102 in step S219, whereupon the process returns to step S217.

Alternatively, if the unused arc is not in a data migration relationship, data transfer path conversion unit 51 determines whether this arc is in an affiliation relationship in step S220. If the arc is not in an affiliation relationship, the process returns to step S217. If the arc is in an affiliation relationship, data transfer path conversion unit 51 adds the node that is at the destination of this arc to the tree in step S221. More specifically, since an affiliation relationship arc that is not being used exists at node 1002 that has been added to the tree as shown in FIG. 38, node 1004 that is at the destination of this arc is added to the tree as node 1103 as shown in FIG. 39.

When the node that is at the destination of an affiliation relationship arc is added to the tree, data transfer path conversion unit 51 confirms whether there is a data migration relationship arc that is not being used in step S222. If such an arc exists, the node that is at the destination of this arc is added to the tree in step S223, and the processing returns to step S217. In other words, after using an affiliation relationship arc to visit a node, data transfer path conversion unit 51 confirms only whether there is a node that may be visited by using a data migration relationship arc.

When it is determined in step S217 that there are no unused arcs, or when it is determined in step S222 that there are no unused data migration relationship arcs, data transfer path conversion unit 51 confirms the existence of returning nodes in step S224. If there is a returning node, data transfer path conversion unit 51 returns a single node in step S226 and proceeds to step S217. On the other hand, if there are no returning nodes in step S224, data transfer path conversion unit 51 confirms the existence or absence of a combination of unused arc and node in step S225. If such a combination exists, data transfer path conversion unit 51 proceeds to step S215, and if not, the processing is concluded.

When all arcs have been used according to the above-described procedure to convert the graph structure shown in FIG. 38, a tree structure is created such as shown in FIG. 39 having a root that takes node 1001 as node 1101 and a root that takes node 1005 as node 1109. In other words, conversion is made to data transfer paths of the tree structure shown in FIG. 39.

Next, a description will be provided on a specific example of security assessment policy input processing by policy input unit 10 in step S206. The security assessment policy input processing is processing of accepting the designation of security assessment policies from a user and applying these as input to assessment unit 50.

The security assessment policies represent data transfer paths that should not exist and are described by regular expressions of nodes. In addition to nodes, symbols for representing sets of nodes may also be defined and used. In this case, for example, assume that [NET] represents any network node, and [USER] represents any user. In addition, assume that “.” represents any node, “*” represents 0 or more repetitions of an immediately preceding node or symbol, “|” represents “OR”, and “̂” represents a node other than the immediately subsequent node. In addition to these examples, other symbols of known regular expressions may be used.

FIG. 41 shows an example of the expression of security assessment policies that policy input unit 10 accepts from a user. In FIG. 41, five examples of security assessment policies are described, namely, “Policy 1” to “Policy 5.”

“Policy 1” indicates that the information of user node U<a> must not migrate to file node F</d/> via any node. In other words, “Policy 1” shows that user “a” must not write to file “/d/” by any path.

“Policy 2” indicates that the information of file node F</c/> must not migrate to user node U<a> via any node or via any network. In other words, “Policy 2” shows that file “/c/” must not be read by user “a” via a network.

“Policy 3” indicates that the information of file node F</c/> must not pass via any node other than network node N<p443>, and moreover, must not migrate to user node U<b> via any node. In other words, “Policy 3” shows that file “/c/” must not be read by user “b” using a network other than port 443.

“Policy 4” indicates that information other than user node U<b> must not migrate via any node to file node F</b/public/>. In other words, “Policy 4” shows that a user other than user “b” must not write to file “/b/public/.”

“Policy 5” indicates that information other than user node U<b> or user node U<g> must not migrate via any node to file node F</b/public/s/>. In other words, “Policy 5” shows that users other than user “b” or user “g” must not write to file “/b/public/s/.”

Description next regards a specific example of the pattern matching processing that is executed by pattern matching unit 52 in step S207.

In the pattern matching processing, pattern matching unit 52 both receives data transfer paths from data transfer path conversion unit 51 and receives security assessment policies from policy input unit 10. Pattern matching unit 52 then searches among the data transfer paths received from data transfer path conversion unit 51 for paths that match the security assessment policies received from policy input unit 10. More specifically, pattern matching unit 52 searches for and extracts arcs and nodes that are included in paths that match security assessment policies. The security assessment policies shown in FIG. 41 conform to regular expressions. As a result, the pattern matching processing by pattern matching unit 52 may be realized using a search algorithm of well known regular expressions.

Violation path retrieval processing that is executed by pattern matching unit 52 as processing executed before step S210 will now be described.

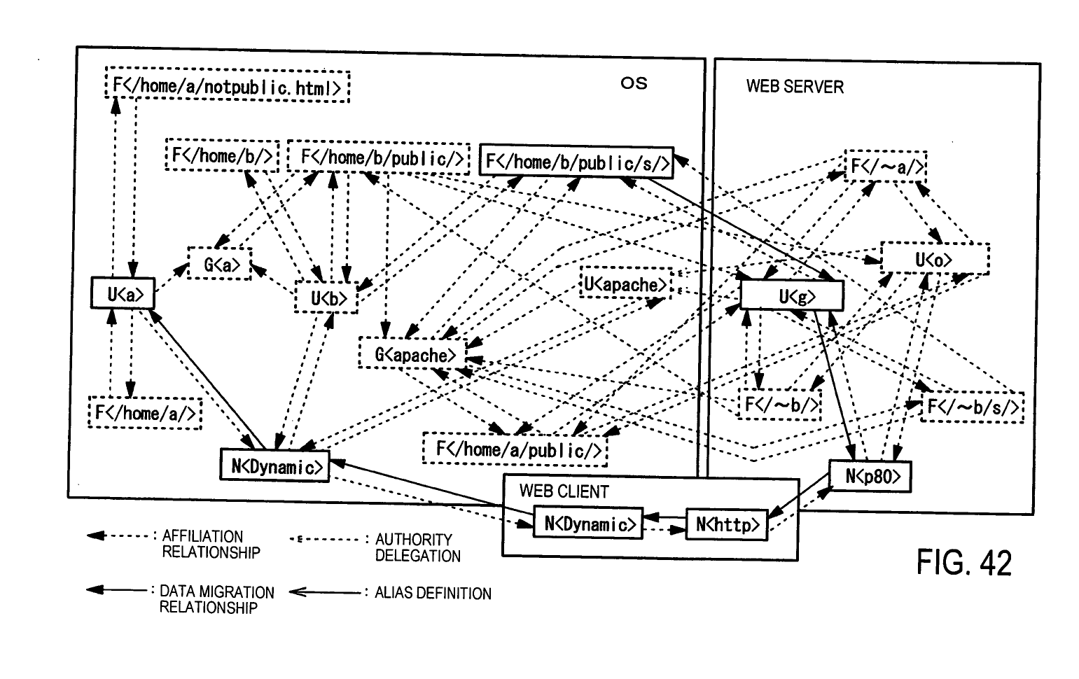

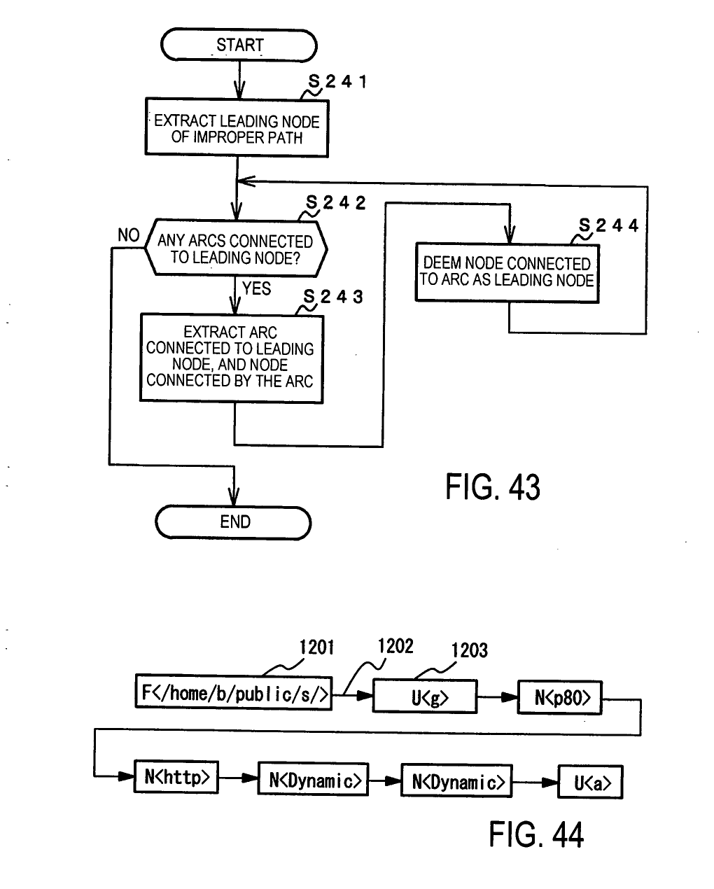

FIG. 42 shows a graph representing improper paths that have been retrieved by the pattern matching process by pattern matching unit 52. In this figure, solid line arrows show improper paths. Nodes enclosed by solid lines in FIG. 42 are nodes that are the initial points, final points, or intermediate points of improper paths. FIG. 43 is a flowchart showing violation path retrieval processing. FIG. 44 shows the extraction of improper paths shown in FIG. 42. A description will now be given on processing for searching improper paths shown in FIG. 42 and for generating improper paths shown in FIG. 44.

In the violation path retrieval processing, pattern matching unit 52 first extracts the leading node 1201 of an improper path in step S241. In step S242, pattern matching unit 52 investigates whether an arc exists which is connected to the leading node, and if such an arc exists, pattern matching unit 52 extracts arc 1202 and node 1203 in step S243. Pattern matching unit 52 next takes node 1203 as the leading node in step S244, and then proceeds to step S242 and repeats the above-described processing. This processing enables the generation of improper paths shown in FIG. 44. Pattern matching unit 52 next delivers data indicating the generated improper paths to setting information retrieval unit 80.

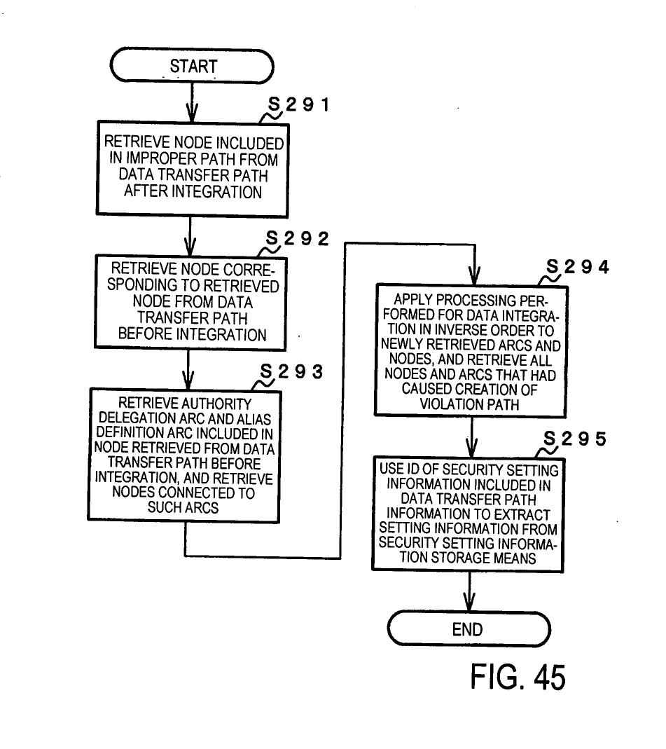

Next, a description will be provided on setting information retrieval processing executed by setting information retrieval unit 80 in step S210. FIG. 45 is a flowchart showing the setting information retrieval processing. Processing in which setting information retrieval unit 80 retrieves improper settings that cause permission of improper paths shown in FIG. 44 will now be described.

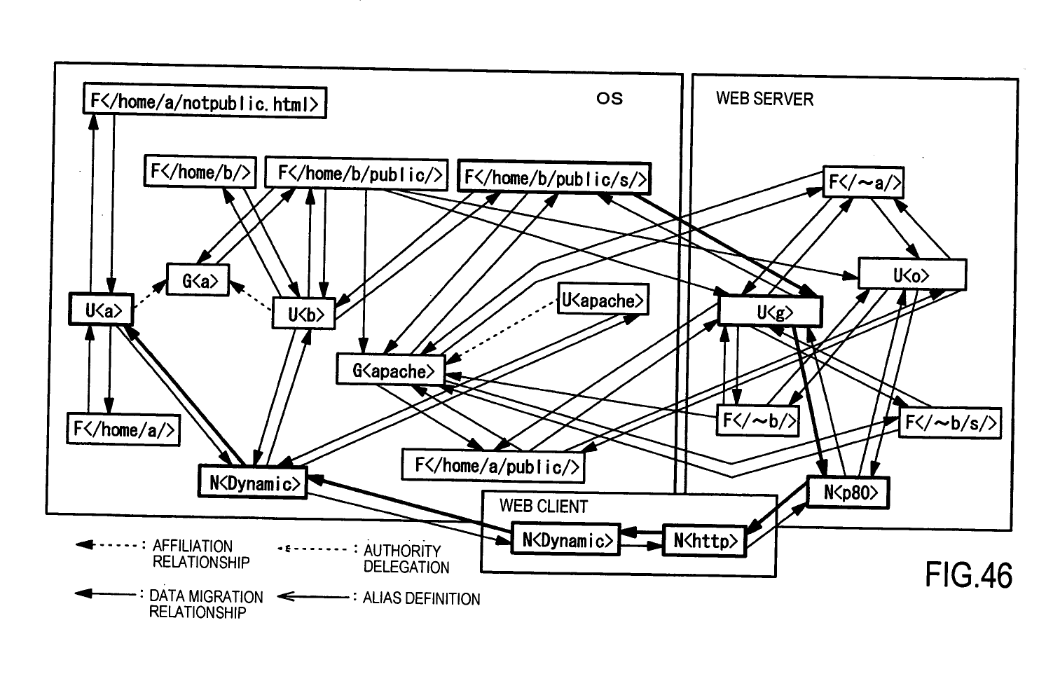

In the setting information retrieval processing, setting information retrieval unit 80 first searches in step S291 for nodes that are included in the improper paths received from pattern matching unit 52 among the data transfer paths after access right integration by access right integration unit 40 which are stored in data transfer path information storage unit 32. FIG. 46 shows an example of a state where a node included in an improper path has been retrieved from a data transfer paths after access right integration. As shown in FIG. 46, the nodes included in improper paths, that is, the nodes enclosed in bold-print boxes, are retrieved from the data transfer paths after access right integration. Additionally, in step S291, if there are arcs that correspond to the data transfer paths after access right integration based on the improper paths received from pattern matching unit 52 as shown in FIG. 46, arcs representing data migration relationships, that is, arcs indicated by bold black arrows, are searched for each node included in the improper paths.

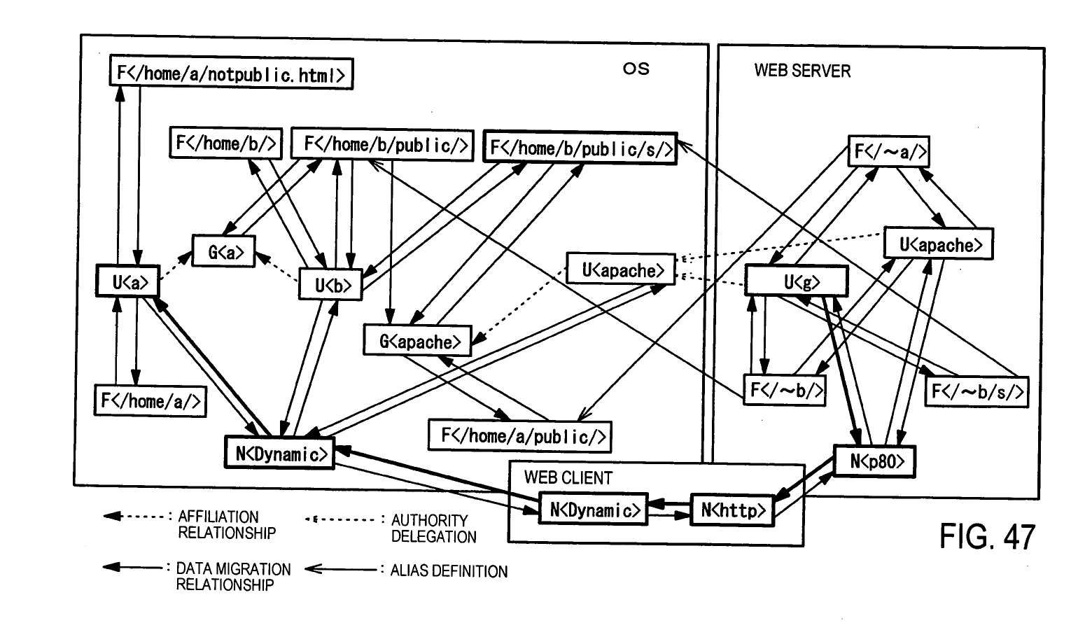

Setting information retrieval unit 80 next retrieves in step S292 nodes corresponding to nodes that have been retrieved from data transfer paths that precede access right integration. FIG. 47 shows an example of a state where an improper path in a data transfer path prior to access right integration has been retrieved. As shown in FIG. 47, nodes corresponding to the nodes that were retrieved in step S291 are retrieved from data transfer paths that precede access right integration, and nodes included in improper paths, that is, nodes enclosed by bold-print lines are retrieved from data transfer paths that precede access right integration. In addition, if arcs corresponding to arcs retrieved in step S291 exist in data transfer paths that precede access right integration, the former arcs (arcs indicated by bold black arrows) are retrieved in step S292 based on improper paths received from pattern matching unit 52, as shown in FIG. 46.

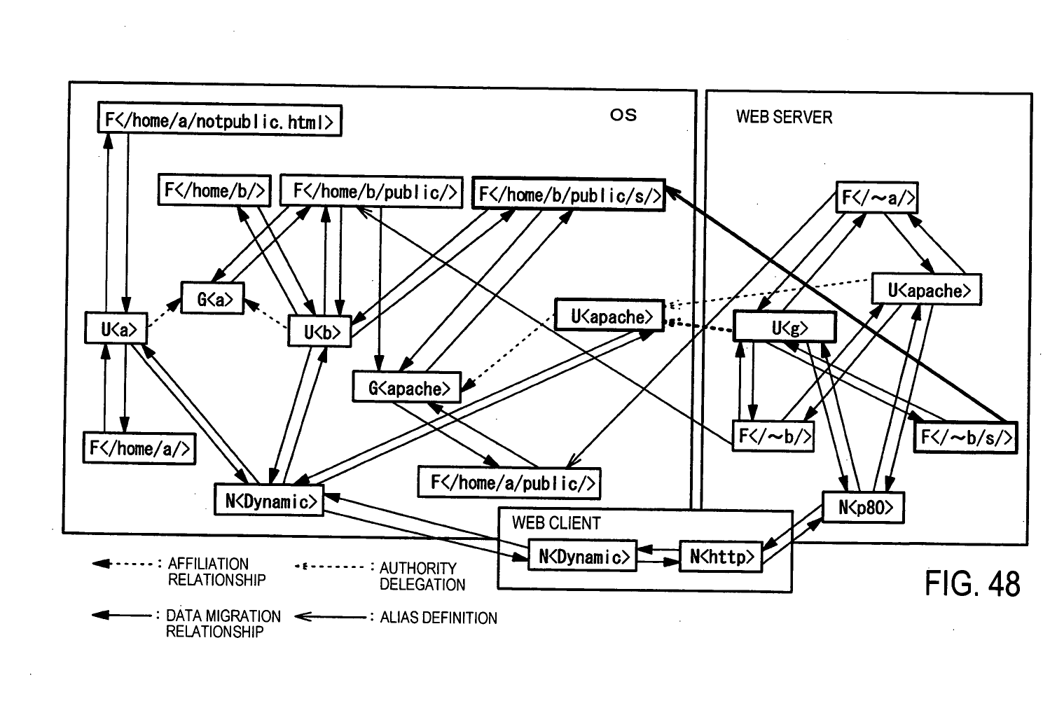

In step S293, setting information retrieval unit 80 searches for authority delegation and alias definition arcs included in nodes retrieved from data transfer paths that precede access right integration, and retrieves nodes connected to these arcs. In step S293, the authority delegation and alias definition arcs that relate to nodes that have been retrieved from data transfer paths that precede access right integration are retrieved. Authority delegation and alias definition arcs are arcs indicating any of authority delegation origin, authority delegation destination, alias definition origin, and alias definition destination. Further, all nodes that relate to arcs retrieved in this manner, that is, nodes that are any of the authority delegation origin, authority delegation destination, alias definition origin, and alias definition destination, are retrieved in step S293. FIG. 48 is a diagram showing an example of a state where an authority delegation arc, an alias definition arc, and a node connected to these arcs have been retrieved. In this example, as shown in FIG. 48, one authority delegation arc and one alias definition arc are found in step S293 based on respective nodes retrieved from data transfer paths that precede access right integration shown in FIG. 47, and four nodes related to these arcs are retrieved.

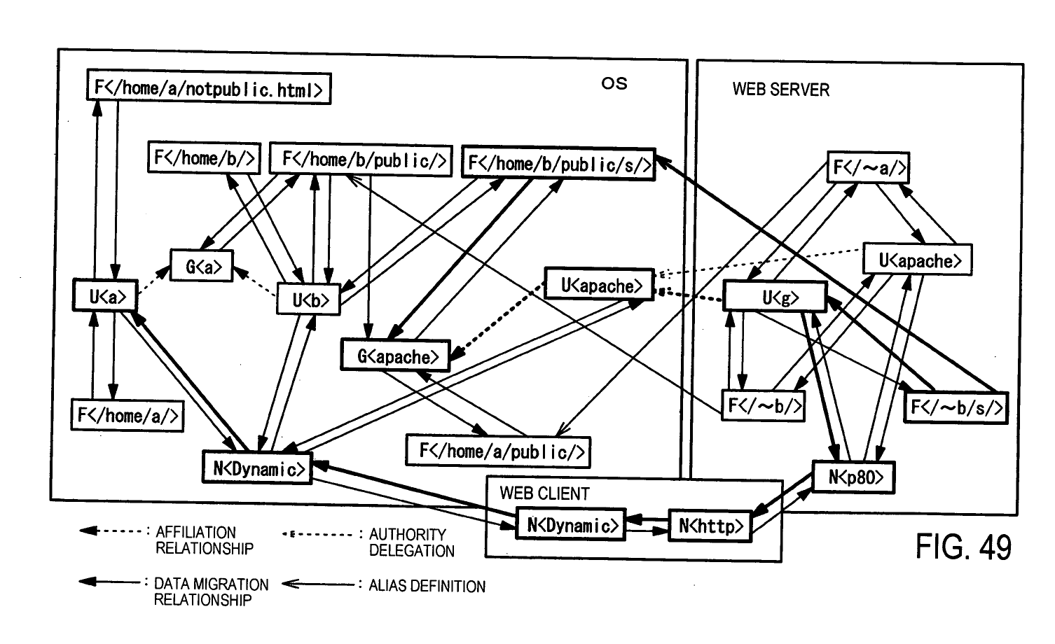

In step S294, setting information retrieval unit 80 next applies, in reverse order, the processes that were carried out in the data integration of arcs and nodes that are newly retrieved in step S293, and searches for all nodes and arcs that caused the creation of improper paths. FIG. 49 shows an example of a state where all nodes and arcs responsible for the creation of an improper path have been retrieved. As shown in FIG. 49, in this example, two data migration relationship arcs having the same direction of migration for two nodes that are in an alias definition relationship and one of two authority delegation arcs indicating that the data migration destinations are in an authority delegation relationship are retrieved in step S294 based on the arcs and nodes newly retrieved in step S293. In addition, nodes related to the newly retrieved arcs are also retrieved, and furthermore, improper paths already retrieved that are shown in FIG. 47 are added.

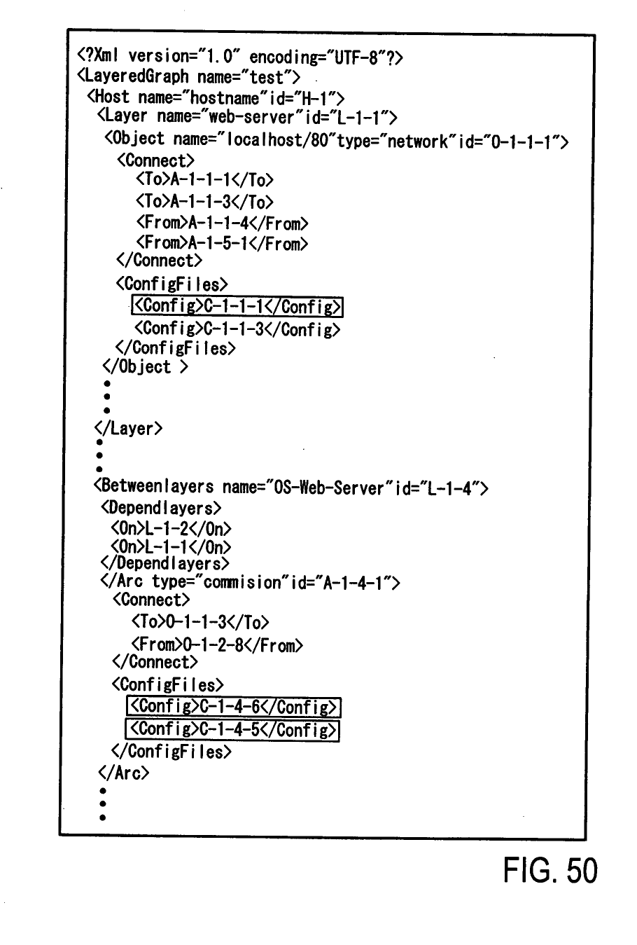

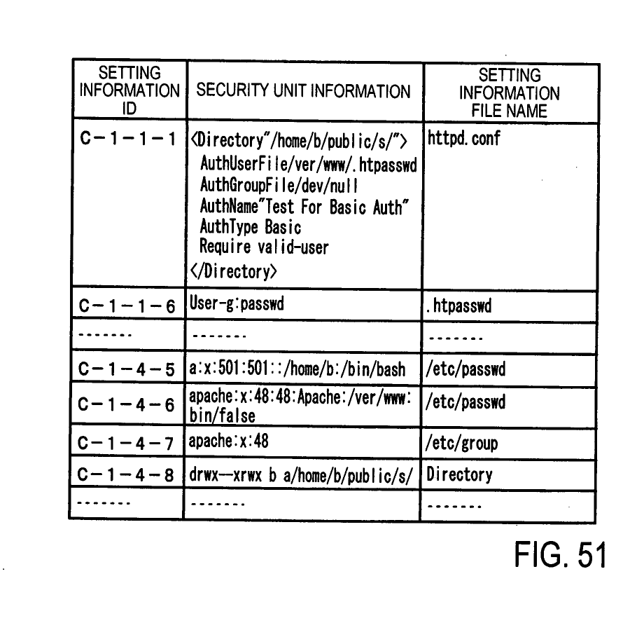

In step S295, setting information retrieval unit 80 next uses the IDs of security setting information contained in the data transfer path information to extract from setting information storage unit 31 the security setting information that caused the creation of all retrieved nodes and arcs. FIG. 50 shows an example of a state in which the positions of improper settings are indicated in the data transfer path information, while FIG. 51 shows an example of the security setting information that has been extracted from setting information storage unit 31. As shown in FIG. 50, setting information retrieval unit 80 reads data transfer path information (refer to FIG. 5) from data transfer path information storage unit 32, and based on the improper paths shown in FIG. 49, searches for the portions at which improper settings have occurred in the data transfer path information, such as, the portions enclosed in squares. Then, as shown in FIG. 51, based on the setting information IDs of the security settings at which improper settings have occurred, setting information retrieval unit 80 reads from setting information storage unit 31 the security setting information that contains security unit information at which improper settings have occurred.

The above-described processing enables the extraction of security setting information that includes setting errors that causes the generation of improper paths.

Next, a description will be provided on improper setting display processing by assessment result display unit 60 in step S211.

Assessment result display unit 60 executes processing for displaying on a display screen and informing a user such as a system assessor of information showing improper settings retrieved by setting information retrieval unit 80, such as the information indicating improper setting locations shown in FIG. 50 and information indicating the contents of improper settings that is shown in FIG. 51. The execution of these specific processing enables the retrieval of improper paths in assessment object system 111 and the notification of the improper settings.

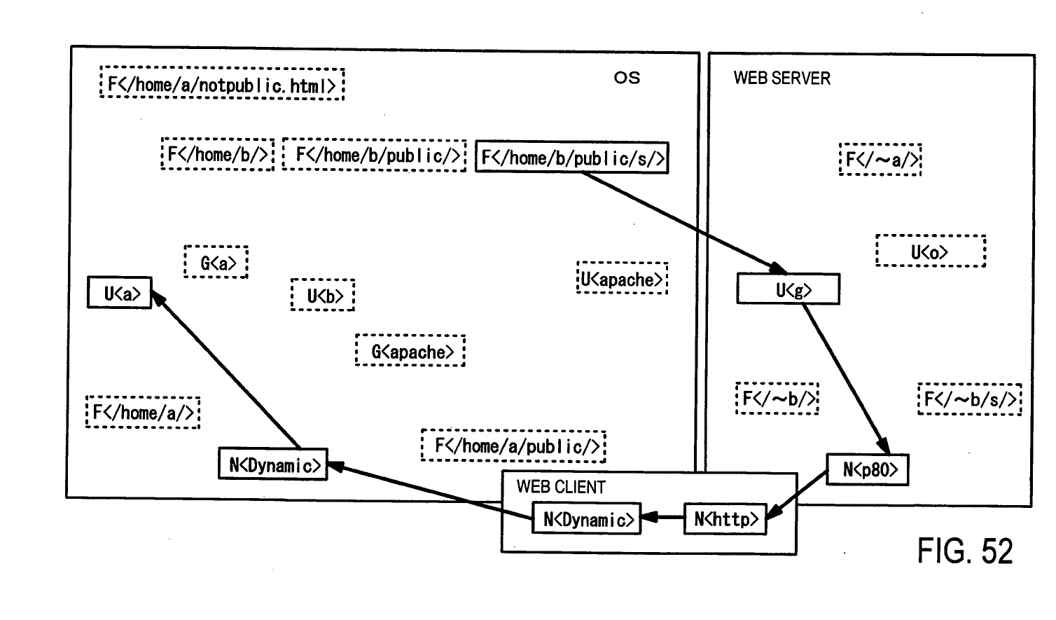

Although not discussed in the above example, paths based on improper settings may be displayed. In such a case, migration paths that are inappropriate may be highlighted and reported by displaying graphs such as shown in FIG. 52 on a display screen. In FIG. 52, only the improper paths are displayed by solid black arrows. Any type of display format may be adopted as long as the improper paths are highlighted. It is also possible to display a graph of the state in which all nodes and arcs that caused the creation of improper paths have been retrieved such as shown in FIG. 49.

When integrating access rights, access right integration unit 40 in this example performs processing for generating arc 901 indicating a data migration relationship shown in FIG. 36 from arc 805 or the like that indicates an authority delegation shown in FIG. 35. Although not mentioned in the above example, when generating arc 901 indicating a data migration relationship, the setting information IDs accompanying all arcs and nodes that are used in generating arc 901, that is, all arcs and nodes that were used for specifying the data migration relationship, may be copied as the setting information ID of newly created arc 901. As a result, the setting information IDs of all arcs and nodes that are used in the generation of an arc are associated with the arc of the data migration relationship generated when integrating access rights. Furthermore, when security setting information is associated with arcs and nodes instead of setting information IDs, this security setting information may be copied to a newly generated arc of a data migration relationship. Thus, in security assessment system 100 that is provided with access right integration unit 40 provided with a function for associating security setting information IDs with arcs of data migration relationships that are newly generated when integrating access rights, setting information retrieval unit 80 should perform the following processing. Specifically, in this case, after searching for all nodes and arcs that compose the improper paths based on the node strings of improper paths that have been supplied by pattern matching unit 52, setting information retrieval unit 80 performs processing for searching for security setting information from setting information storage unit 31 based on the setting information IDs associated with these nodes and arcs, and for supplying the security setting information extracted through retrieval to assessment result display unit 60. If security setting information is associated with arcs and nodes instead of setting information IDs, setting information retrieval unit 80 may supply the security setting information associated with all nodes and arcs that compose the improper paths to assessment result display unit 60 without searching in setting information storage unit 31.

### Example 2

A description will now be provided on a specific example of the above-described security assessment system 100 from the perspective of a user interface. In this case, the description will focus on the screens that are displayed on the display device provided in examining computer 120 of security assessment system 100 shown in FIG. 26.

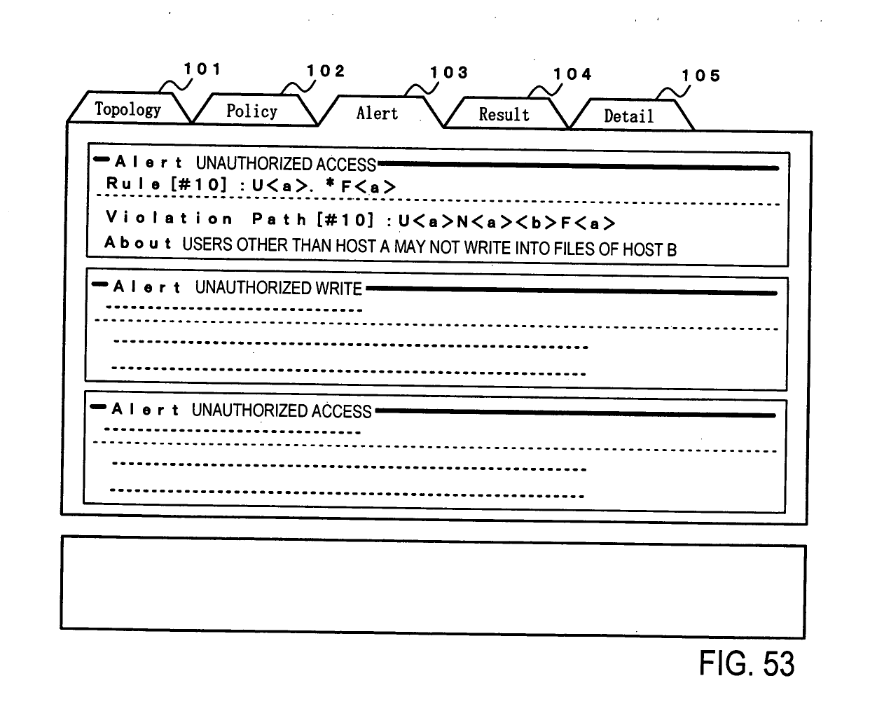

FIG. 53 shows an example of a primary screen showing a user interface in security assessment system 100 in its entirety. The primary screen is provided with display areas for displaying a plurality of tabs 101, 102, 103, 104, and 105. When any of tabs 101, 102, 103, 104, and 105 are selected through the operation of a user such as a system assessor, a screen is displayed that corresponds to the selected tab. In other words, in the primary screen, the display content of the screen may be switched in accordance with a tab selection operation by the assessor or the like to allow display of a plurality of items of information. Incidentally, FIG. 53 shows an alert screen that is displayed when alert tab 103 is selected.

Next, a description will be provided on operations of a user interface by an assessor or the like when security assessment system 100 is arranged to execute security authentication processing.

When security assessment system 100 is arranged to execute security authentication processing, a user such as a system assessor first operates a console (not shown) provided in examining computer 120 to have a primary screen (refer to FIG. 53) displayed on the display device. An information input device such as a keyboard or mouse is used as the console.

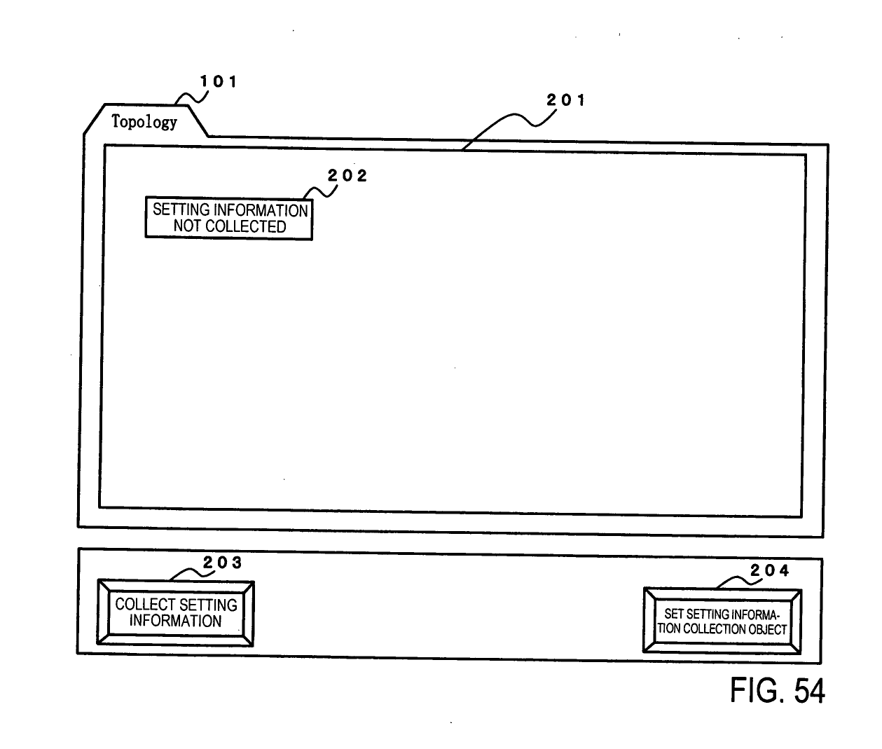

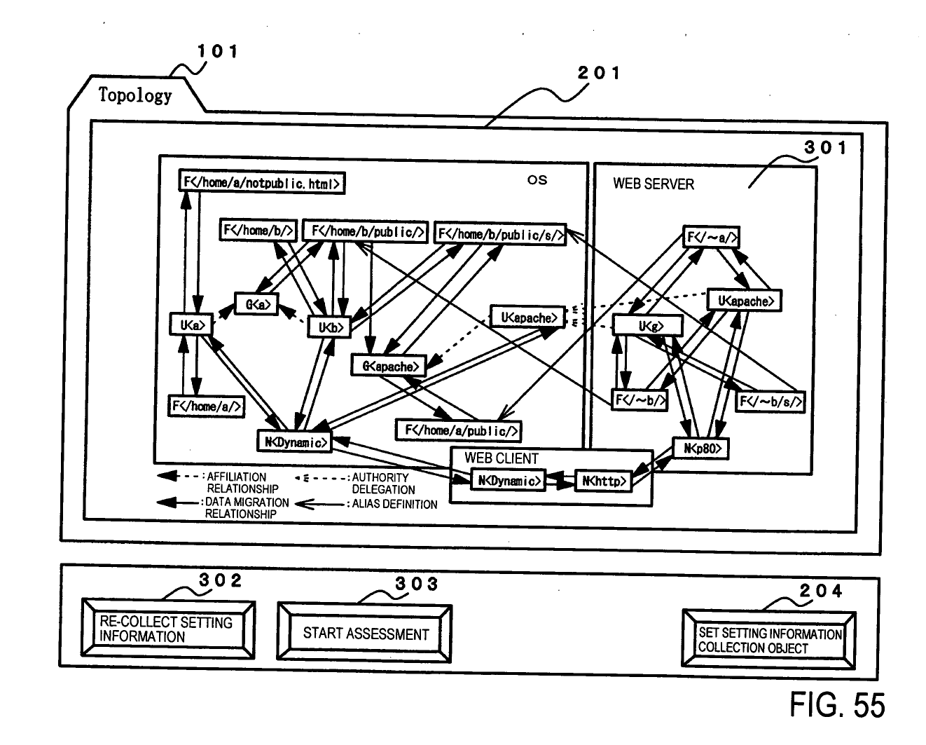

The user such as a system assessor next selects topology tab 101 by operating the console and thus causes the display of the topology screen. FIGS. 54 and 55 show examples of topology screens displayed on the display device when topology tab 101 is selected. When topology tab 101 is selected on the primary screen, examining computer 120 causes the display of the topology screen shown in FIG. 54 on the display device. FIG. 53 shows an example of a topology screen when information is not being collected by setting information collection unit 70.

The topology screen shown in FIG. 54 is provided with: setting information display window 201, setting information collection button 203, and setting information collection object setting button 204. In this case, “setting information not collected indication” 202 indicating that information has not yet been collected is enabled in setting information display window 201. Setting information collection button 203 is a button for instructing setting information collection unit 70 to collect security setting information. Setting information collection object setting button 204 is a button for selecting the host that is to be an object of security setting assessment. Pressing setting information collection object setting button 204 causes the display of a list of computers or programs that are candidates for the object of security settings assessment. An assessment object of security settings may also be selected from this list.

When the topology screen shown in FIG. 54 is displayed, the assessor or the like operates the console to press or click setting information collection button 203 and then either instructs the collection of security setting information or instructs the generation of data transfer paths.

When security setting information is collected in accordance with the collection instructions that are issued by pressing or clicking setting information collection button 203, data transfer paths that have been created based on the collected security setting information are displayed in setting information display window 201, for example, as shown in FIG. 55. In this case, data transfer paths (refer to FIG. 33) that have been generated by data transfer path generation unit 21 are displayed, as shown in FIG. 55.

The topology screen shown in FIG. 55 is provided with: display area 301 for displaying data transfer paths, setting information re-collection button 302, assessment start button 303, and setting information collection object setting button 204. In other words, setting information collection button 203 changes to setting information re-collection button 302 after the execution of collection of security setting information or the like. In addition, the topology screen shown in FIG. 55 shows a state in which the data transfer paths that are generated based on security setting information collected in accordance with the pressing or clicking of setting information collection button 203 are displayed in display area 301 in setting information display window 201.

Setting information re-collection button 302 is a button for instructing setting information collection unit 70 to once again collect security setting information and for causing redrawing of the data transfer paths on setting information display window 201. Assessment start button 303 is a button for causing access right integration unit 40 to execute processing for integrating the access rights of data transfer paths that have been generated by data transfer path generation unit 21 and stored in data transfer path information storage unit 32, transmitting data transfer paths to assessment unit 50 after access right integration, and instructing the start of security assessment by assessment unit 50.

When the topology screen shown in FIG. 55 is displayed, the assessor or the like operates the console to press or click assessment start button 303 and thus instructs the start of assessment in assessment unit 50. In this example, the instruction for starting assessment causes access right integration by access right integration unit 40, and further, the generation of data transfer paths that have been converted by data transfer path conversion unit 51, and the transmission of these data transfer paths to pattern matching unit 52. Assessment unit 50 then enters a standby state for input of security assessment policies.

The assessor or the like next operates the console to specify the security assessment policies to be used in assessment. In other words, the assessor or the like, by manipulating the console, selects policy tab 102, causes display of the policy screen, and designates the security assessment policies in the policy screen.

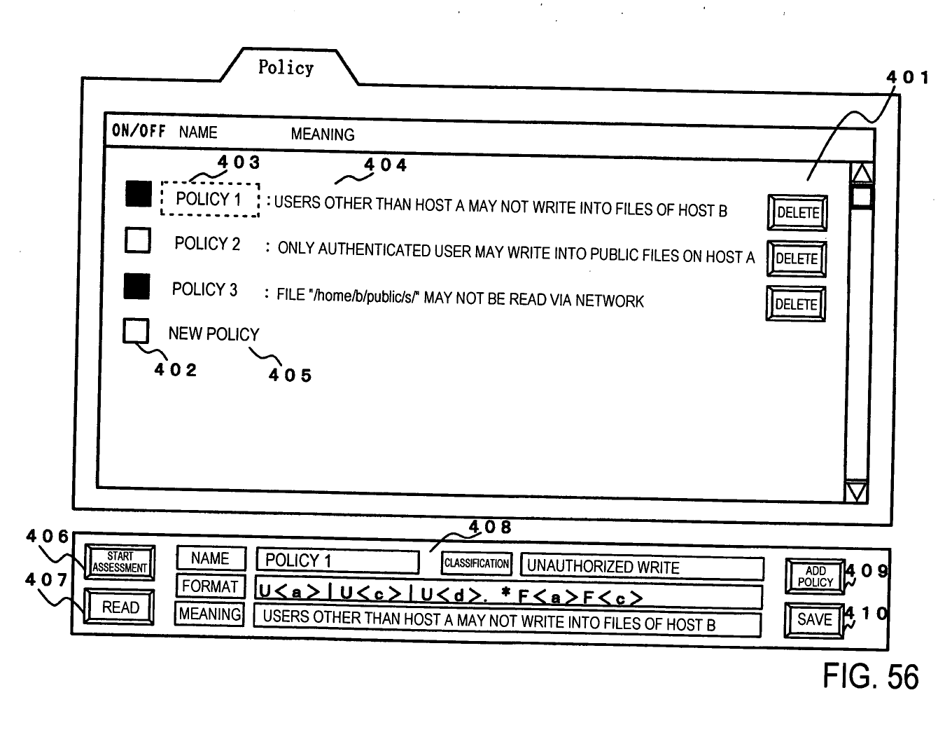

FIG. 56 shows an example of a policy screen displayed on the display device when policy tab 102 has been selected. As shown in FIG. 56, the policy screen is provided with policy list window 401 displaying a list of security assessment policies. Check boxes 402 of policy list window 401 are for indicating whether the object policies will actually be used for assessment. In other words, only policies for which check boxes 402 are set to ON are transmitted by policy input unit 10 to pattern matching unit 52 and used as security assessment policies of the assessment object. Incidentally, in FIG. 56, a state where the check boxes are shown to be filled indicates that the check boxes are set to ON.

The policy screen is provided with policy detailed information display window 408 in which is displayed at least one of such annexed information items as the name, format, meaning, and type of policies. A format refers to a description in accordance to the description format of the policy. In this case, when policy name 403 is selected in policy list window 401 through the user's such as the system assessor operation of the console, detailed information related to the selected policy is displayed in policy detailed information display window 408, and the policy name for which detailed information is displayed is highlighted, as shown as the portion within the dotted-line enclosure in FIG. 56.

The policy screen is further provided with: assessment start button 406, read button 407, policy addition button 409, and save button 410. Read button 407 is a button for instructing reading of a policy saved in policy storage unit 33. Save button 410 is a button for instructing saving a policy to policy storage unit 33.

In this example, when new policy 405 is selected by an operation of the console in the policy screen by the assessor or the like, all of the information in policy detailed information display window 408 is first cleared. The new policy is then written into policy detailed information display window 408 by means of an operation of the console by the assessor or the like, and the new policy is added to policy list window 401 when policy addition button 409 is pressed or clicked.

With security assessment system 100, after operating the console to specify the policies to be used in assessment in the policy screen, an assessor or the like presses or clicks assessment start button 406. In response thereof, the specified security assessment policies are transmitted to pattern matching unit 52 and, at the same time, a pattern matching processing is executed using the specified security assessment policies and data transfer paths that have already been entered. Subsequently, a setting information retrieval processing is further executed by setting information retrieval unit 80, and the retrieval results are transmitted to assessment result display unit 60.

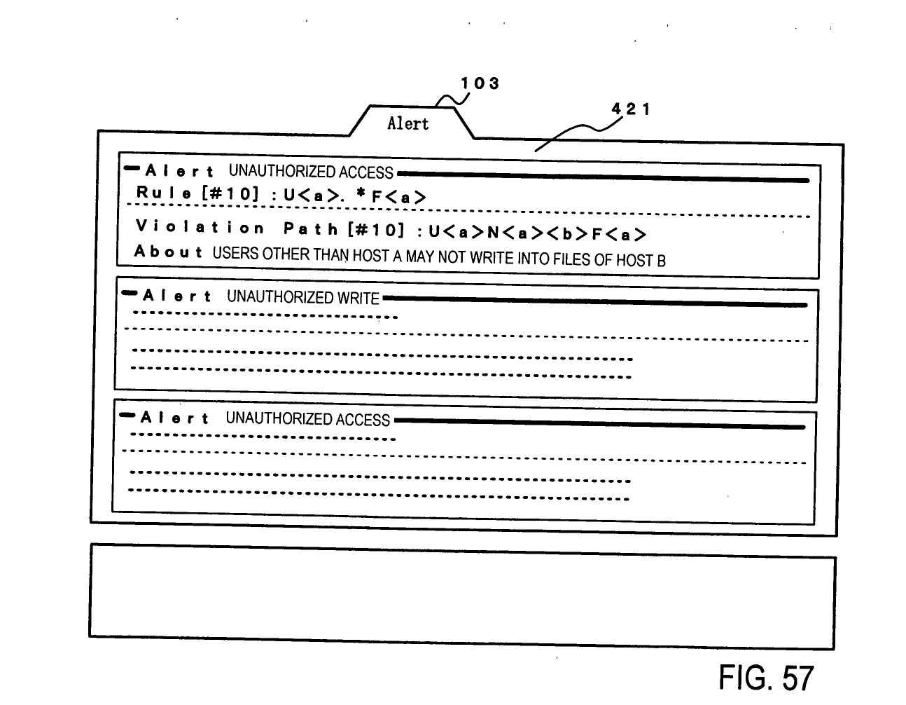

An assessor or the like presses or clicks alert tab 103 through an operation of the console. FIG. 57 shows an example of the policy screen displayed on the display device when alert tab 103 is selected. As shown in FIG. 57, the alert screen displays a list of the retrieval results of setting information retrieval unit 80. In alert list display window 421, assessment result display unit 60 displays all of the improper settings in the retrieval results that are retrieved by setting information retrieval unit 80. The items displayed as improper settings include at least one of, for example, the type, the name, and the format of the security assessment policies, and the data transfer paths matching the prohibition paths indicated by the security policy. Alert list display window 421 may further display the above-described detailed contents of improper settings that are shown in FIG. 50 or FIG. 51.

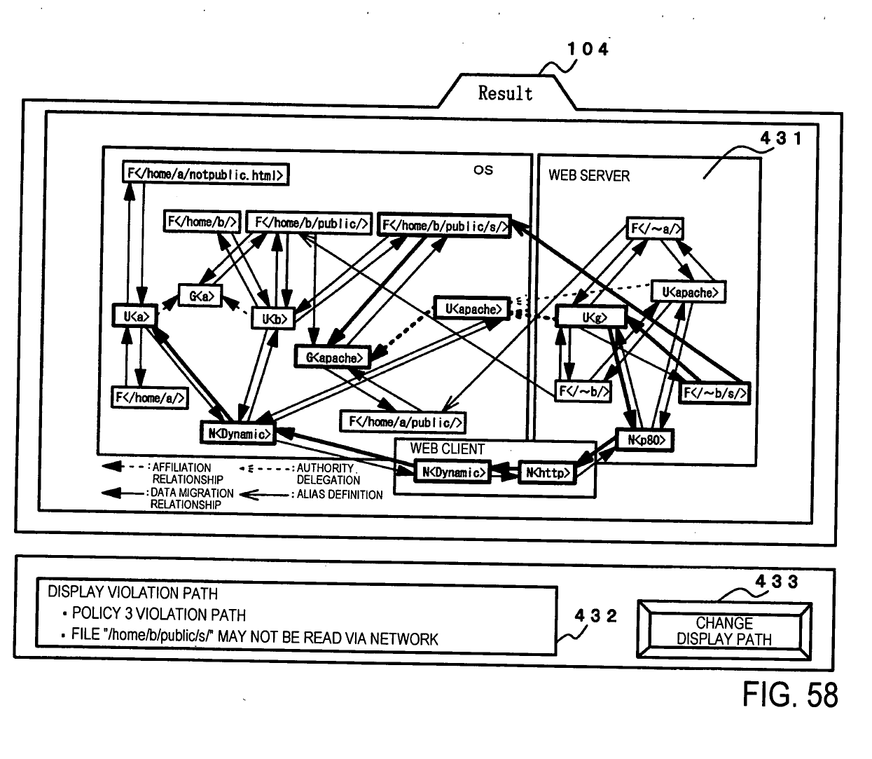

An assessor or the like presses or clicks result tab 104 through an operation of the console. FIG. 58 shows an example of the result screen displayed on the display device when result tab 104 has been selected. As shown in FIG. 58, the result screen displays a graph (refer to FIG. 49) indicating all of the improper paths retrieved by setting information retrieval unit 80. The result screen displays a graph in which the improper paths of the data transfer paths are highlighted in detected result display window 431. In addition, policy information display window 432 displays various types of information related to the violation paths (improper paths) displayed in detection result display window 431.

In this example, when displayed path alteration button 433 is selected by an operation of the console by the assessor or the like, a list of violation paths is displayed. When one violation path is selected from the list of violation paths by an operation of the console by the assessor or the like, the violation path that is displayed in detection result display window 431 changes. The violation path list assumes a display format such as shown in FIG. 42.

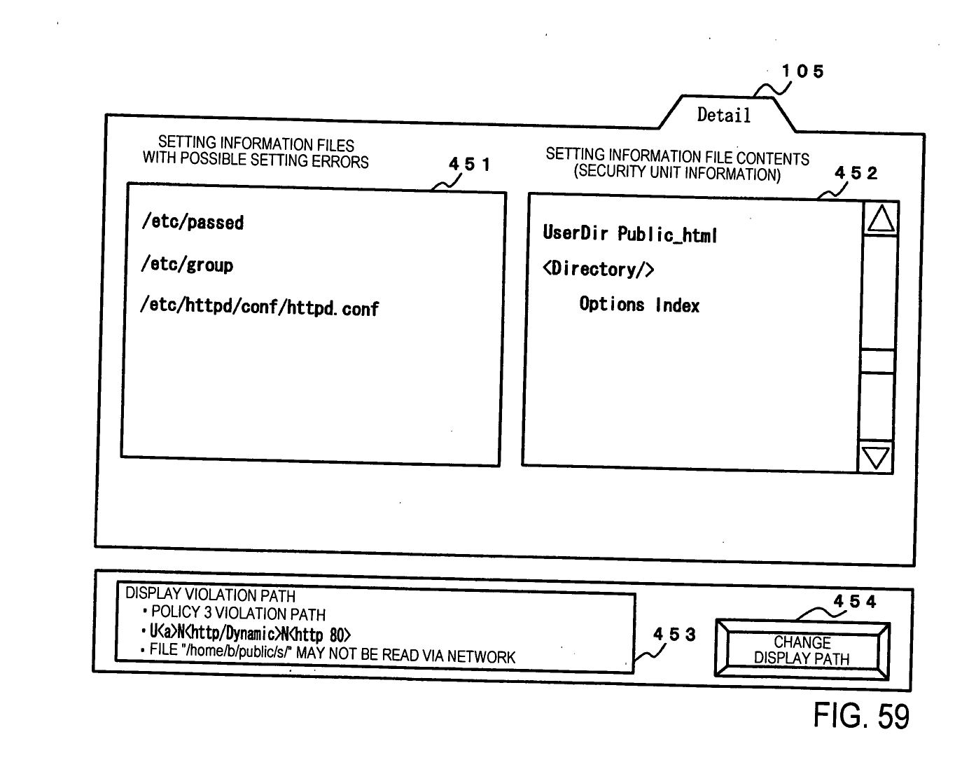

Next, an assessor or the like presses or clicks detail tab 105 through an operation of the console. FIG. 59 shows an example of the detail screen displayed on the display device when detail tab 105 has been selected. As shown in FIG. 59, detail screen displays details of the improper paths by means of assessment result display unit 60. In this case, a list of setting information files corresponding to security unit information retrieved as improper settings by setting information retrieval unit 80 is displayed in improper setting display window 451 in which is displayed the content of setting information files that are possible setting errors, that is, security unit information.

In setting file content display window 452, the detail screen shows the contents of the setting information file that has been selected by the assessor or the like in improper setting display window 451. Further, information related to the currently displayed improper path is displayed in displayed violation path display window 453.

As described above, various types of screen displays are provided for the user interface, and, based on the operations on the screen by the user such as a system assessor, various types of processes are executed and execution result are displayed.

### Example 3

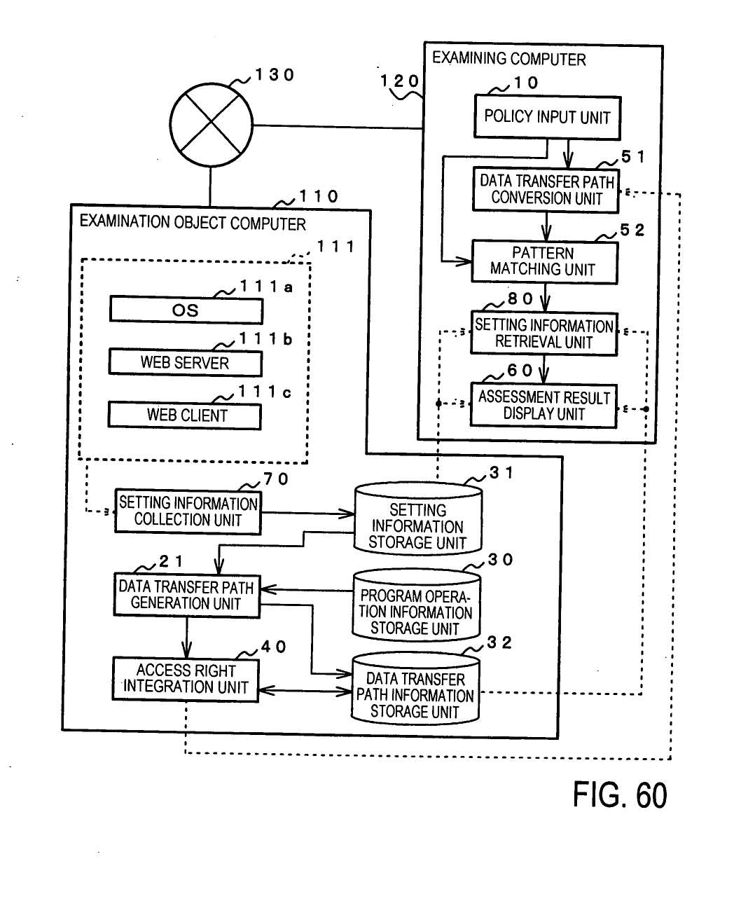

FIG. 60 shows another specific configuration of security assessment system 100 shown in FIG. 2. In comparison to FIG. 26, security assessment system 100 shown in FIG. 60 differs in the configuration of information input from the policy input unit to data transfer path conversion unit 51, but otherwise shares the same configuration.

In this example, policy input unit 10 delivers the leading node of entered security assessment policies to data transfer path conversion unit 51. Data transfer path conversion unit 51 converts the data transfer path information received from access right integration unit 40 to a tree structure that takes as its root the leading node of the security assessment policies from policy input unit 10, and supplies the data of the converted tree structure to pattern matching unit 52. Pattern matching unit 52 searches for the security assessment policies from policy input unit 10 based on the tree structure that has been converted by data transfer path conversion unit 51 and supplies the retrieval results to setting information retrieval unit 80.

Next, a description will be provided on a specific example of data transfer path conversion processing by data transfer path conversion unit 51 in step S205. In this case, for instance, a description will be provided on the data transfer path conversion processing when the data transfer paths shown in FIG. 38 are given.

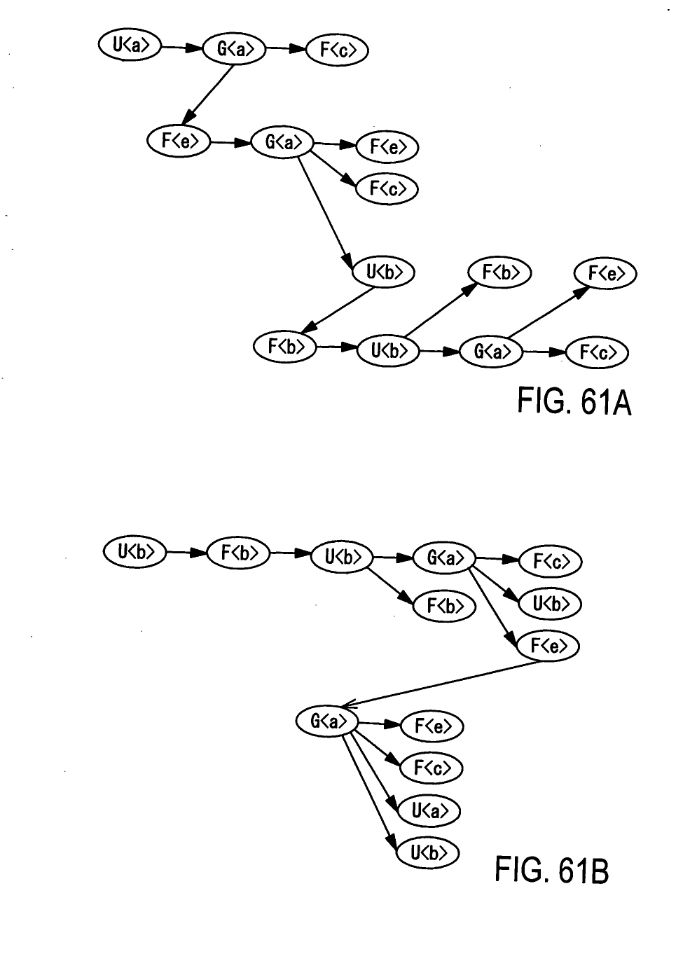

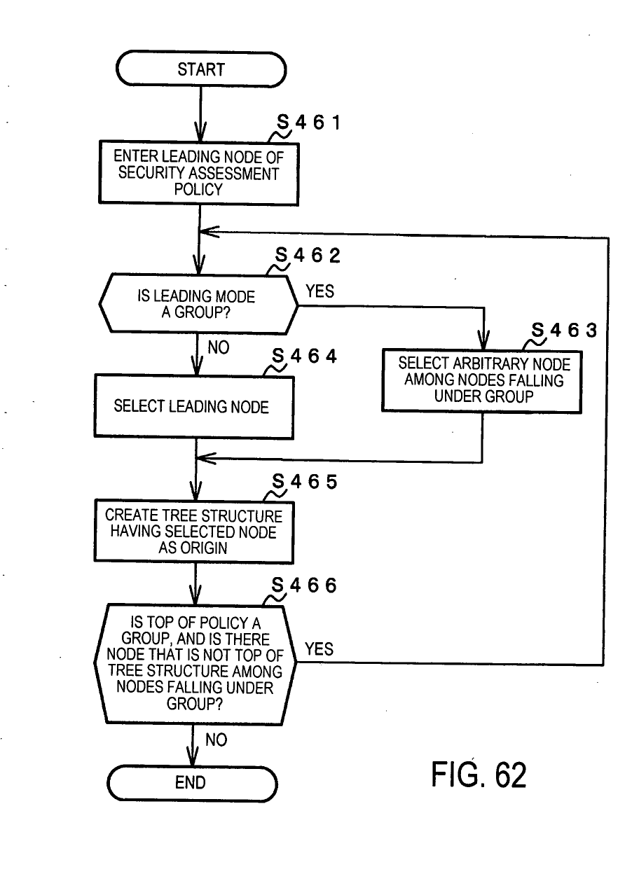

FIGS. 61A and 61B show data transfer paths after conversion of the data transfer paths shown in FIG. 38 by the data transfer path conversion processing in this example when “(U<a>|U<b>)” is given as the leading node of a security assessment policy “(U<a>|U<b>).*F<e>” from policy input unit 10. FIG. 62 is a flowchart showing data transfer path conversion processing in this example.

In the data transfer path conversion processing, data transfer path conversion unit 51 first receives “(U<a>|U<b>)” as the leading node of the security assessment policy from policy input unit 10 in step S461. In step S462, data transfer path conversion unit 51 determines whether the leading node of the received security assessment policy is a group, that is, a group node or a group of a plurality of nodes linked by OR. If the leading node is a group in step S462, data transfer path conversion unit 51 selects one of the nodes belonging to this group as the leading node in step S463. In this example, leading node “(U<a>|U<b>)” is a group, and any node that falls under this group (for example, (U<a>)) is selected in step S463. If, in step S462, the leading node of the security assessment policy is not a group, that is, if the leading node is an independent node, data transfer path conversion unit 51 selects this node as the leading node in step S464.

When a leading node has been selected, data transfer path conversion unit 51 creates a tree structure that takes the selected node as its root in step S465. In step S465, processes are executed that are similar to those of the above-described steps S216 to S223. As a result, in this example, a tree structure that takes a node (for example, (U<a>)) as its root as shown in FIG. 61A is generated.

Subsequently, it is determined in step S466 whether the leading node of the received security assessment policy is a group and whether a node remains among the nodes belonging to this group that has not yet been selected as the leading node, and if such a node exists, data transfer path conversion unit 51 returns to step S462 and then subsequently selects this node as the leading node in step S463. In this example, leading node “(U<a>|U<b>)” is a group, and because a node (for example, (U<a>)) has already been selected as the leading node, a node that falls under this group (for example, (U<b>)) is selected in this step S463. Then, in step S465, a tree structure is created that takes the selected node as its root. As a result, in this example, a tree structure that takes a node (for example, (U<b>)) as its root as shown in FIG. 61B is generated.

The processing in the above-described steps S463 to S466 is repeated until data transfer path information of tree structures that take as roots all nodes that fall under the group have been created.

In this example, as described above, data transfer path conversion unit 51 uses the leading node of a security assessment policy that has been received as input from policy input unit 10 to execute processing for the conversion to data transfer path information of tree structure.

### Example 4

Next, operations of a specific example of security assessment system 100d shown in FIG. 11 will be described. Here, specific operations of security assessment processing (refer to FIG. 13) in assessment system 100d will be described.

In this example, a description will be provided for a case where setting assessment is performed on a computer system composed of four hosts, namely, SERVER1, SERVER2, FIREWALL and CLIENT. It is assumed that the OS of all of the hosts are constituted by Linux, and hosts SERVER1 and SERVER2 operate as servers that have been installed with an application of a service that will be explained hereinbelow. In addition, for FIREWALL, firewall software called “ipchains” has been installed that performs packet filtering. For host CLIENT, client software has been installed that is used by user to log in and use the functions of other servers.

First, through setting model input unit 11, a setting model representing the configuration of the computer system and security setting information (refer to step S301) are entered. The setting model is entered according to the following procedure by having setting model input unit 11 store various types of information entered by a user such as the system assessor into setting model storage unit 34.

Setting model input unit 11 first stores in setting model storage unit 34 a host to be an assessment object that has been entered through the operations of a user such as an assessor. This processing is carried out based on the assessor's specification of the host to be the assessment object.

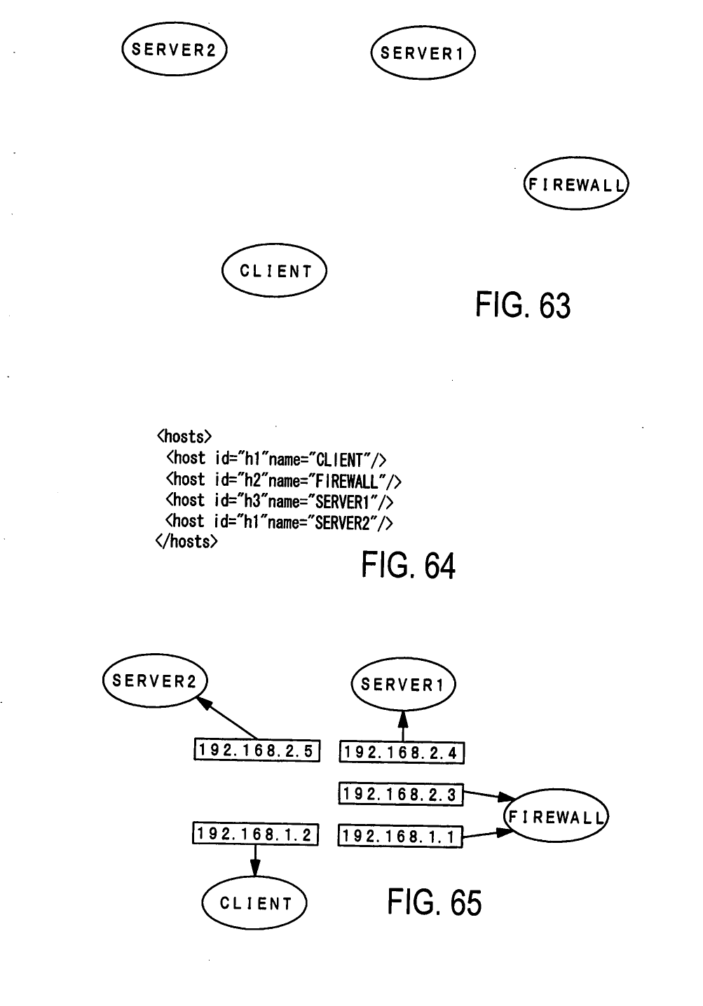

In this case, there are four hosts: SERVER1, SERVER2, FIREWALL, and CLIENT, shown in FIG. 63. Therefore, these four hosts are entered by setting model input unit 11. When the four hosts have been entered, the host that is the assessment object is stored in setting model storage unit 34 as shown in, for example, FIG. 64.

Next, by operating setting model input unit 11, the assessor or the like enters the IP addresses of the hosts. In this example, it is assumed that IP addresses are assigned to each of the hosts as shown in FIG. 65. In this case, the assessor or the like uses function “b” indicating which IP address belongs to which host, and enters:

b(192.168.2.5)=SERVER2;
b(192.168.2.4)=SERVER1;
b(192.168.2.3)=b(192.168.1.1)=FIREWALL; and
b(192.168.1.2)=CLIENT

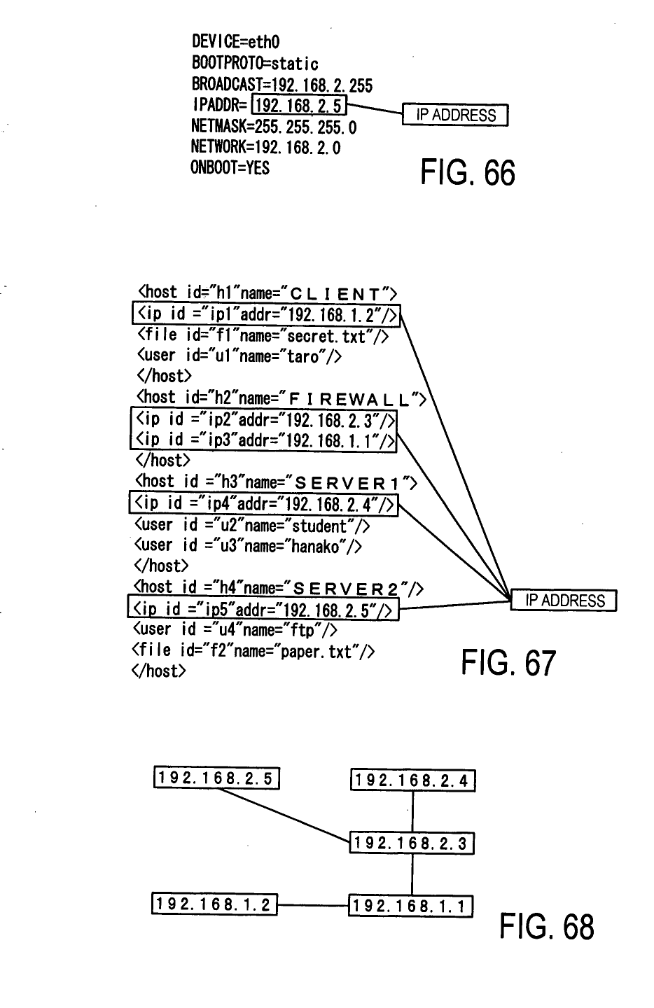

In a case where the OS is Linux, the affiliation information of the IP addresses is written in a setting file such as “ifcfg-eth0,” or “ifcfg-eth1” that is stored in the directory of each host “/etc/sysconfig/network-script/.” More specifically, the file “ifcfg-eth1” shown in FIG. 66 is stored in host SERVER2, and the numerals that follow the character string “IPADDR=” in this file is the IP address associated with SERVER2. The other IP addresses are similarly arranged.

The IP addresses of the hosts are stored in setting model storage unit 34 together with the four previously described hosts as shown, for example, in FIG. 67.

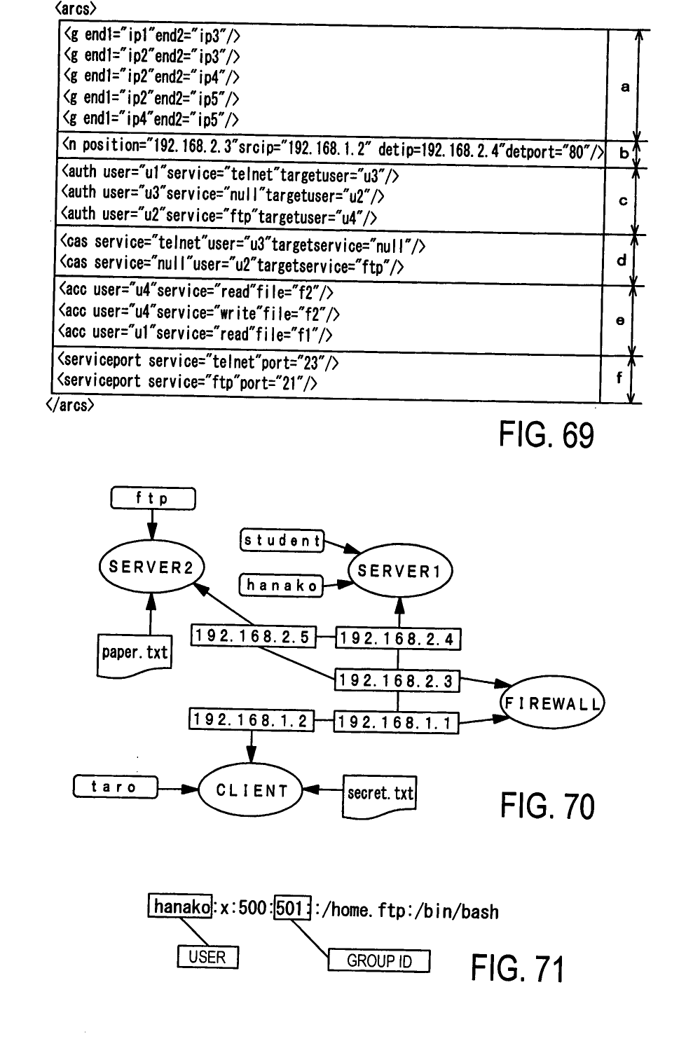

Next, Graph G representing network connections is entered. Graph G is a graph that takes each IP address as an apex. In this example, it is assumed that the network system that is the assessment object is the configuration shown in FIG. 68. Graph G is entered by having the assessor confirm the state of connections of the network devices and perform user operations on setting model input unit 11. Each IP address is defined as shown in FIG. 67, and the network system that is the assessment object is in a relationship as shown in FIG. 68. Graph G showing the connections of the network that is the assessment object is therefore described as shown in, for example, range “a” shown in FIG. 69 and stored in setting model storage unit 34.

A user is next entered. FIG. 70 shows the relationship between the user and the hosts. In FIG. 70, nodes enclosed by squares with rounded corners represent users, nodes enclosed by ovals represent hosts, and the arrows between these nodes represent the affiliation relationships of the users to the hosts.

Using function “b” representing the hosts to which users belong, the relationships shown in FIG. 70 may be described as:

b(ftp)=SERVER2;
b(student)=SERVER1;
b(hanako)=SERVER1;
b(taro)=CLIENT.

The user of each host is created by the user settings and group settings of the OS. More specifically, in the case of Linux, the user settings are stored in the directory “/etc/passwd” while the group settings are stored in the directory “/etc/group.”

FIG. 71 shows a user setting of host SERVER1. From these settings it may be understood that the user “hanako” is present in host SERVER1. Thus, b(hanako)=SERVER1.

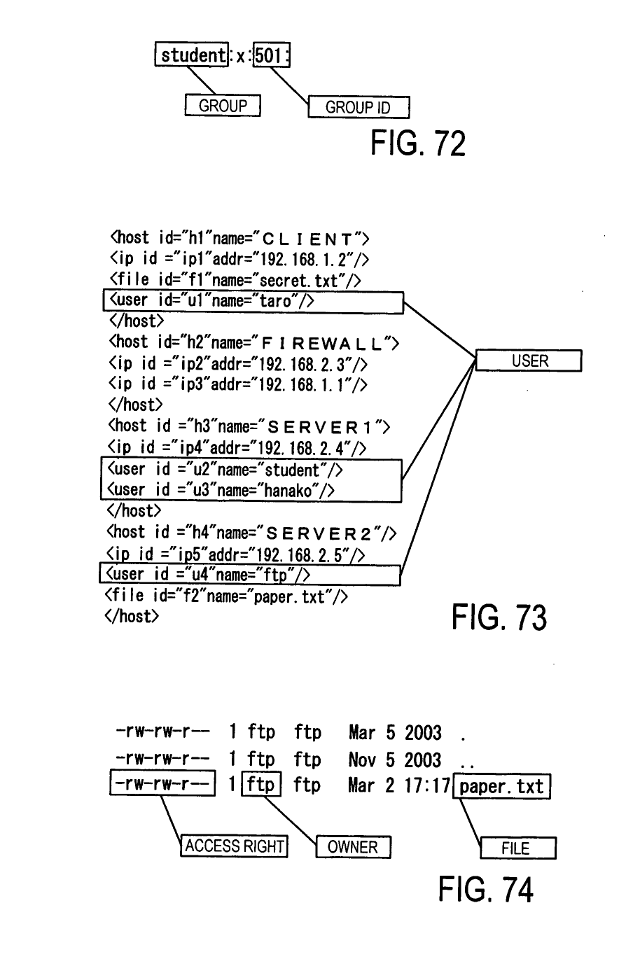

FIG. 72 shows a group setting of host SERVER1. From these settings, it may be understood that the group “student” is present in SERVER1. Since users and groups are both treated as users in a setting model, the group “student” is also treated as a user, and it may be understood that b(student)=SERVER1. The same holds true for the settings of the other hosts.

Users that are entered as described above are stored in setting model storage unit 34 together with the previously described four hosts and IP addresses thereof as shown in, for example, FIG. 73.

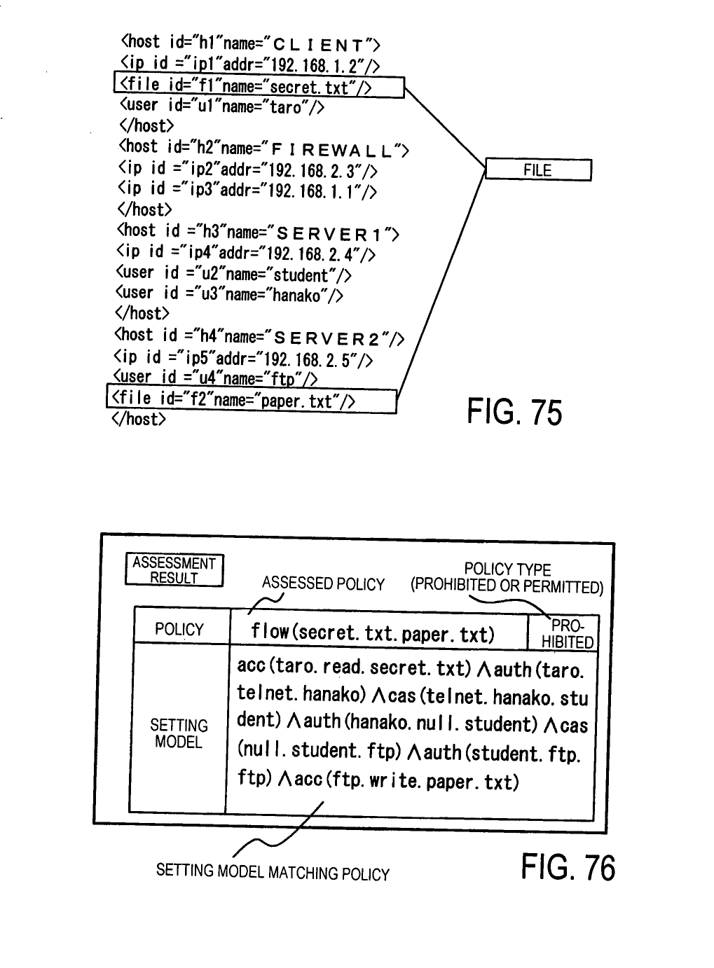

Files are next entered. The files of each host are created by referring to the file system of the OS. More specifically, in the case of Linux, a list of files may be obtained by executing the command “ls ?alr.” For example, a list of files that may be acquired on host SERVER2 is as shown in FIG. 74. From the file list, it is understood that file “paper.txt” exists in host SERVER2. Thus, b(paper.txt)=SERVER2. The same holds true for the other hosts. Files that have been entered as described above are stored together with the previously described four hosts, host IP addresses, and users in setting model storage unit 34 as shown in, for example, FIG. 75.

Next, network access expressions are entered. In the assessment object system, packet filtering is implemented in host FIREWALL. For example, assume that communication is permitted from any port number of transmission source IP address 192.168.1.2 to port number 80 of transmission destination IP address 192.198.2.4. The setting of a network access expression n(192.168.2.3, 192.168.1.2, 192.168.2.4, 80) may be created from this information and the IP address at which filtering is performed. The network access expression that is thus entered is described as shown in, for example, range “b” of FIG. 69, and stored in setting model storage unit 34.

Next, access control matrix expressions of files are entered. An “access control matrix expression” is an expression of the presence or absence of a user's access authority to a file. Two types of access authorities exist, namely, “read,” which represents the authority to read a file, and “write,” which represents the authority to write a file. For example, as shown in FIG. 74, the owners and the authorities with respect to the respective files may be understood from the output result of the command “ls ?alr.” In the list shown in FIG. 74, user “ftp” is granted the “read” authority and “write” authority to the file “paper.txt.” Based on this information, the access control matrix expression “acc(ftp, read, paper.txt), acc(ftp, write, paper.txt)” may be described. The file access control matrix expression that has been entered in this manner is described as shown in range “e” of FIG. 69 and stored in setting model storage unit 34.

Next, a type of authority acquisition that may be performed through the use of a service, that is, authority acquisition relationship is next entered. An “authority acquisition” represents the ability of one user to use a service to acquire the authority of another user. An authority acquisition is created unconditionally when one user retains information necessary for authentication such as another user's ID or password, or when authority may be acquired without undergoing special authentication. More specifically, authority acquisition may be created by investigating a network service that is executed on a host, and relevant settings thereof.

In this example, it is assumed that a service “telnet” is provided on SERVER1, and that a user “taro” of host CLIENT knows the password to access a user “hanako” on host SERVER1 by the service “telnet.” It is further assumed in this example that an anonymous FTP service is offered on host SERVER2, and that users belonging to a group “student” on host SERVER1 can use the service “ftp” unconditionally. In this case, user “taro” of host CLIENT can acquire the authority of user “hanako” of host SERVER1 by means of the service “telnet.” Therefore, the authority acquisition relationship may be expressed as auth(taro, telnet, hanako). In addition, user “student” of host SERVER1 may unconditionally acquire the authority of user “ftp” of host SERVER2 through service “ftp.” Therefore, the authority acquisition relationship may be expressed as auth(student, ftp, ftp).

A service “null” represents the affiliation of a user to a group. In the case of Linux, an authority acquisition relationship using service “null” may be created from a user setting file shown in FIG. 71 and a group setting file shown in FIG. 72. More specifically, based on the user setting file shown in FIG. 71, the group ID of user “hanako” is “501”; and the group for which the group ID is “501” in the group setting file shown in FIG. 72 is “student.” From this information, it may be understood that user “hanako” belongs to the group “student.” Thus, auth(hanako, null, student) may be created as an authority acquisition relationship.

The authority acquisition relationship that is thus entered is described as shown in range “c” of FIG. 69 and stored in setting model storage unit 34.

Next, cascade relationships are entered. A “cascade relationship” represents the types of services that may be used one after another when a particular service is used to acquire authority. This relationship is determined by the type of service. More specifically, this relationship is determined in advance according to the type of service, such that, for example, the service “ftp” may be used once authority has been acquired through the service “telnet,” but the service “telnet” cannot be used even after acquiring authority through the service “ftp.” In addition, the types of authority that may be used are determined according to whether the relevant service has been installed in a host, or according to whether a user that has acquired authority has the authority to execute the service. In this example, when the authority of the user “hanako” of host SERVER1 has been acquired through the service “telnet,” the service “null” may be used. Thus, cas (telnet, hanako, null) is obtained as a cascade relationship. When the service “null” is used to acquire the authority of user “student” of host SERVER1, the service “ftp” may be used. Thus, cas(null, student, ftp) is obtained as a cascade relationship.

A cascade relationship that has been thus entered is described as shown in range “d” of FIG. 69 and stored in setting model storage unit 34.

Furthermore, the port number of the network used by the service is entered as shown in range “f” of FIG. 69. In the case of Linux, the correspondence between the names of services and port numbers may be inspected by referencing the file “/etc/services.”

In this manner, a setting model (refer to FIG. 69) including the system configuration of the assessment object system (for example, see FIG. 75) is thus constructed in setting model storage unit 34 through the inputting and successive storage of the various types of information which compose a setting model. In other words, a setting model is entered to setting model storage unit 34.

In step S302, security assessment policies are next entered through policy input unit 10. The security assessment policy given in this example is assumed to be policy “flow(secret.txt, paper.txt).” This policy “flow(secret.txt, paper.txt)” is a prohibition policy representing that there must be no migration of data from secret.txt to paper.txt, and that the contents of secret.txt must not be written to paper.txt.

Using the setting model and policy that have been entered as described above, assessment unit 50a performs processing for assessing whether a model that matches the policy exists in step S303.

Assessment unit 50a may be realized by using a Prolog interpreter, which is a well-known language processor. In this case, among the respective predicates in the policy description, “acc”, “auth”, and “cas” are implemented as built-in predicates.

The contents of the implementation of each of the built-in predicates are as follows:

acc(U, S, F): “true when (U, S, F) is included in the access control matrix expression in the setting model storage unit”;

cas(S1, U, S2): “true when (S1, U, S2) is included in a cascade relationship in the setting model storage unit”;

auth(U1, S, U2): “true when (U1, S, U2) is included in the authority acquisition relationship in the setting model storage unit, and at the same time, when a connection may be established to the port realizing service S on U2 from the host to which U1 belongs to the host to which U2 belongs.”

In this case, the judgment of whether a connection may be established to the port for realizing service “S” on user “U2” from the host to which user “U1” belongs to the host to which user “U2” belongs may be performed by examining whether there is a path in a network connection expression stored as a setting model in setting model storage unit 34 that connects from the host to which user “U1” belongs to the host to which user “U2” belongs, and at the same time, whether the relevant port in this path is permitted by the network access expression stored as a setting model in setting model storage unit 34.

In addition, the predicate “flow” expressing the data flow relationship may be described by a Prolog program such as:

flow(F, F) :-true.
flow(F1, F2) :-flow2(F1, F3), flow(F3, F2).
flow2(F1, F2) :-acc(U1, read, F1), auth2(U3, S1, U1), auth2(U3, S2,

U2), acc(U2, write, F2).

auth2(U, S, U) :-true.
auth2(U3, S1, U1) :-auth(U3, S1, U2), cas(S1, U2, S2), auth2(U2,

S2, U1).

Accordingly, the above-described Prolog program on the Prolog processor provided with the above-described built-in predicates will be able to judge whether the policy described by policy input unit 10 matches a setting model.

The adoption of a configuration that uses assessment unit 50a provided with the functions explained above enables judgment of whether the policy “flow(secret.txt, paper.txt)” matches with the setting model stored in setting model storage unit 34.

In the case of the setting model described in this example, it is found that the setting model matches with the policy “flow(secret.txt, paper.txt).”

In this example, it is assumed that the matching permission policy is displayed by assessment result display unit 60. More specifically, the assessed policy is displayed and presented to the assessor as shown in FIG. 76. In addition, as shown in FIG. 76, the type of policy shows whether the policy is indicating a path that must not exist or a path that must exist. In other words, the type of policy communicates whether the policy is a prohibition policy or a permission policy. Furthermore, when a matching prohibition policy is displayed as shown in FIG. 76, the setting model that matches paths that must not exist which are indicated by this prohibition policy may be displayed together with the prohibition policy.

When accompanying information such as descriptions of the policies is stored in policy storage unit 33, the accompanying information such as an explanatory text may also be displayed together with the policy.

As described above, a configuration is adopted in which the system configuration and settings are applied as a setting model, policies that show flow that does not conform or flow that is necessary are used to search the model, and the policies and model then displayed, whereby an assessor, relying on the displayed policies and model, is able to review the settings and may therefore discover and remedy setting errors in which the settings of a plurality of hosts or programs have composite relationships.

### Example 5

Next, a specific example of the security assessment data generation system according to the first embodiment, which is shown in FIG. 16, will be described.

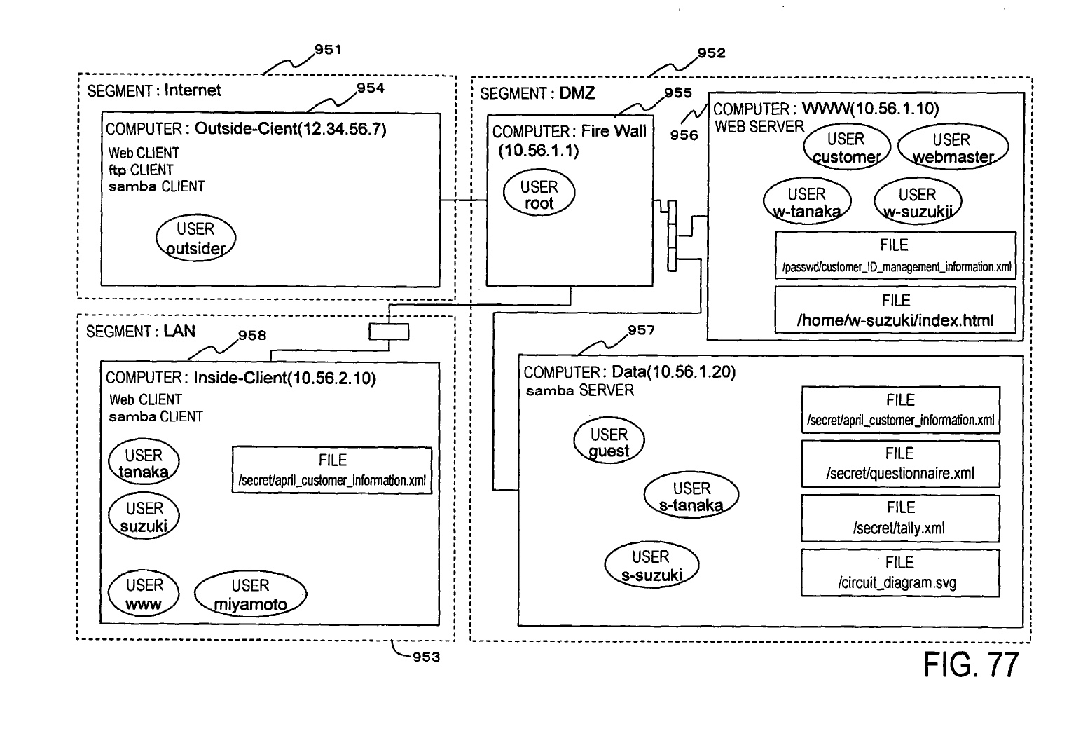

FIG. 77 shows an exemplary configuration of a computer system that is an assessment object. The dashed squares shown in FIG. 77 represent segments (network segments). In this case, there are three segments, namely, Internet segment 951, DMZ (DeMilitarized Zone) segment 952, and LAN segment 953. Additionally, in FIG. 77, hosts are represented by solid squares. A host exists for each segment. Internet segment 951 is provided with Outside-Client host 954 having an IP address of 12.34.56.7. DMZ segment 952 is provided with Fire Wall host 955 having an IP address of 10.56.1.1, WWW host 956 having an IP address of 10.56.1.10, and Data host 957 having an IP address of 10.56.1.20. LAN segment 953 is provided with Inside-Client host 958 having an IP address of 10.56.2.10.

Respective client applications of Web, ftp and samba are running on Outside-Client host 954, and the Outside-Client host 954 has an outsider user. Fire Wall host 955 has a root user. At WWW host 956, a Web server is running, users w-tanaka, w-suzuki, customer and webmaster respectively exist, and files “passwd/customer_ID_management_information.xml” and “/home/w-suzuki/index.html” exist. At Data host 957, samba server is running, users guest, s-tanaka and s-suzuki respectively exist, and files “/secret/april_customer_information.xml”, “/secret/questionnaire.xml”, “/secret/tally.xml” and “/circuit_diagram.svg” exist. At Inside-Client host 958, Web client and samba client are running, users tanaka, suzuki, miyamoto and www respectively exist, and file “/secret/april_customer_information.xml” exists.

System configuration information collection unit 1402 of the security assessment data generation system shown in FIG. 16 collects system configuration information from the computer system exemplified in FIG. 77. Attribute information is entered to attribute information input unit 1403, whereby attribute information input unit 1403 adds the attribute information to the system configuration information, and stores the information in attribute information storage unit 1404. When accepting input of attribute information, for instance, system configuration information may be presented to an administrator or an operator from a display device (not shown) to accept attribute information entered by the administrator or the operator.

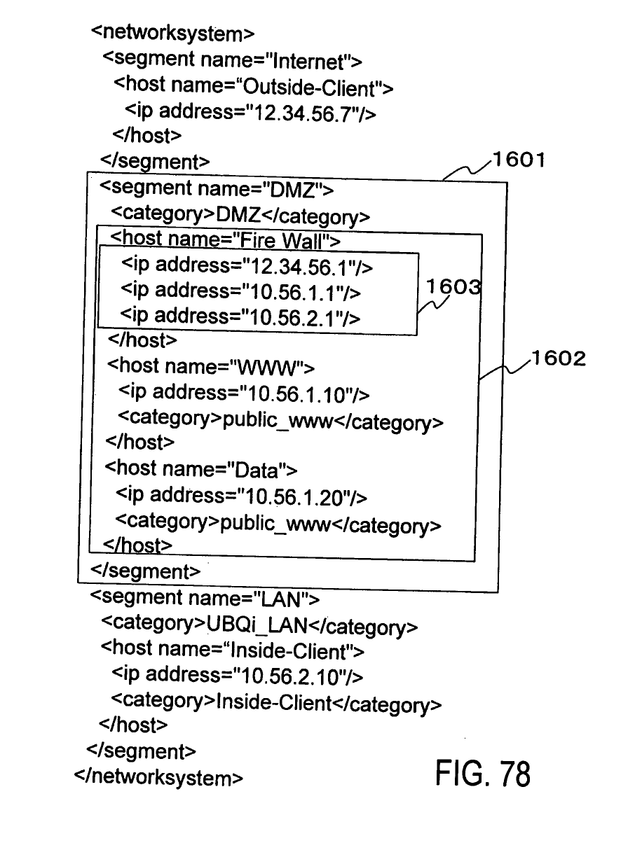

FIG. 78 shows an example of system configuration information to which network configuration information attributes have been added, that is, network configuration information. In this example, a plurality of (in this case, three) “segment” elements are described within a “networksystem” element. Description 1601 indicates one of the “segment” elements or, more specifically, an element of the DMZ segment. To describe description 1601 as an example, for the “segment” element, the name of the segment (in this example, “DMZ”) is described as a name attribute of the network configuration information attribute. In addition, information on hosts belonging to the segment is stored in the “segment” element. Information of each host is described as a “host” element enclosed by host tags. Description 1602 indicates three “host” elements. As a name attribute, the name of each host (in this example, “Fire Wall”, “WWW” and “Data”) is described in each “host” element. As shown in description 1603, an IP address of each host is described in each “host” element as an address attribute of “ip” element. Since description 1603 relates to the host Fire Wall, description 1603 includes the three IP addresses retained by this host.

In FIG. 78, the description enclosed by the category tags, that is, the “category” element represents attribute information indicating network segment function information of the segment or function information of the host. “<category>DMZ</category>” in the shown example is attribute information indicating that the function of the segment is “DMZ.” In addition, “<category>public_www</category>” is attribute information (host configuration information attribute) indicating that the function of the host is “public_www.”

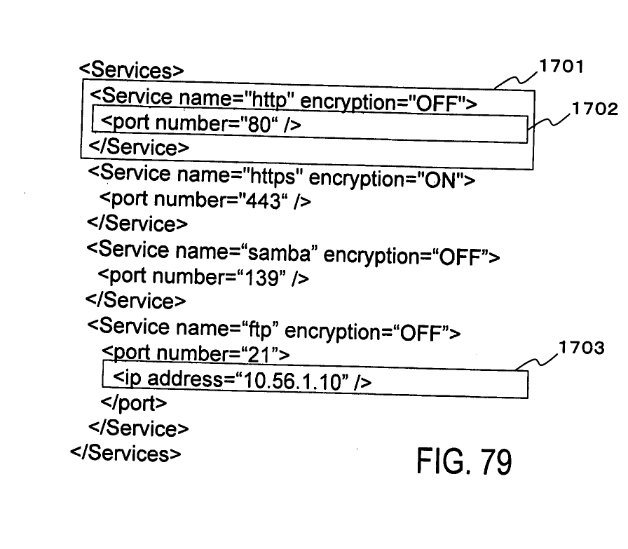

FIG. 79 shows an example of system configuration information to which a service information attribute has been added, that is, service information. In this example, service information attributes are managed by service name in the “Service” element. Here, “Service” element will be described using description 1701 that is a description of the “Service” element of http service as an example. In the “Service” element, the presence or absence of encryption is described as an encryption attribute. In description 1701, the encryption attribute is described as “OFF.” Incidentally, an encryption attribute of “OFF” indicates that encryption will not be performed, while an encryption attribute of “ON” indicates that encryption will be performed. In addition, each “Service” element includes an “port” element as attribute information. A port number used by an object service is described in the “port” element. For instance, a port number “80” is described in description 1702 of the “port” element included in description 1701. This means that http service uses TCP port 80. Furthermore, when service is performed at a specific port only at specific hosts, there are cases where an IP address will be described in the “port” element instead of a port number, as shown by description 1703.

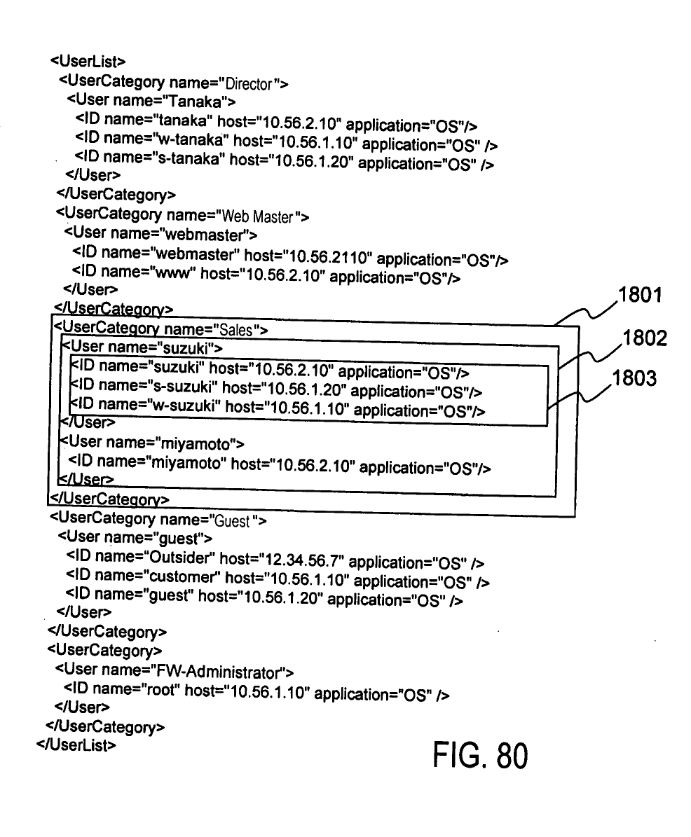

FIG. 80 shows an example of system configuration information to which a user information attribute has been added, that is, user information. In this example, a “UserCategory” element is described for every user function within a “UserList” element. Description 1801 represents one of the “UserCategory” elements. A function of the user is described in the name attribute of a “UserCategory” element. For instance, for the name attribute of the “UserCategory” element of the description 1801, “sales” is described as a function of the user. In addition, in each “UserCategory” element, a user corresponding to the function indicated by the name attribute of the “UserCategory” element is respectively described as a “User” element. For instance, in description 1802 in the “UserCategory” element of description 1801, two “User” elements of users responsible for “sales” are described. A name of a user is described in the name attribute of a “User” element. With the two “User” elements included in description 1802, “suzuki” and “miyamoto” are respectively described as name attributes. In addition, as shown in description 1803, in an “User” element, a user account of the user is described as an “ID” element. With the “ID” element exemplified in FIG. 80, a name of a user account is described in the name attribute of the “ID” element, a host in which the user account is registered is described in the host attribute of the “ID” element, and an application that manages the user account is described in the application attribute. For instance, with the first “ID” element of the description 1803, the name, host and application attributes are respectively described as “suzuki”, “10.56.2.10” and “OS.” Furthermore, the system configuration information (user information) shown in FIG. 21 corresponds to the description portion of the “ID” element. Therefore, in FIG. 80, the description portion of the “ID” element corresponds to system configuration information (user information), while the other description portions thereof, such as function information indicating a function such as “sales” or the name attribute in a “User” element correspond to an user information attribute to be added to user information.

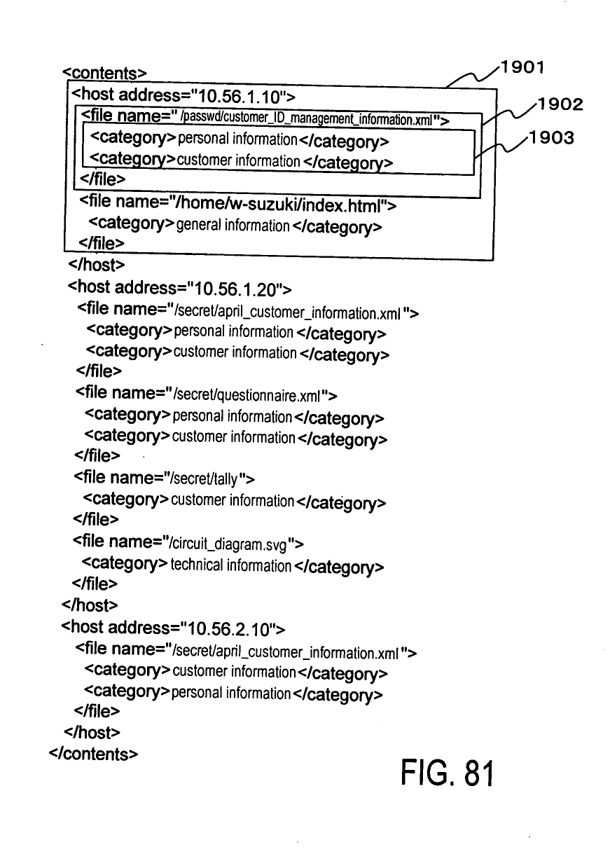

FIG. 81 shows an example of system configuration information to which a file information attribute has been added, that is, file information. In this example, in the “contents” element, file information attributes are described for each host in which a file is stored or, more specifically, for each “host” element. For instance, in description 1901, a file information attribute of a file stored in a single host is described. In a “host” element, as shown in description 1902, a “file” element is described for each file. A storage location of a file and a file name are described in the name attribute of a “file” element. The storage location of a file and the file name corresponds to file information while other descriptions correspond to file information attributes. For instance, in description 1902, the description “/passwd/customer_ID_management_information.xml” corresponds to file information (system configuration information), and the other description portions correspond to file information attributes. In addition, in a “file” element, file information attributes representing the contents, function or type of the file are described as “category” elements. For instance, in the two “category” elements included in description 1903, a file type and a file function of “individual information”, “customer information” are indicated.

Since the configuration of the security assessment data generation system according to this example is similar to that of the security assessment data generation system shown in FIG. 16, access policy generation unit 1405 is provided. Access policy generation unit 1405 creates an access policy using attribute information added to system configuration information. Access policy generation unit 1405 may create an access policy by entering and using information that directly indicates a “migration source”, a “migration destination”, and a “migration path”, instead of using attribute information.

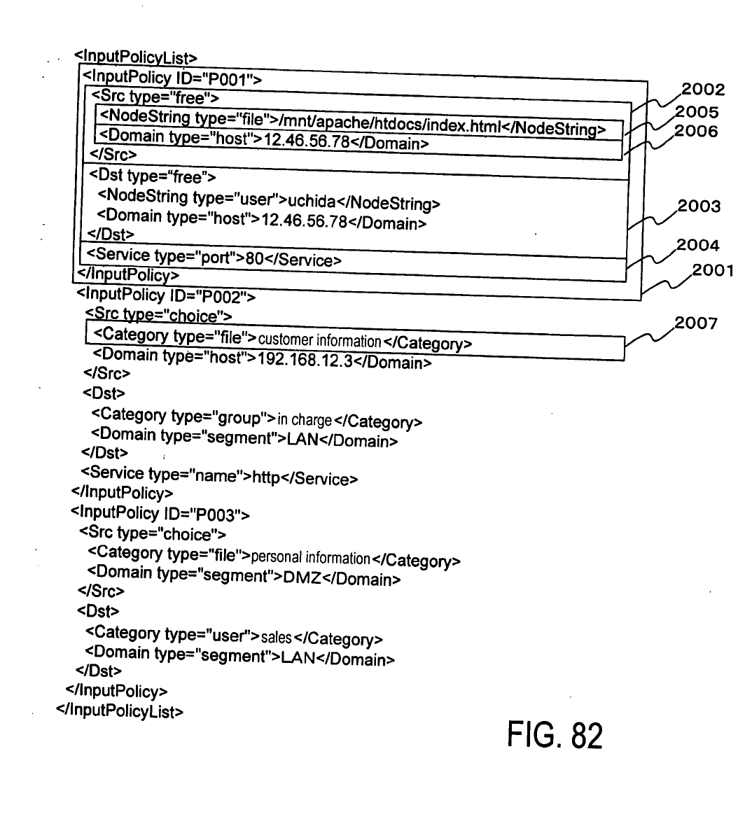

FIG. 82 shows an example of an access policy created by access policy generation unit 1405. In this example, the access policy is created and managed as a file. As shown in FIG. 82, an access policy is described in a range enclosed by InputPolicyList tags. In addition, individual access policies are described as “InputPolicy” elements in the range enclosed by InputPolicyList tags. As shown, a plurality of “InputPolicy” elements, that is, descriptions enclosed by InputPolicy tags may exist. In a single “InputPolicy” element, a migration source is described as a “Src” element, a migration destination is described as a “Dst” element, and a migration path is described as a “Service” element. In the example shown, “InputPolicy” element 2001 includes “Src” element 2002 indicating a migration source, “Dst” element 2003 indicating a migration destination, and “Service” element 2004 indicating a migration path.

“NodeString” elements and “Domain” elements are described in the “Src” and “Dst” elements. In the example shown in FIG. 82, “NodeString” element 2005 and “Domain” element 2006 are included in “Src” element 2002. In the “NodeString” element, information directly specified by the operator is described upon creation of the access policy. Information directly specified by the operator refers not to information that has been selected from information presented as candidates, but instead to information specified by the operator in a state where no candidates have been presented. For instance, with “NodeString” element 2005, a file storage location and a file name of “/mnt/apache/htdocs/index.html” is described as a migration source directly specified by the operator. In addition, a domain is described in a “Domain” element. When creating an access policy, in the event that selection candidates of attribute information are presented to the operator and attribute information is selected from the candidates by the operator, the “Src” element or “Dst” element includes a “Category” element instead of a “NodeString” element. For instance, the second “InputPolicy” element shown in FIG. 82 includes “Category” element 2007. “Category” element 2007 indicates “customer information” that is attribute information selected from the attribute information of the transmission source.

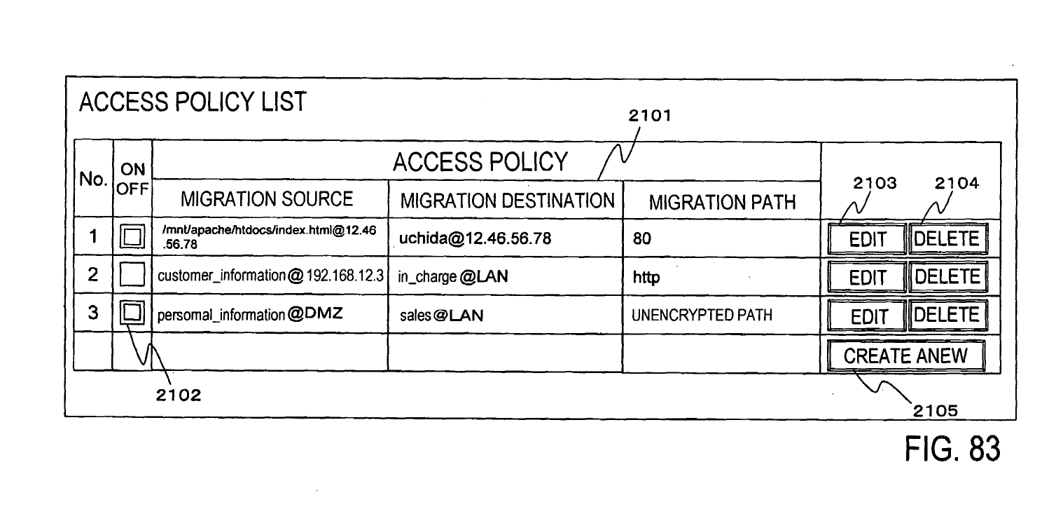

Next, a description will be provided on a user interface presented by access policy generation unit 1405 to the operator when creating an access policy, that is, in step S603 shown in FIG. 22. FIG. 83 shows an example of an initial screen that is presented to the operator when creating an access policy.

When creating an access policy, access policy generation unit 1405 first displays the initial screen exemplified in FIG. 83 on a display device (not shown). Access policy generation unit 1405 displays an access policy that has already been created in access policy display field 2101 in the initial screen. Alternatively, as an recommended access policy, an access policy set as default may be displayed in access policy display field 2101. Access policy generation unit 1405 displays radio box 2102, editing button 2103 and delete button 2104 so as to correspond to respective access policies displayed in access policy display field 2101. Radio box 2102 is used to specify whether an access policy corresponding to the radio box will be enabled or disabled. For instance, when editing button 2103 is operated by a mouse click or the like, access policy generation unit 1405 displays an editing screen of an access policy corresponding to the operated editing button on the display device. In addition, when the delete button 2104 is operated, access policy generation unit 1405 deletes an access policy corresponding to the operated delete button. Furthermore, access policy generation unit 1405 displays newly create button 2105 in the initial screen. When newly create button 2105 is operated, access policy generation unit 1405 displays an access policy newly create screen on the display device. Incidentally, as for the editing screen, a screen having the same user interface as the access policy newly create screen and which prompts the operator to perform editing will suffice.

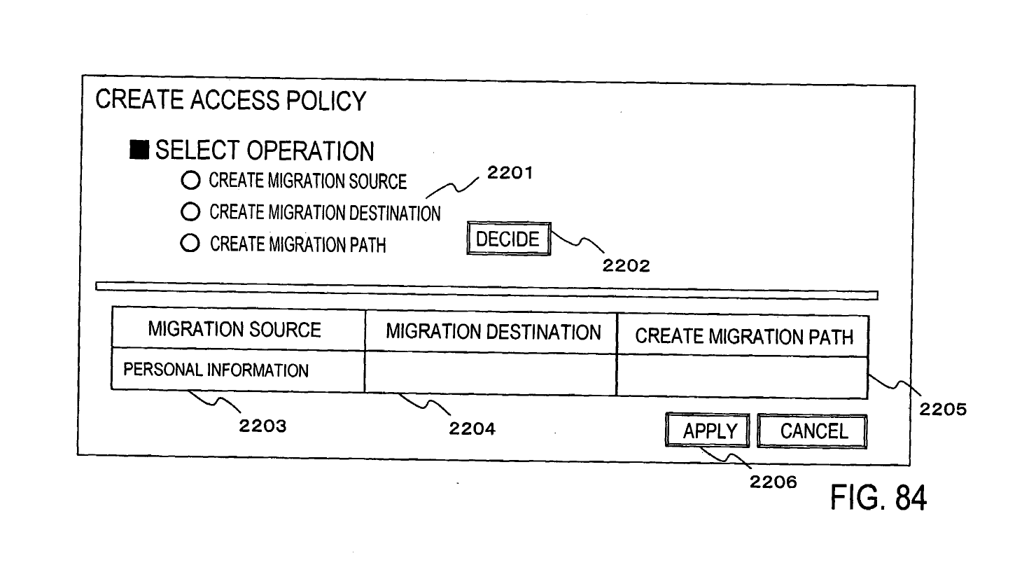

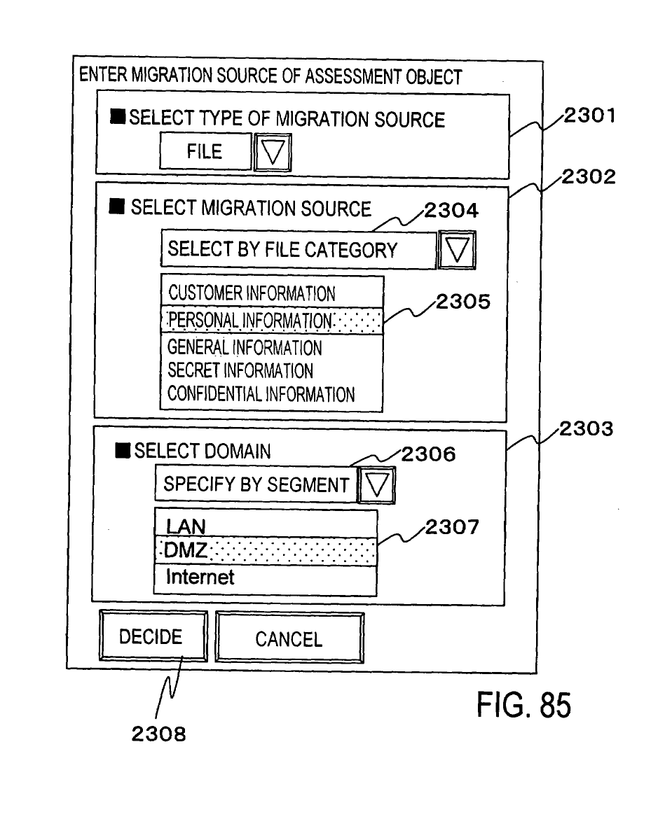

FIG. 84 shows an example of an access policy newly create screen. In the access policy newly create screen, access policy generation unit 1405 displays screen option 2201, decision button 2202, migration source input field 2203, migration destination input field 2204, migration path input field 2205 and apply button 2206. Screen option 2201 is a display of options that prompt the operator to select any one of a migration source input screen, a migration destination input screen and a migration path input screen. When a selection by the operator is performed at screen option 2201 and the decision button 2202 is operated, access policy generation unit 1405 displays a migration source input screen, a migration destination input screen or a migration path input screen according to the selection result of the operator. In other words, the migration source input screen is displayed when “create a migration source” has been selected, the migration destination input screen is displayed when “create a migration destination” has been selected, and a migration path input screen is displayed when “create a migration path” has been selected. While information regarding a migration source, a migration destination and a migration path are respectively arranged to be specified in the migration source input screen, the migration destination input screen and the migration path input screen, the respective screens will be described later with reference to FIGS. 85 to 87.

In addition, in a case where the operator has prior knowledge about input values of the respective items of migration source, migration destination and migration path, the operator may use an input device such as a keyboard to directly enter such input values to migration source input field 2203, migration destination input field 2204 and migration path input field 2205. Values to be entered to migration source input field 2203, migration destination input field 2204 and migration path input field 2205 are input values that are specified by the operator in a state where selection candidates are not presented, that is, input values directly specified by the operator.

When apply button 2206 is operated, access policy generation unit 1405 creates an access policy exemplified in FIG. 82 based on information on migration source, migration destination and migration path specified through the migration source input screen, the migration destination input screen and the migration path input screen, and information entered to migration source input field 2203, migration destination input field 2204 and migration path input field 2205. Then, access policy generation unit 1405 once again displays the initial screen (refer to FIG. 83) shown in FIG. 83.

FIG. 85 shows an example of a migration source input screen. In the migration source input screen, access policy generation unit 1405 displays migration source type selection field 2301, migration source selection field 2302, domain selection field 2303 and decision button 2308.

Migration source type selection field 2301 prompts the operator to select either a file or a user as an information migration source. In the example shown in FIG. 85, a file has been selected as a migration source from a pull down menu.

In this case, access policy generation unit 1405 displays migration source specification method selection field 2304 and option display field 2305 in migration source selection field 2302. Migration source specification method selection field 2304 prompts the operator to decide whether a file name, a user name or the like will be specified without using attribute information, or whether attribute information will be specified. In this example, migration source specification method selection field 2304 is realized by the pull down menu. When “file” has been specified in migration source type selection field 2301, migration source specification method selection field 2304 prompts the operator to select any one of the specification methods of, for instance, “select by file category”, “select by directory” and “select by file.” In addition, when “user” has been specified in migration source type selection field 2301, migration source specification method selection field 2304 prompts the operator to select any one of the specification methods of “select by user category” and “select by user name.”

Furthermore, access policy generation unit 1405 displays, in option display field 2305, options corresponding to the specification method selected at migration source specification method selection field 2304, and prompts the operator to select one of the items from the options. In the example shown in FIG. 85, since the specification method of “select by file category” has been selected, access policy generation unit 1405 has displayed the file information attributes of “customer information”, “personal information”, “general information”, “secret information” and “confidential information” as options in option display field 2305. In this example, “personal information” has been selected at option display field 2305. When the specification method of “specify by directory” or “specify by file” has been selected at migration source specification method selection field 2304, access policy generation unit 1405 displays directory names or file names in option display field 2305 and prompts the operator to select a directory name or a file name. Incidentally, directory names and file names are not deemed attribute information. When the specification method of “select by user category” has been selected at migration source specification method selection field 2304, access policy generation unit 1405 displays user information attributes such as, for instance, “director”, “manager”, “regular employee”, “Web master” and “sales” in option display field 2305 as options, and prompts the operator to select an user information attribute. When the specification method of “specify by user name” has been selected at migration source specification method selection field 2304, access policy generation unit 1405 displays user names in option display field 2305 and prompts the operator to select a user name. Incidentally, user names are also not deemed attribute information.

In addition, access policy generation unit 1405 displays domain specification method selection field 2306 and domain option display field 2305 in domain selection field 2303. Domain specification method selection field 2306 prompts the operator to select, for instance, whether a segment or a host is to be specified as a domain. In the shown example, domain specification method selection field 2306 is realized by a pull down menu. Domain specification method selection field 2306 prompts the operator to select any one of the specification methods of, for instance, “specify by segment”, “specify by host” and “no domains specified.”

Access policy generation unit 1405 displays options corresponding to the specification method selected in domain specification method selection field 2306 in domain option display field 2307, and prompts the operator to select one of the items from the options. In the example shown in FIG. 85, since the specification method of “select by segment” has been selected, access policy generation unit 1405 has displayed the segment names of “LAN”, “DMZ” and “Internet” which are included in network configuration information attributes as options in domain option display field 2307. In this example, “DMZ” has been selected therefrom. As options of “LAN”, “DMZ” and “Internet” and the like, access policy generation unit 1405 may display name attribute (refer to FIG. 78) of a “segment” element which is attribute information added to network configuration information. When the specification method of “specify by host” has been selected at domain specification method selection field 2306, access policy generation unit 1405 displays hosts in domain option display field 2307, and prompts the operator to select a host. Incidentally, hosts selected in this case are not deemed attribute information. In addition, when the specification method of “no domains specified” has been selected at domain specification method selection field 2306, access policy generation unit 1405 need not display domain option display field 2307.

When decision button 2308 is operated, access policy generation unit 1405 finalizes contents specified by the operator in migration source type selection field 2301, migration source selection field 2302 and domain selection field 2303, and displays the access policy newly create screen (refer to FIG. 84). In the example shown in FIG. 85, access policy generation unit 1405 finalizes specification of the “personal information” file in the “DMZ” segment as the migration source.

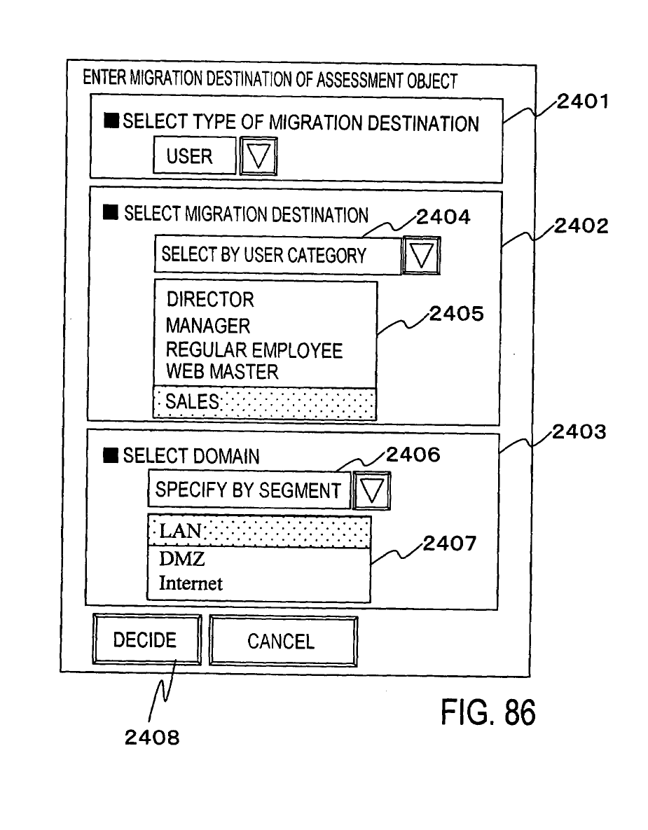

FIG. 86 shows an example of a migration destination input screen. In the migration destination input screen, access policy generation unit 1405 displays migration destination type selection field 2401, migration destination selection field 2402, domain selection field 2403 and decision button 2408. The screen configuration of the migration destination input screen is similar to the screen configuration of the migration source input screen. In the same manner as migration source selection field 2302 shown in FIG. 85, migration destination selection field 2402 includes migration destination specification method selection field 2404 and option display field 2405. In the same manner as domain selection field 2303 shown in FIG. 85, domain selection field 2403 includes domain specification method selection field 2406 and domain option display field 2407. Modes of selecting a type of migration destination, selecting a migration destination and specifying a domain in the migration destination input screen is similar to modes of selecting a type of migration source, selecting a migration source and specifying a domain in the migration source input screen.

When decision button 2408 is operated, access policy generation unit 1405 finalizes contents specified in migration destination type selection field 2401, migration destination selection field 2402 and domain selection field 2403, and displays the access policy newly create screen (refer to FIG. 84). In the example shown in FIG. 86, access policy generation unit 1405 finalizes specification of a “sales” user in the “LAN” segment as the migration destination.

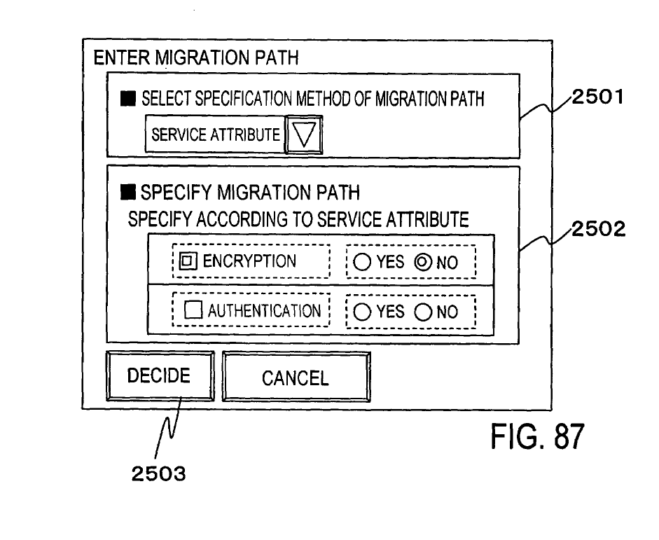

FIG. 87 shows an example of a migration path input screen. Access policy generation unit 1405 displays migration path specification method selection field 2501, migration path specification field 2502 and decision button 2503 in the migration path input screen.

Migration path specification method selection field 2501 prompts the operator to decide either a migration path will be specified according to service attributes or according to another method, such as service names or port numbers. In this case, migration path specification method selection field 2501 is realized by a pull down menu. Migration path specification method selection field 2501 displays, for instance, “service attribute”, “service name”, “port number” as selection candidates. FIG. 86 shows a case where “service attribute” has been selected.

Access policy generation unit 1405 displays migration path specification field 2502 corresponding to the specification method selected in migration path specification method selection field 2501. In the example shown in FIG. 86, as a result of selection of “service attribute”, access policy generation unit 1405 has displayed a field for specifying a migration path according to service attributes such as “presence or absence of encryption” or “presence or absence of authentication.” In this case, a migration path for which encryption will not be performed has been specified. When “service name” or “port number” has been selected in migration path specification method selection field 2501, access policy generation unit 1405 displays service names or port numbers in migration path specification field 2502 to prompt specification of a migration path according to a service name or a port number. Incidentally, service names or port numbers selected in this case are not deemed attribute information.

When decision button 2503 is operated, access policy generation unit 1405 finalizes contents specified in migration path type selection field 2501 and migration path selection field 2502, and displays the access policy newly create screen (refer to FIG. 84).

After finalization of the specification contents in the migration source input screen (refer to FIG. 85), migration destination input screen (refer to FIG. 86) and migration path input screen (refer to FIG. 87), when apply button 2206 in the access policy newly create screen shown in FIG. 84 is operated, access policy generation unit 1405 creates an access policy corresponding to the specification contents. Incidentally, when “no domains specified” is specified in domain specification method field 2306 in the migration source input screen, access policy generation unit 1405 will not create a “Domain” element in the “Src” element (refer to FIG. 82). In a similar manner, when “no domains specified” is specified in domain specification method selection field 2406 in the migration destination input screen, access policy generation unit 1405 will not create a “Domain” element in the “Dst” element (refer to FIG. 82).

Assume now that the specification contents exemplified in FIGS. 85 to 87 have been finalized, the access policy newly create screen shown in FIG. 84 is displayed, and subsequently, apply button 2206 (refer to FIG. 84) has been operated. In this case, access policy generation unit 1405 will create an access policy of “information may not be migrated using a path unprotected by encryption from the “personal information” file in the “DMZ” segment to “sales” personnel in the “LAN” segment.”

Next, a description will be provided on an operation in which assessment policy generation unit 1407 (refer to FIG. 16) converts an access policy created by access policy generation unit 1405 as described above into an assessment policy. Conversion of an access policy to an assessment policy is performed in the event that a migration source, a migration destination and a migration path of an access policy are specified using attributes by retrieving system components such as actual file names or user accounts based on the attributes, and representing a migration source, a migration destination and a migration path using the retrieved results. Conversion to an assessment policy may be divided into operations for: converting a user specified as a migration source or a migration destination using attribute information into a user account; converting a file specified as a migration source or a migration destination using attribute information into a file name; and converting a service specified as a migration path using attributes into an IP address or a port number. The three operations will be described below.

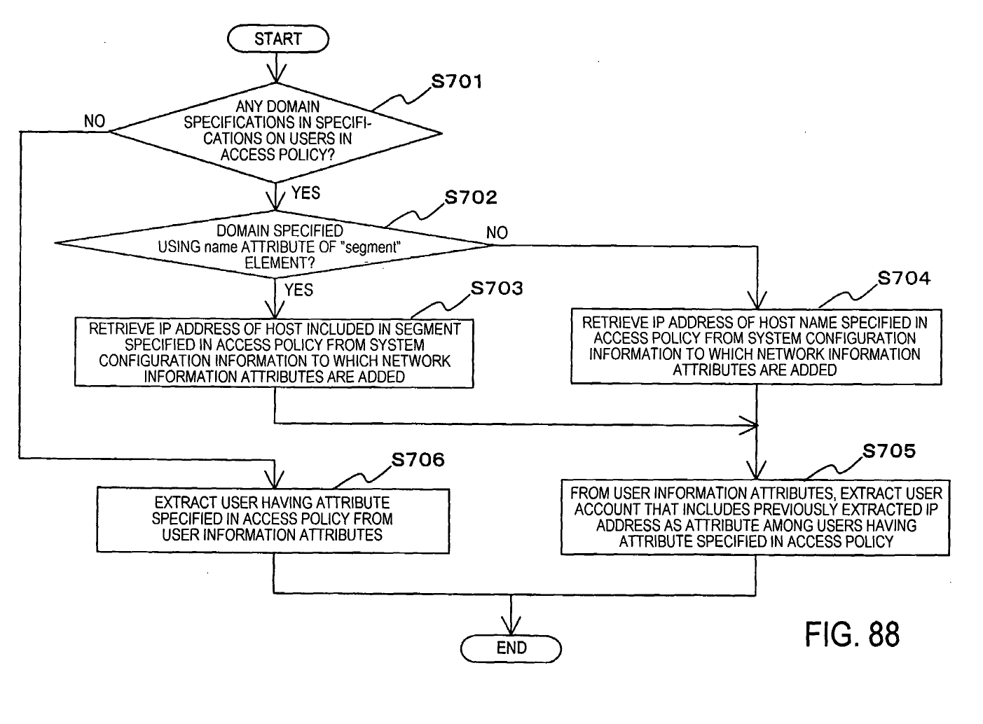

The flowchart shown in FIG. 88 represents operations for retrieving a user account converted from a user when the user is specified as a migration source or migration destination using attribute information. The operation is performed in step S605 or S607 in FIG. 22 described above.

First, in step S701, assessment policy generation unit 1407 judges whether a domain specification exists in a user specification of an access policy. In other words, assessment policy generation unit 1407 judges whether the “Src” element or the “Dst” element in the access policy representing a user includes a “Domain” element. Incidentally, a “Domain” element in the “Src” element or the “Dst” element is generated by the access policy generation unit when a domain is specified in domain selection field 2303 (refer to FIG. 85) or domain selection field 2403 (refer to FIG. 86).

When it is determined in step S701 that the “Src” element or the “Dst” element in the access policy representing a user includes a “Domain” element, in step S702, assessment policy generation unit 1407 judges whether the domain specification had been performed using a name attribute (refer to FIG. 78) of a “segment” element that is attribute information added to network configuration information. A case where domain specification had been performed using a name attribute of a “segment” element refers to a case where access policy generation unit 1405 displays name attributes of a “segment” element that is attribute information added to network configuration information as options in domain option display field 2307 (refer to FIG. 85) or domain option display field 2407 (refer to FIG. 86), and a domain is specified from the options.

When it is judged in step S702 that domain specification has been performed using a name attribute of a “segment” element, in step S703, assessment policy generation unit 1407 retrieves IP addresses of all hosts included in the segment specified as a domain upon creation of an access policy from system configuration information to which network configuration information attributes have been added, that is, from network configuration information shown in FIG. 78. On the other hand, when it is judged that domain specification has been performed without using a name attribute of a “segment” element, in step S704, assessment policy generation unit 1407 retrieves IP addresses of hosts specified as domains upon creation of an access policy from system configuration information to which network configuration information attributes have been added, that is, from network configuration information. After steps S703 and S704, the processing proceeds to step S705.

In step S705, assessment policy generation unit 1407 extracts a user account as described below. Assessment policy generation unit 1407 identifies a user having attribute information specified in migration source selection field 2302 (refer to FIG. 85) or migration destination selection field 2402 (refer to FIG. 86) upon creation of an access policy from user information (refer to FIG. 80) to which user information attributes have been added. Then, among user accounts of the user, a user account corresponding to the IP address retrieved in step S704 or S705 is extracted.

In step S701, when it is judged that the “Src” element or the “Dst” element in the access policy representing a user does not include a “Domain” element, in step S706, assessment policy generation unit 1407 extracts a user account of a user having attribute information specified in migration source selection field 2302 or migration destination selection field 2402 upon creation of an access policy from user information to which user information attributes have been added.

In this manner, assessment policy generation unit 1407 converts an access policy by replacing a user specified as a migration source or a migration destination using attribute information with a user account extracted in step S705 or S706. This processing is performed in step S605 or S607 in FIG. 22.

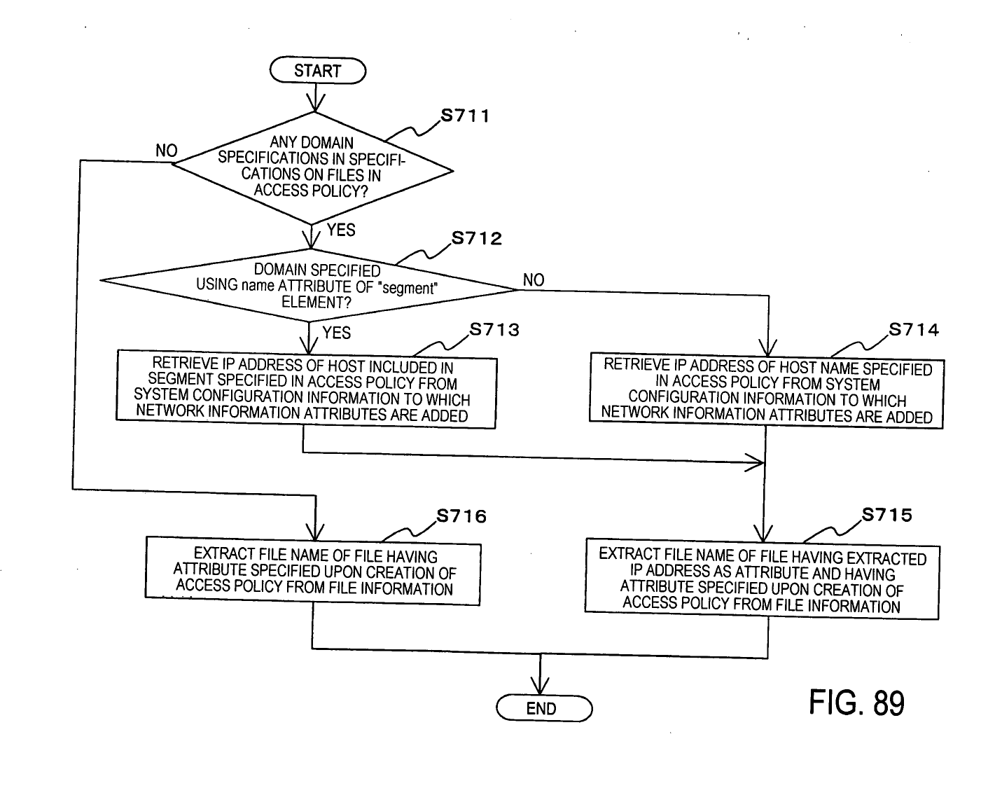

The flowchart shown in FIG. 89 represents operations for retrieving a file name converted from a file when the file is specified as a migration source or migration destination using attribute information. This operation corresponds to the processing of step S607 in FIG. 22 described above.

First, in step S711, assessment policy generation unit 1407 judges whether a domain specification exists in a file specification of an access policy. In other words, assessment policy generation unit 1407 judges whether the “Src” element or the “Dst” element in the access policy representing a file includes a “Domain” element. Incidentally, as described above, a “Domain” element in the “Src” element or the “Dst” element is generated by the access policy generation unit when a domain is specified in domain selection field 2303 or domain selection field 2403.

When it is determined that the “Src” element or the “Dst” element in the access policy representing a file includes a “Domain” element, in step S711, assessment policy generation unit 1407 judges whether the domain specification had been performed using a name attribute (refer to FIG. 78) of a “segment” element that is attribute information added to network configuration information. A case where domain specification had been performed using a name attribute of a “segment” element refers to a case where access policy generation unit 1405 displays name attributes of a “segment” element that is attribute information added to network configuration information as options in domain option display field 2307 (refer to FIG. 85) or domain option display field 2407 (refer to FIG. 86), and a domain is specified from the options.

When it is judged in step S712 that domain specification has been performed using a name attribute of a “segment” element, in step S713, assessment policy generation unit 1407 retrieves IP addresses of all hosts included in the segment specified as a domain upon creation of an access policy from system configuration information to which network configuration information attributes have been added, that is, from network configuration information (refer to FIG. 78). On the other hand, when it is judged that domain specification has been performed without using a name attribute of a “segment” element, in step S714, assessment policy generation unit 1407 retrieves IP addresses of hosts specified as domains upon creation of an access policy from system configuration information to which network configuration information attributes have been added, that is, from network configuration information. After steps S713 and S714, the processing proceeds to step S715.

In step S715, assessment policy generation unit 1407 extracts a file name as described below. Assessment policy generation unit 1407 identifies a host having the IP address retrieved in step S713 or S714 as an attribute from file information (refer to FIG. 81) to which file information attributes have been added. Then, among file names of files included in the host, a file name of a file having attribute information specified in migration source selection field 2302 (refer to FIG. 85) or migration destination selection field 2402 (refer to FIG. 86) upon creation of an access policy is extracted.

In step S711, when it is judged that the “Src” element or the “Dst” element in the access policy representing a file does not include a “Domain” element, in step S716, assessment policy generation unit 1407 extracts a file name of a file having attribute information specified in migration source selection field 2302 or migration destination selection field 2402 upon creation of an access policy from the file names of all files included in file information to which file information attributes have been added.

In this manner, assessment policy generation unit 1407 converts an access policy by replacing a file specified as a migration source or a migration destination using attribute information with a file name extracted in step S715 or S716. This processing is performed in step S610 in FIG. 22.

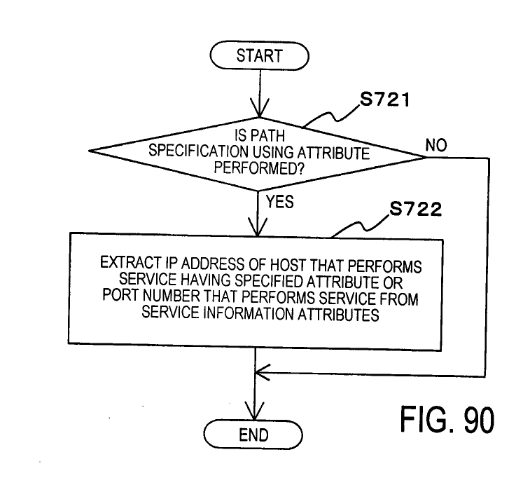

The flowchart shown in FIG. 90 represents operations for retrieving an IP address or a port number converted from a service when the service is specified as a migration path using attribute information. This operation corresponds to the processing in step S609 in FIG. 22 described above.

First, in step S721, assessment policy generation unit 1407 judges whether specification of a migration path has been performed using attribute information. For instance, as exemplified in FIG. 86, access policy generation unit 1405 displays specification field 2502 for specifying a migration path according to service attributes such as “presence or absence of encryption” or “presence or absence of authentication”, and judges whether a migration path has been specified in specification field 2502. If specification of a migration path has not been performed using attribute information, processing is concluded. In a case where specification of a migration path has been performed using attribute information, in step S722, assessment policy generation unit 1407 retrieves an IP address or a port number having attribute information used for specifying the migration path from system configuration information to which service information attributes have been added, that is, service information (refer to FIG. 79).

Subsequently, assessment policy generation unit 1407 converts an access policy by replacing a service specified as a migration path using attribute information with an IP address or a port number extracted in step S722. This processing is performed in step S610 in FIG. 22 described above.

Next, using a specific example, the procedure of converting an access policy created based on specification contents exemplified in FIGS. 85, 86 and 87 to an assessment policy will be described. In the specification contents shown in FIG. 85, the “personal information” file of the “DMZ” segment has been selected as a migration source. At this point, assessment policy generation unit 1407 extracts a “segment” element having a name attribute of “DMZ” from network configuration information attributes (refer to FIG. 78) stored in the attribute information storage unit. Information included in the extracted “segment” element is information related to the “DMZ” segment. Next, assessment policy generation unit 1407 extracts a list of IP addresses included in the extracted “segment” element. In this example, the IP addresses “12.34.56.1”, “10.56.1.1”, “10.56.2.1”, “10.56.1.10” and “10.56.1.20” are extracted.

Then, assessment policy generation unit 1407 extracts “personal information” files included in the hosts having the extracted IP addresses from the file information attributes (refer to FIG. 81). In other words, files which are included in “host” elements having the extracted IP addresses as address attributes and in which “personal information (attribute information specified in FIG. 85)” are described together with category tags are extracted. In this example, information having a file name of “/passwd/customer_ID_management_information.xml” included in a host having an IP address of “10.56.1.10”, and information having file names of “/secret/april_customer_information.xml” and “/secret/questionnaire.xml” which are included in a host having an IP address of “10.56.1.20” are extracted.

Assessment policy generation unit 1407 retrieves an intermediate path from an input of a migration path on a screen shown in FIG. 87. In the screen exemplified in FIG. 87, a path that is not protected by encryption has been specified. In this case, assessment policy generation unit 1407 retrieves a port number of a service that does not involve encryption from the service information attributes. In the service information attributes exemplified in FIG. 79, paths without encryption, that is, services for which “encryption=OFF” have been set are “http”, “samba” and “ftp.” The respective port numbers of these services are “port 80”, “port 139” and “port 21.”

Assessment policy generation unit 1407 retrieves a migration destination. In the screen exemplified in FIG. 86, a “sales” user in the “LAN” segment has been specified as a migration destination. In the same manner as migration destination retrieval, assessment policy generation unit 1407 first retrieves IP addresses of hosts belonging to the “LAN” segment from network configuration information attributes. In other words, IP addresses included in “segment” elements at which “LAN” has been set as the name attribute are retrieved. As a result, an IP address of “10.56.2.10” is retrieved. Assessment policy generation unit 1407 then retrieves an ID of a “sales” user corresponding to IP address “10.56.2.10” from user information (refer to FIG. 80) to which user information attribute has been added. As a result, an ID of “suzuki” is retrieved.

Next, assessment policy generation unit 1407 organizes the migration source, the migration destination and the migration path retrieved so far into an assessment policy. As a result, a path is obtained in which files “//10.56.1.10/passwd/customer_ID_management_information.xml”, “//10.56.1.20/secret/april_customer_information.xml” and “//10.56.1.20/secret/questionnaire.xml” are prohibited to pass port numbers “80” and “139”, which are unencrypted paths, to reach user “suzuki” at “10.56.2.10.” Expressing this as an assessment policy using the regular expression shown in Example 1, the following is obtained: F(“/passwd/customer_ID_management information.xml” @10.56.1.10) F(“/secret/april_customer_information.xml” @10.56.1.20) F(“/secret/questionnaire.xml” @10.56.1.20)].*[N(0.0.0.0-, 21, 0.0.0.0-, 0-) N(0.0.0.0-, 80, 0.0.0.0-, 0-) N(0.0.0.0-, 139, 0.0.0.0-, 0-)].*U(suzuki @10.56.2.10).

As described above, by using attribute information added to system configuration information, even when assessing complicated system configurations, assessment policies may be generated by entering simple access policies without having to manually write complicated assessment policies. As a result, even content administrators or ordinary users who do not possess special knowledge on an assessment object system may identify improper settings by creating an access policy for assessing whether their own contents are appropriately protected or are granted appropriate access rights, generating an assessment policy, and entering the same to assessment unit 1510 (refer to FIG. 23).

As described above, both the security assessment data generation system and the security assessment system may be realized by having a computer read a software program for expressing the respective functions of the systems and by executing the program. Therefore, it should be understood that such a program, a program product including such a program, and a storage medium storing such a program are also included in the scope of the present invention.

1. A security assessment data generation method of generating an assessment policy that is data to be inputted to a security assessment system that assesses a presence or absence of an improper setting indicating a composite error of security settings in an assessment object system, the method comprising the steps of:
collecting system configuration information including information regarding at least one of or a combination of a network, an application, a file, a service and a user of the assessment object system;
receiving attribute information that is added to said system configuration information and which indicates contents of attributes of at least one of or a combination of the network, the application, the file, the service and the user;
generating, using said attribute information, an access policy that includes information regarding at least one of or a combination of a migration source, a migration destination and a migration path of data with respect to an improper data migration path; and
generating an assessment policy describing the improper data migration path based on said access policy, said system configuration information and said attribute information.

2. The method according to claim 1, further comprising a step for assessing, using a data migration path that indicates data migration in said assessment object system and said assessment policy, whether the data migration path in said assessment object system is appropriate.

3. A security assessment data generation system for generating an assessment policy that is data to be inputted to a security assessment system that assesses a presence or absence of an improper setting that indicates a composite error of security settings in an assessment object system, the system comprising:
system configuration information collection means for collecting system configuration information including information regarding at least one of or a combination of a network, an application, a file, a service and a user of said assessment object system;
attribute information inputting means for receiving input of attribute information which is added to said system configuration information and which indicates contents of attributes of at least one of or a combination of the network, the application, the file, the service and the user;
access policy generation means for generating, using said attribute information, an access policy that includes information regarding at least one of or a combination of a migration source, a migration destination and a migration path of data with respect to an improper data migration path; and
assessment policy generation means for generating an assessment policy representing an improper data migration path based on said access policy generated by said access policy generation means, said system configuration information and said attribute information.

4. The system according to claim 3, wherein said attribute information inputting means is arranged so as to display the system configuration information collected by said system configuration information collection means and prompt an operator to enter said attribute information.

5. The system according to claim 3, wherein said access policy generation means is arranged so as to display said attribute information as options and prompt an operator to select said attribute information, and to specify said migration source, said migration destination or said migration path according to the selected attribute information.

6. The system according to claim 4, wherein said access policy generation means is arranged so as to display said attribute information as options and prompt the operator to select said attribute information, and to specify said migration source, said migration destination or said migration path according to the selected attribute information.

7. The system according to claim 3, wherein said assessment policy generation means is arranged so as to generate the assessment policy by replacing the information regarding the migration source, the migration destination or the migration path in the access policy specified using said attribute information with information included in said system configuration information or said attribute information.

8. The system according to claim 4, wherein said assessment policy generation means is arranged so as to generate the assessment policy by replacing the information regarding the migration source, the migration destination or the migration path in the access policy specified using said attribute information with information included in said system configuration information or said attribute information.

9. The system according to claim 5, wherein said assessment policy generation means is arranged so as to generate the assessment policy by replacing the information regarding the migration source, the migration destination or the migration path in the access policy specified using said attribute information with information included in said system configuration information or said attribute information.

10. The system according to claim 6, wherein said assessment policy generation means is arranged so as to generate the assessment policy by replacing the information regarding the migration source, the migration destination or the migration path in the access policy specified using said attribute information with information included in said system configuration information or said attribute information.

11. The system according to claim 3, further comprising assessment means for assessing, using a data migration path indicating data migration in said assessment object system and said assessment policy, whether the data migration path in said assessment object system is appropriate.

12. A security assessment data generation program to be installed in a computer that generates an assessment policy that is data to be inputted to a security assessment system that assesses a presence or absence of an improper setting indicating a composite error of security settings in an assessment object system, the program causing said computer to execute processing for:
collecting system configuration information including information regarding at least one of or a combination of a network, an application, a file, a service and a user of the assessment object system;
receiving attribute information that is added to said system configuration information and which indicates contents of attributes of at least one of or a combination of the network, the application, the file, the service and the user;
generating, using said attribute information, an access policy that includes information regarding at least one of or a combination of a migration source, a migration destination and a migration path with respect to an improper data migration path; and
generating an assessment policy describing the improper data migration path based on said access policy, said system configuration information and said attribute information.

13. The program according to claim 12, causing said computer to further execute processing for assessing, using a data migration path indicating data migration in said assessment object system and said assessment policy, whether the data migration path in said assessment object system is appropriate.

14. The system according to claim 4, further comprising assessment means for assessing, using a data migration path indicating data migration in said assessment object system and said assessment policy, whether the data migration path in said assessment object system is appropriate.

15. The system according to claim 5, further comprising assessment means for assessing, using a data migration path indicating data migration in said assessment object system and said assessment policy, whether the data migration path in said assessment object system is appropriate.

16. The system according to claim 6, further comprising assessment means for assessing, using a data migration path indicating data migration in said assessment object system and said assessment policy, whether the data migration path in said assessment object system is appropriate.

17. The system according to claim 7, further comprising assessment means for assessing, using a data migration path indicating data migration in said assessment object system and said assessment policy, whether the data migration path in said assessment object system is appropriate.

18. The system according to claim 8, further comprising assessment means for assessing, using a data migration path indicating data migration in said assessment object system and said assessment policy, whether the data migration path in said assessment object system is appropriate.

19. The system according to claim 9, further comprising assessment means for assessing, using a data migration path indicating data migration in said assessment object system and said assessment policy, whether the data migration path in said assessment object system is appropriate.

20. The system according to claim 10, further comprising assessment means for assessing, using a data migration path indicating data migration in said assessment object system and said assessment policy, whether the data migration path in said assessment object system is appropriate.
